(19) United States
(12) Patent Application Publication
(10) Pub. No.: US 2014/0371087 A1
(43) Pub. Date: Dec. 18, 2014

(54) MIXED FORMAT MICROARRAYS

(71) Applicant: Nuclea Biotechnologies, Inc., Pittsfield, MA (US)

(72) Inventor: Patrick J. Muraca, Pittsfield, MA (US)

(21) Appl. No.: 14/302,847

(22) Filed: Jun. 12, 2014

Related U.S. Application Data
(60) Provisional application No. 61/835,785, filed on Jun. 17, 2013.

(51) Int. Cl. G06F 19/28; G06F 19/00

(52) U.S. Cl. CPC G06F 19/28; G06F 19/3418
USPC 506/9; 705/2

(57) ABSTRACT

The invention provides methods, database and information management system for using mixed format microarrays to identify and validate biomarkers in target samples. The present invention provides highly accurate diagnostic assays and methods.

### CROSS REFERENCE TO RELATED APPLICATIONS

This application claims the benefit of U.S. Provisional Application Ser. No. 61/835,785 filed Jun. 17, 2013, the content of which is hereby incorporated by reference in its entirety.

### FIELD OF THE INVENTION

The invention relates to methods, databases and information systems using a plurality of different types of microarrays to identify and validate diagnostic and prognostic markers, and use of the markers in diagnostic and/or prognostic assays. In one embodiment, the invention relates to methods of using a nucleic acid microarray and a tissue or cell microarray to identify and validate diagnostic and prognostic markers.

### BACKGROUND OF THE INVENTION

The physiological responses of an organism to a condition, (e.g., such as a disease, an environmental condition, exposure to a drug, and the like) involve the complex interactions of multiple genes. Thus, a single gene-single tissue analysis or even a multiple gene-single tissue analysis will rarely provide a true picture of how to treat perturbations in these responses.

The completion of the human genome project has identified greater than 10⁶ genes in the human genome, yet interactions between the products of most of these genes remain to be elucidated. While it is a relatively straightforward matter to assess the expression of a single gene in one or more tissue samples, methods for modeling the interactions of multiple genes in multiple tissue samples, and in particular, in tissue samples from patients afflicted with diseases, have lagged behind.

Database systems for gene expression monitoring have been described in the art. For example, U.S. Pat. No. 6,185,561 describes a database model to facilitate molecular profiling or “data mining” of expression information obtained from nucleic acid arrays.

International Patent Application WO 99/44062 describes methods for rapid molecular profiling of tissues or other cellular specimens. The publication describes correlating data obtained from tissue microarrays with clinical information obtained from patients and suggests the use of a database for analyzing and correlating different molecular characteristics of tissue samples. The publication does not describe how to use such a database to identify interactions between multiple gene products or to identify a specific physiological response.

U.S. Pat. No. 5,980,096 describes a computer-based system for modeling and simulating complex systems, but does not evaluate patient characteristics in this process.

There is a need in the art for assays which combine evaluations of the genome and proteome with evaluations of tissue and cell samples to characterize physiological responses to disease, environmental conditions, drugs, agents (e.g., toxic or teratogenic agents), and the like. While genomic-based assays and proteomic-based assays can identify molecular markers associated with the incidence, progression, and/recurrence of disease, there is a need in the art to validate that these markers do in fact identify physiological responses in complex systems, i.e., such as in cells and tissues, and to correlate these responses with information about patients.

### SUMMARY OF THE INVENTION

This invention relates to methods, assays, databases and information systems using a plurality of different types of microarrays to identify and validate diagnostic and prognostic markers. In one aspect, the invention relates to use a nucleic acid microarray with a tissue and/or cell microarray to profile diagnostic and/or prognostic biomarkers of a cancer patient. In one aspect, the profiling data is stored into a specimen-linked database and an information management system is used to provide access to the biomarker profiles associated with patient clinical information.

In one aspect, the invention provides a method comprising performing a first assay and a second assay. The first assay comprises the step of contacting at least one target sample comprising a plurality of target biomolecules with a plurality of molecular probes disposed at different known locations on a substrate (e.g., a nucleic acid microarray, a peptide, polypeptide or protein microarray, an oligosaccharide microarray, or other small molecule array) while the second assay comprises the step of contacting at least one molecular probe with a plurality of target samples, each target sample comprising a plurality of target biomolecules and disposed at a different known location on a substrate (e.g., such as a tissue and/or cell microarray). The target sample used in the first assay and at least one of the target samples in the second assay are from the same patient. In one aspect, the second assay is performed using at least one molecular probe which specifically binds to a biomolecule in the target sample in the first assay. The patient from whom target samples are obtained is preferably human, but can also be a non-human animal or a plant.

When nucleic acids are used as molecular probes in the first assay, these can include oligonucleotides, cDNAs, RNA molecules, PNA molecules and modified forms thereof. When peptides, polypeptides, and/or proteins are used as molecular probes in the first assay, these can include antibodies (single chain, or double chain), antigen-binding fragments of antibodies, antigens or other peptides or proteins.

In one aspect, molecular probes on the substrate used in the first assay comprise cancer-specific biomolecules (e.g., nucleic acids, peptides, polypeptides or proteins, etc.) differentially expressed in cancer cells. In another aspect, the molecular probes comprise biomolecules from cancer cells at different stages/grades of disease and preferably, which are cancer-specific biomolecules.

In a further aspect, the molecular probes on the substrate used in the first assay comprise different modified forms of the same protein. Preferably, at least one probe comprises the unmodified form of the protein. In another aspect, the molecular probes are biomolecules which specifically recognize different modified forms of the same protein (e.g., the probes are antibodies or aptamers which specifically recognize one modified form of the protein but do not recognize unmodified forms or other types of modifications of the same protein). Preferably, at least one probe is provided which specifically reacts with the unmodified form of the protein and not with the modified form.

In one aspect, molecular probes in the first assay comprise nucleic acids and molecular probes in the second assay comprise one or more of peptides, polypeptide, or proteins or oligosaccharides. In a preferred aspect, when a nucleic acid probe is identified as reacting (e.g., specifically binding) to a biomolecule in the at least one target sample in the first assay, an antibody recognizing a peptide, polypeptide or protein encoded by a nucleic acid comprising the nucleic acid probe is used as a probe in the second assay.

In one aspect, at least one molecular probe is provided as the control probe in the first assay.

As discussed above, the plurality of target samples disposed on the substrate in the second assay can comprise cells or tissues, or portions thereof. When cells are provided as target samples in the second assay, in one aspect, the cells are substantially homogeneous. Substantially homogeneous populations of cells can be generated by flow sorting, affinity sorting, magnetic sorting, panning, limiting dilution, or by combinations of these methods, and generally by any method which can provide a population of cells in which at least about 80%, and preferably at least about 90%, or at least about 95%, of the cells are of the same type (e.g., express the same cell-type specific markers).

In one aspect, the cells are selected from the group consisting of hematopoietic stem cells and progenitor cells, T cells, B cells, monocytes, granulocytes, dendritic cells, macrophages, erythroid cells, megakaryocytes, platelets, endothelial cells, epithelial cells, tumor cells, leukocytes, chondrocytes, osteoblasts, fibroblasts, and smooth muscle cells.

The plurality of molecular probes in the first assay is preferably stably associated with the substrate. The plurality of target samples in the second assay also are preferably stably associated with the substrate, but in one aspect, target samples are provided in buffers or culture media in segregated areas on the substrate (e.g., such as in wells in a microtiter plate).

In one aspect, a tissue microarray is used in the second assay. Preferably, the plurality of target samples is from at least about two different types of tissues from the same patient. Still more preferably, the plurality of target samples in the second assay is from at least about five different tissues from the same patient. In one aspect, the at least about two or at least about five different tissues are selected from the group consisting of brain tissue, cardiac tissue, liver tissue, pancreatic tissue, spleen tissue, stomach tissue, lung tissue, skin tissue, eye tissue, colon cells, reproductive cells, kidney tissue, and bladder tissue.

In another aspect, at least one of the plurality of target samples in the second assay is selected from the group consisting of a substantially homogeneous cell sample, a tissue sample, a genomic DNA sample, a total RNA sample, an mRNA sample, a cDNA sample comprising reverse-transcribed mRNA molecules, and a sample of peptides, polypeptides, and or proteins. Preferably, the biomolecules in the sample represent a heterogeneous population of biomolecules from at least one cell, i.e., the mRNA sample is from a population of total mRNA from at least one cell and the cDNA sample is not cDNA of a single transcript. Similarly, the sample of peptides, polypeptides or proteins, preferably represents a heterogeneous population of molecules as would be found in at least one cell.

In one aspect, at least one target sample in either the first or the second assay is from a bodily fluid. The bodily fluid can be selected from the group consisting of a blood sample, lymph sample, a urine sample, a leukapheresis sample, peritoneal fluid, pleural fluid, and an amniotic fluid sample.

Cell and/or tissue samples can be frozen, paraffin-embedded, or plastic-embedded. In one aspect, the target samples in the second assay comprise two or more of: frozen, paraffin-embedded or plastic-embedded samples.

In one aspect, at least one target sample is provided as the control sample in the second assay, for example, the normal tissue from the same organ as the diseased tissue from the same or a different but demographically matched individual.

The method also can comprise providing additional assays. For example, in one aspect, the method further comprises providing a third assay which comprises the step of contacting a target sample comprising a plurality of target biomolecules with a plurality of molecular probes disposed at different known locations on a substrate; wherein the plurality of molecular probes are different from the plurality of molecular probes of the first assay. Thus, if a nucleic acid microarray were used in the first assay, a peptide, polypeptide or protein microarray could be used in the second assay. Preferably, the third assay is performed prior to said second assay.

The method preferably comprises the step of detecting the reactivity of target biomolecules with one or more of the plurality of molecular probes in the first assay, and/or the second assay. To facilitate this, the target biomolecules in the first assay and the at least one molecular probe in the second assay are labeled. Preferably, information relating to reactivity is stored in a database along with information relating to the patient(s) who provided target samples. Information relating to patient(s) includes, but is not limited to, age, sex, occupation, residence, medical history (including therapeutic procedures and agents, and the outcomes of such treatments), family medical history, molecular profiles previously determined for samples from patients, etc.

The invention also provides a method comprising the steps of: providing a plurality of first molecular probes disposed at distinct known locations at a first position on a substrate and providing a plurality of second molecular probes disposed at distinct known locations at a second position on said substrate. The first and second molecular probes are preferably selected from the group consisting of nucleic acids, peptides, polypeptides, proteins, oligosaccharides, and other small molecules, and the first and second molecular probes are different from each other. The first and second molecular probes are contacted with labeled target biomolecules, which are preferably from the same sample or from substantially identical samples (e.g., two samples of the same tissue/cell type from the same patient). In this assay as well, the target biomolecules preferably are labeled and the reactivity of the target biomolecules with probe biomolecule(s) determined. Information relating to reactivity and to the patient from which the target samples were obtained is preferably stored in a database.

In a further aspect, the invention provides a method comprising the steps of: providing a plurality of first target samples, each first target sample comprising a plurality of first target biomolecules and disposed at a different known location at a first position on a first substrate, the first target molecules selected from the group consisting of genomic DNA, total RNA, mRNA, peptides, polypeptides, oligosaccharides; providing a plurality of second target samples, each second target sample comprising a plurality of second target biomolecules and disposed at a different known location at a second position on a first substrate; the second target molecules selected from the group consisting of substantially cells, tissues, and combinations thereof. The first and second target samples are contacted with at least one molecular probe, which is preferably labeled, and reactivity between the molecular probe and biomolecule(s) in the target sample is determined. Preferably, at least one of the first and second target samples is from the same patient. Still more preferably, at least one of the first and second target samples is from the same tissue from the same patient. In one aspect, the method further comprises storing information relating to reactivity in a database along with information relating to patient(s) providing the target samples.

In still a further aspect, the invention provides a method comprising the steps of providing a plurality of molecular probes, each molecular probe disposed at a distinct known location at a first position on a substrate, the probe being selected from the group consisting of oligonucleotides, PNA molecules, cDNA molecules, peptides, polypeptides, proteins, oligosaccharides, and other cellular biomolecules, providing a plurality of target samples, each target sample comprising a plurality of target biomolecules and disposed at a known location at a second position on the substrate. The first position is reacted with at least one labeled target sample while the second position is reacted with at least one molecule probe. Preferably, at least one target sample and at least one of the plurality of target samples is from the same patient. Still more preferably, at least one molecular probe is substantially identical to one of the plurality of molecular probes.

The invention also provides sets of microarrays for performing any of the methods described above. In one aspect, the invention provides a set of microarrays comprising at least a first microarray and at least a second microarray. The first microarray comprises a first plurality of molecular probes disposed at distinct known locations on a first substrate while the second microarray comprises a plurality of target samples comprising a plurality of biomolecules, each target sample disposed at a distinct known location on a second substrate wherein at least one of the biomolecules in the target sample specifically reacts with at least one of the plurality of molecular probes.

In one aspect, the first and second substrate is the same, i.e., both the first and second microarray is arrayed on a single substrate. However, in another aspect, the first and second substrate is different.

The target samples on the second microarray can comprise cell or tissue samples or portions thereof. The samples can be frozen, paraffin-embedded, and/or plastic-embedded. In one aspect, the second microarray includes two or more of frozen and paraffin-embedded and/or plastic embedded samples.

In one aspect, at least about two of the target samples of the second array are from the same patient. More preferably, the at least about two target samples are from different tissue and/or cell types from the same patient. Still more preferably at least about five of the target samples are from different tissues and/or cell types from the same patients, such as from brain tissue, cardiac tissue, liver tissue, pancreatic tissue, spleen tissue, stomach tissue, lung tissue, skin tissue, eye tissue, colon cells, reproductive cells, kidney tissue, bladder tissue, cells in a bodily fluid.

In another aspect, at least one of the plurality of target samples in the second microarray is selected from the group consisting of a substantially homogeneous cell sample, a tissue sample, a genomic DNA sample, a total RNA sample, an mRNA sample, a cDNA sample comprising reverse-transcribed mRNA molecules, and a sample of peptides, polypeptides, proteins, and other cellular biomolecules. Preferably, the biomolecules in the sample represent a heterogeneous population of biomolecules from at least one cell, i.e., the mRNA sample is from a population of total mRNA from at least one cell and the cDNA sample is not cDNA of a single transcript. Similarly, the sample of peptides, polypeptides or proteins, preferably represents heterogeneous population of molecules as would be found in at least one cell.

### BRIEF DESCRIPTION OF THE DRAWINGS

FIG. 1 is a flow diagram describing one embodiment of the invention. Column A shows one or more first probe microarray assay with labeled target sample. Column B shows one or more target microarray assay with labeled probes identified from the first microarray assay.

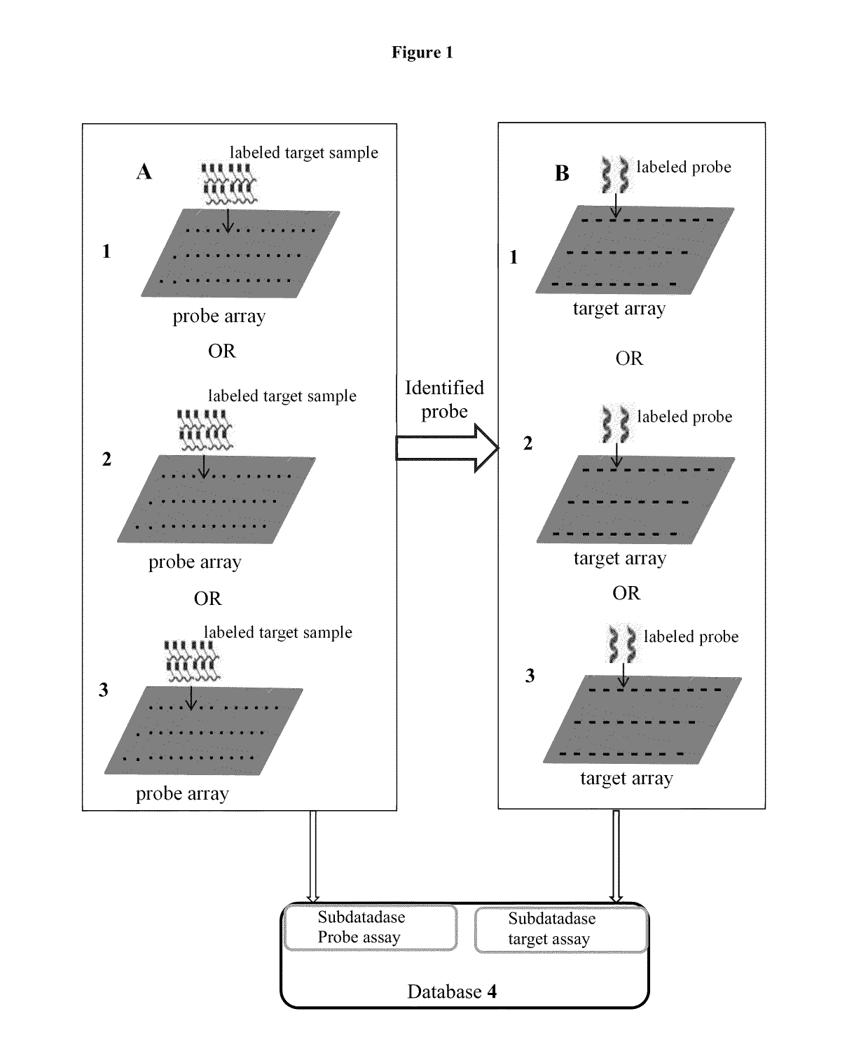

FIG. 2 provides a schematic diagram of a system comprising a specimen-linked database according to one embodiment of the invention.

### DETAILED DESCRIPTION OF THE INVENTION

The invention provides methods of linking genomic, proteomic and cell/tissue assays and of generating and using specimen-linked databases. The invention also provides sets or combinations of different types of microarrays (“mixed format microarrays”) for use in such assays.

### THE DEFINITIONS

The following definitions provide the meanings of specific terms which are used in the following written description to serve to provide a clearer understanding of certain aspects of the present invention. These definitions are not meant to be limiting in nature.

As used herein, the term “information about a patient” refers to any information known about the individual (a human or non-human animal) from whom a cell sample was obtained. The term “patient” does not necessarily imply that the individual has ever been hospitalized or received medical treatment prior to obtaining a cell sample. The term “patient information” includes, but is not limited to, age, sex, weight, height, ethnic background, occupation, environment, family medical background, the patient's own medical history (e.g., information pertaining to prior diseases, diagnostic and prognostic test results, drug exposure or exposure to other therapeutic agents, responses to drug exposure or exposure to other therapeutic agents, results of treatment regimens, their success, or failure, history of alcoholism, drug or tobacco use, cause of death, and the like). The term “patient information” refers to information about a single individual. Information from multiple patients provides “demographic information,” defined as statistical information relating to populations of patients, organized by geographic area or other selection criteria, while “epidemiological information” is defined as information relating to the incidence of disease in populations.

As defined herein, the term “information relating to” is information which summarizes, reports, provides an account of, and/or communicates particular facts, and in some aspects, includes information as to how facts were obtained and/or analyzed.

As used herein, the term, “in communication with” refers to the ability of a system or component of a system to receive input data from another system or component of a system and to provide an output in response to the input data. “Output” may be in the form of data or may be in the form of an action taken by the system or component of the system.

As used herein, the term “provide” means to furnish, supply, or to make available.

As defined herein, a “tissue” is an aggregate of cells that perform a particular function in an organism. The term “tissue” as used herein refers to cellular material from a particular physiological region. The cells in a particular tissue may comprise several different cell types. A non-limiting example of this would be brain cells that further comprise neurons and glial cells, as well as capillary endothelial cells and blood cells.

As defined herein, a “molecular probe” is any detectable molecule, or is a molecule which produces a detectable molecule upon reacting with a biological molecule. “Reacting” encompasses specific binding, labeling, or catalyzing an enzymatic reaction. A “biological molecule” or “biomolecule” is any molecule which is found in cells or within the body of an organism.

As used herein, the term “biological characteristics of a cell or cells” refers to the phenotype and/or genotype of one or more cells, which can include cell type, and/or tissue type from which the cell was obtained, morphological features of the cell(s), and the expression of biological molecules within the cell(s). The “expression of biological molecules” can include the expression and accumulation of RNA sequences, the expression and accumulation of proteins (including the expression of their modified, cleaved, or processed forms, and further including the expression and accumulation of enzymes, their substrates, products, and intermediates) and the expression and accumulation of metabolites, carbohydrates, lipids, and the like), as well as the presence or absence or copy number of particular chromosomes or chromosome regions within the cell. A biological characteristic can also be the ability of cell(s) to bind, incorporate, or respond to a drug or agent. “Biological characteristics of a cell source” refers to the characteristics of the organism/patient who is the source of the cells (e.g., such as the age, sex, and physiological state of the organism) and encompasses patient information.

As defined herein, a “diagnostic trait” is an identifying characteristic, or set of characteristics, which in totality, is diagnostic. The term “trait” encompasses both biological characteristics and experiences (e.g., exposure to a drug, occupation, place of residence). In one aspect, a trait is a marker for a particular cells type, such as a transformed, immortalized, pre-cancerous, or cancerous cells, or a state (e.g., a disease) and detection of the trait provides a reliable indicia that the sample comprises that cells type or state. Screening for an agent affecting a trait thus refers to identifying an agent which can cause a detectable change or response in that trait which is statistically significant within 95% confidence levels.

As used herein, the term “expression” refers to a level, form, or localization of a product. For example, “expression of a protein” refers to any or all of the level, form (e.g., presence, absence, quantity, or quantity of modifications, or cleavage or other processed products), or localization (e.g., subcellular and/or extracellular compartment) of the protein.

A “disease or pathology” is a change in one or more biological characteristics that impairs normal functioning of a cells, cells, and/or organism. A “pathological condition” encompasses a disease but also encompasses abnormal responses which are not associated with any particular infectious organism or single genetic alteration in an individual. For example, as defined herein, a stroke or an immune response occurring after transplantation of an organism would be encompassed by the term “pathological condition.”

As used herein, the term “cancer” refers to a malignant disease caused or characterized by the proliferation of cells which have lost susceptibility to normal growth control. “Malignant disease” refers to a disease caused by cells that have gained the ability to invade either the cells of origin or to travel to sites removed from the cells of origin.

As used herein, a “cancer-specific marker” or a “tumor specific antigen” or “tumor-specific marker” is a biomolecule which is expressed preferentially on cancer or tumor cells and is not expressed or is expressed to small degree in non-cancer cells of an adult individual. The term “cancer-specific marker” is used to encompass both tumor-specific markers and markers of abnormally proliferating cancerous cells which do not form tumors (e.g., such as leukemia). As used herein, “a small degree” means that the difference in expression of the marker in cancer cells and non-cancer cells is large enough to be detected as a statistically significant difference when using routine statistical methods to within 95% confidence level.

As used herein, the term “difference in biological characteristics” refers to an increase or decrease in a measurable expression of a given biological characteristic. A difference may be an increase or a decrease in a quantitative measure (e.g., amount of a protein or RNA encoding the protein) or a change in a qualitative measure (e.g., location of the protein). Where a difference is observed in a quantitative measure, the difference according to the invention will be at least about 10% greater or less than the level in a normal standard sample. Where a difference is an increase, the increase may be as much as about 20%, 30%, 50%, 70%, 90%, 100% (2-fold) or more, up to and including about 5-fold, 10-fold, 20-fold, 50-fold or more. Where a difference is a decrease, the decrease may be as much as about 20%, 30%, 50%, 70%, 90%, 95%, 98%, 99% or even up to and including 100% (no specific protein or RNA present). It should be noted that even qualitative differences may be represented in quantitative terms if desired. For example, a change in the intracellular localization of a polypeptide may be represented as a change in the percentage of cells showing the original localization.

As defined herein, the “efficacy of a drug” or the “efficacy of a therapeutic agent” is defined as ability of the drug or therapeutic agent to restore the expression of diagnostic trait to values not significantly different from normal (as determined by routine statistical methods, to within 95% confidence levels).

As defined herein, a “cell microarray” is a microarray that comprises a plurality of locations, each location comprising one or more cells where the morphological features of the cell(s) at each location are visible through microscopic examination. The term “a tissue microarray” is a microarray that comprises a plurality of sublocations, each sublocation comprising tissue cells and/or extracellular materials from tissues, and/or cells typically infiltrating tissues, where the morphological features of the cells or the extracellular materials at each sublocation are visible through microscopic examination. The term “microarray” implies no upper limit on the size of the cell samples on the array, but merely encompasses a plurality of cell samples stably associated with known locations on a substrate which, in one aspect, can be viewed using a microscope to reveal morphologically distinct features.

As used herein, a portion of a sample which is “stably associated with a substrate” refers to a portion which does not substantially move from its position on the substrate during one or more molecular procedures.

As defined herein, a “whole body microarray” is a microarray comprising samples representing substantially the whole body of an organism. In one aspect, the microarray comprises at samples from at least about five different types of tissues or cells from an organism, at least about ten different types of tissue/cells, or at least about 20 different types of tissues/cells from the same organism. As used herein, “different types of tissue/cells” refer to tissues/cells which differ in the expression of at least one peptide, polypeptide, or protein. Preferably, “different types of tissues/cells” are from different organs or from anatomically and histologically distinct sites in the same organ. For example, in one aspect, a whole body microarray comprises samples from at least about five different types of tissues selected from the group consisting of brain tissues, cardiac tissues, liver tissues, pancreatic tissues, spleen tissues, stomach tissues, lung tissues, skin tissues, eye tissues, colon tissues, reproductive organ tissues, and kidney tissues and/or substantially homogeneous cells from these tissues. In preferred aspects, a sample of cells from a bodily fluid is also included, such as a blood sample, lymph sample, CSF sample, a urine sample and the like. Cells also can be selected from the group consisting of hematopoietic stem cells and progenitor cells, T cells, B cells, monocytes, granulocytes, dendritic cells, macrophages, erythroid cells, megakaryocytes, platelets, endothelial cells, epithelial cells, tumor cells, leukocytes, fibroblasts, and the like. Preferably, cell samples at any one location in the microarray are at least about 80%, at least about 90%, at least about 95%, at least about 97%, and up to about 100% homogeneous.

As used herein “homogeneous” means that the cells are all of one type, i.e., a dendritic cell sample that is 100% homogeneous comprises no non-dendritic cells.

As defined herein a “sample” is a material suspected of comprising an analyte and includes a biological fluid, suspension, buffer, collection of cells, scraping, fragment or slice of cells. A biological fluid includes blood, plasma, sputum, urine, cerebrospinal fluid, lavages, and leukapheresis samples.

As used herein “donor block” refers to an embedding material comprising one or more cells(s). While referred to as a “block”, the embedded cells or cells(s) can be generally of any shape or size so long as an at least about 0.3 mm in diameter sample core can be obtained from it. A sample from a donor block can be placed directly onto a slide or can be placed in a recipient block.

As used herein a “donor sample” refers to an embedded cell sample obtained from the donor block.

As used herein “recipient block” refers to a block formed from an embedding material which is capable of holding donor samples (i.e., portions of embedded cell samples) in a pattern so that the location of the donor samples relative to each other is maintained when the block is sectioned to produce an array of cell samples. The term “microarray block” refers more specifically to a recipient block which comprises a desired number of donor samples.

As used herein a “nucleic acid microarray”, a “peptide microarray”, a “polypeptide microarray”, a “protein microarray”, or a “small molecule microarray” or “arrays” of any of nucleic acids, peptides, polypeptides, proteins, small molecules, refer to a plurality of nucleic acids, peptides, polypeptides, proteins, oligosaccharides or small molecules, respectively, that are immobilized on a substrate in assigned distinct locations (i.e., known locations. As used herein, a “distinct” location is one which can be visually distinguished as separate from other locations, e.g., there is a region of substrate which is not attached to a molecular probe (nucleic acids, peptides, polypeptides, proteins, oligosaccharides, small molecules) between distinct known locations.

As used herein, although a “molecular probe” is referred to in the singular a molecular probe can comprise one or a plurality of molecules. Typically, a molecular probe comprises a plurality of molecules which are identical or substantially identical. For example, a molecular probe which comprises an oligonucleotide sequence can comprise a plurality of molecular probes so long as each molecular probe comprises the oligonucleotide sequence or a substantially identical sequence (greater than about 95% identity when sequences are maximally aligned, and preferably, greater than 97% or 99% identity).

As used herein, a “peptide” is a polymer comprising from about one to about ten amino acids. As used herein, a “polypeptide” comprises at least about ten amino acids. A “protein” comprises at least an initiating methionine or the amino acid immediately after the initiating methionine and the amino acid encoded by a nucleic acid sequence preceding the translational stop codon which encodes the polypeptide, and all of the amino acids there-between. A modified form of a peptide/polypeptide/protein can comprise a post-translationally modified form of a protein, such as by phosphorylation, ribosylation, methylation (Arg, Asp, N, S, or O-directed), prenylation (e.g., Farnesyl, geranylgeranyl, and the like), acetylation, acylation. Modified peptides/polypeptides/proteins also encompass allelic variations of the same and cleaved or otherwise processed forms of the same.

As used herein a “diagnostic probe” is a probe whose binding to a cell sample provides an indication of the presence or absence of a particular trait. In one aspect, a probe is considered diagnostic if it binds to a diseased cells and/or cells (“disease samples”) in at least about 80% of samples tested comprising diseased cells/cells and binds to less than 10% of non-diseased cells/cells in samples (“non-disease” samples). Preferably, the probe binds to at least about 90% or at least about 95% of disease samples and binds to less than about 5% or 1% of non-disease samples.

As used herein, “oligonucleotide” generally refers to any oligoribonucleotide or oligodeoxyribonucleotide, which may be unmodified RNA or DNA. “Oligonucleotides” include, without limitation, single- and double-stranded nucleic acids.

As used herein, “isolated” or “purified” when used in reference to a nucleic acid means that a naturally occurring sequence has been removed from its normal cellular (e.g., chromosomal) environment or is synthesized in a non-natural environment (e.g., artificially synthesized). Thus, an “isolated” or “purified” sequence may be in a cell-free solution or placed in a different cellular environment. The term “purified” does not imply that the sequence is the only nucleotide present, but that it is essentially free (about 90-95% pure) of non-nucleotide material naturally associated with it, and thus is distinguished from isolated chromosomes.

As used herein a “modified nucleic acid” or a “modified oligonucleotide” or a “modified polynucleotide” is a nucleic acid/oligonucleotide/polynucleotide which comprises at least one residue with any of: an altered internucleotide linkage(s), altered sugar(s), altered base(s), or combinations thereof, so long as the modification does not interfere with specificity of the hybridization of the nucleic acid/oligonucleotide/polynucleotide (i.e., the probe still specifically binds to its complementary sequence under selective hybridization conditions).

As used herein, “specific hybridization” or “selective hybridization” or “hybridization under stringent conditions” refers to hybridization which occurs when two nucleic acid sequences are substantially complementary, i.e., there is at least about 95% and preferably, at least about 97% identity between the sequences, wherein the region of identity comprises at least 10 nucleotides. In one embodiment, the sequences hybridize under stringent conditions following the incubation of the sequences overnight at 42° C., followed by stringent washes (0.2×SSC at 65° C.). Typically, stringent conditions will be those in which the salt concentration is at least about 0.01 to 1.0 M Na ion concentration (or other salts) at pH 7.0 to 8.3 and the temperature is at least about 30° C. for short probes (e.g., about 6 to 50 nucleotides). Stringent conditions may also be achieved with the addition of destabilizing agents such as formamide. Generally, stringent conditions are selected to be about 5° C. lower than the thermal melting point (Tm) for the specific sequence at a defined ionic strength and pH, as calculated using methods routine in the art.

As used herein, the “thermal melting point (Tm)” is the temperature, under defined ionic strength, pH, and nucleic acid concentration, at which 50% of the probes complementary to the target sequence hybridize to the target sequence at equilibrium. As the target sequences are generally present in excess, at Tm, 50% of the probes are occupied at equilibrium).

As used herein, “background” or “background signal intensity” refers to hybridization signals that result from non-specific binding, or other interactions, between the labeled target biomolecules and molecular probes. Background signals can also be produced by intrinsic fluorescence of the labels used to label target and/or probe molecules. Background can be calculated for an entire substrate or for individual molecular probes/target molecules on the substrate.

As used herein “donor block” refers to embedding material comprising a tissue or portion thereof or cell(s). While referred to as a “block”, the embedded tissue or cell(s) can be generally of any shape or size so long as an at least about 0.3 mm in diameter sample core can be obtained from it. A sample from a donor block can be placed directly onto a slide or can be placed in a recipient block.

As used herein “donor sample” refers to an embedded tissue or cell sample obtained from the donor block.

As used herein “recipient block” refers to a block formed from an embedding material which is capable of holding donor samples in a pattern so that the location of the donor samples relative to each other is maintained when the block is sectioned to produce an array of tissue and/or cell samples. The term “microarray block” refers more specifically to a recipient block which comprises a desired number of donor samples.

As used herein a “hole sized to receive a donor” sample refers to a hole in the recipient block/microarray block which fits a donor sample snugly, so that there is no appreciable space between the donor sample and the walls of the hole (e.g., less than about 1 mm between the edge of a donor sample and the walls of the hole in the recipient block).

As used herein “information relating to the location of each donor sample” is information which includes at least the coordinates of the donor sample in the block.

As used herein “substantially identical microarrays” refer to microarrays obtained by sectioning a single microarray block. Preferably, substantially identical microarrays comprise sections which are within about 0-600 μm of each other in a microarray block. Substantially identical microarrays comprise a one-to-one correspondence of samples, such that samples at identical coordinates in each of a plurality of microarrays will be substantially identical.

As used herein a “substantially identical test sample” refers to sections from the same block of an embedded test sample (preferably sections which are within about 0-600 μm of each other). When referring to a sample of suspended test cells or a non-embedded tissue sample, a substantially identical test sample refers to cells which express the same cell-type specific markers. Substantially identical cells can be obtained from substantially the same anatomic location of the same tissue of the same organism or if the cells are from a bodily fluid, the cells can be obtained from the same individual under substantially the same physiological conditions. However, in some cases a substantially identical test sample refers to a sample comprising the same types of cells/tissues of demographically matched patients, so long as the markers expressed on these samples are substantially the same.

As used herein “coordinates” refer to the x, y location of a sample in a microarray comprising samples arranged in rows and columns, wherein the x coordinate refers to the column number of the sample and the y coordinate refers to the row number of the sample.

As used herein “substantially intact morphological features” refers to features which at least can be viewed under a microscope to distinguish subcellular features (e.g., such as a nucleus, an intact cells membrane, organelles, and/or other cytological features).

As used herein “molecular procedure” refers to contact with a test reagent or molecular probe such as an antibody, nucleic acid probe, enzyme, chromagen, label, and the like. In one aspect, a molecular procedure comprises one or more of a plurality of hybridizations, incubations, fixation steps, changes of temperature (from about −4° C. to about 100° C.), exposures to solvents, and/or wash steps.

As used herein “similar demographic characteristics” or “demographically matched”, refers to patients who minimally share the same sex and belong to the same age grouping (e.g., are within about 5 to 15 years of a selected age). Additional shared characteristics can be selected, including, but not limited to, shared place of residence (e.g., within a hundred mile radius of a particular location), shared occupation, shared history of illnesses, shared ethnic background, and the like.

As defined herein, a “database” is a collection of information or facts organized according to a data model which determines whether the data is ordered using linked files, hierarchically, according to relational tables, or according to some other model determined by the system operator. The organization scheme that the database uses is not critical to performing the invention, so long as information within the database is accessible to the user through an information management system. Data in the database are stored in a format consistent with an interpretation based on definitions established by the system operator (i.e., the system operator determines the fields which are used to define patient information, molecular profiling information, or another type of information category). As used herein, a “specimen-linked database” is a database which cross-references information in the database to cells specimens provided on one or more microarrays, and preferably using codes, such as SNOMED® codes, ICD-9 codes, and/or DSM-IV TR codes.

As defined herein, a “system operator” is an individual who controls access to the database.

As used herein, the term “information management system” refers to a system which comprises a plurality of functions for accessing and managing information within the database. Minimally, an information management system according to the invention comprises a search function, for locating information within the database and for displaying a least a portion of this information to a user, and a relationship determining function, for identifying relationships between information or facts stored in the database.

As defined herein, an “interface” or “user interface” or “graphical user interface” is a display (comprising text and/or graphical information) displayed by the screen or monitor of a user device connectable to the network which enables a user to interact with the database and information management system according to the invention.

As used herein, the term “link” refers to a point-and-click mechanism implemented on a user device connectable to the network which allows a viewer to link (or jump) from one display or interface where information is referred to (a “link source”), to other screen displays where more information exists (a “link destination”). The term “link” encompasses both the display element that indicates that the information is available and a program which finds the information (e.g., within the database) and displays it one the destination screen. In one aspect, a link is associated with text; however, in other aspects, links are associated with images or icons. In some aspects, selecting a link (e.g., by right clicking using a mouse) will cause a drop down menu to be displayed which provides a user with the option of viewing one of several interfaces. Links can also be provided in the form of action buttons, radiobuttons, check buttons and the like.

As defined herein, a “browser” is a program which supports the displaying of documents, across a network. Browsers enable accessing linked information over the Internet and other networks, as well as from magnetic disk, CD-ROM, or other memory sources.

As used herein “providing access to at least a portion of a database” refers to making information in the database available to user(s) through a visual or auditory means of communication.

As used herein “through a visual means of communication” includes displaying or providing written text, image(s), or a combination of written and graphical information to a user of the database.

As used herein “through an auditory or verbal means of communication” refers to providing the user with taped audio information, or access to another user who can communicate the information through speech or sign language. Written and/or graphical information can be communicated through a printed report or electronically (e.g., through a display on the display of a computer or other processor, through email or other electronic messaging systems, through a wireless communications device, via facsimile, and the like). Access can be unrestricted or restricted to specific subdatabases within the database.

As used herein, “instruction pipelining” refers to the sequence of bus operations that occurs during instruction execution. The instruction-fetch, decode, operand-fetch, execute pipeline is essentially invisible to the user, except in some cases where the pipeline must be broken (such as for branch instructions). In the operation of the pipeline the instruction fetch, decode, operand fetch, and execute operations are independent which allow instruction executions to overlap. Thus, during any given cycle of operations, one to more different instructions can be active, each at a different stage of completion, resulting in one to n-deep pipeline (see, e.g., as described in U.S. Pat. No. 5,724,248, the entirety of which is incorporated by reference herein.

As used herein, “pathway molecules” or “pathway biomolecules” are molecules involved in the same pathway and whose accumulation and/or activity and/or form (i.e., referred to collectively as the “expression” of a molecule) is dependent on other pathway molecules, or whose accumulation and/or activity and/or form affects the accumulation and/or activity or form of other pathway target molecules. For example, a “GPCR pathway molecule” is a molecule whose expression is affected by the interaction of a GPCR and its cognate ligand (a ligand which specifically binds to a GPCR and which triggers a signaling response, such as a rise in intracellular calcium). Thus, a GPCR itself is a GPCR pathway molecule, as is its ligand, as is intracellular calcium. An “early pathway molecule” is a molecule whose expression is required for the expression of at least about five other genes, while a “late pathway” molecule is a molecule whose expression is required for the expression of about two or fewer other genes.

As used herein a “correlation” refers to a statistically significant relationship determined using routine statistical methods known in the art. For example, in one aspect, statistical significance is determined using a Student's unpaired t-test, considering differences as statistically significant at p<0.05.

As used herein a “diagnostic probe” is a probe whose binding to a cell sample provides an indication of the presence or absence of a particular trait. In one aspect, a probe is considered diagnostic if it binds to a diseased cells and/or cells (“disease samples”) in at least about 80% of samples tested comprising diseased cells/cells and binds to less than 10% of non-diseased cells/cells in samples (“non-disease” samples). Preferably, the probe binds to at least about 90% or at least about 95% of disease samples and binds to less than about 5% or 1% of non-disease samples.

As used herein, “oligonucleotide(s)” generally refers to any oligoribonucleotide or oligodeoxyribonucleotide, which may be unmodified RNA or DNA. “Oligonucleotides” include, without limitation, single- and double-stranded nucleic acids. As used herein, the term “modified oligonucleotide(s)” also include DNAs or RNAs as described above, that contain one or more modified bases. A “modified oligonucleotide” includes at least one residue with any of: an altered internucleotide linkage(s), altered sugar(s), altered base(s), or combinations thereof.

As used herein, “isolated” or “purified” when used in reference to a nucleic acid means that a naturally occurring sequence has been removed from its normal cellular (e.g., chromosomal) environment or is synthesized in a non-natural environment (e.g., artificially synthesized). Thus, an “isolated” or “purified” sequence may be in a cell-free solution or placed in a different cellular environment. The term “purified” does not imply that the sequence is the only nucleotide present, but that it is essentially free (about 90-95% pure) of non-nucleotide material naturally associated with it, and thus is distinguished from isolated chromosomes.

As used herein “electronic subtraction” refers to a method of comparing a first expressed sequence database with a second expressed sequence database and electronically removing sequences which are in both the first and second database. Methods of electronic subtraction are described in U.S. Pat. No. 5,840,484, for example, the entirety of which is incorporated by reference herein.

As used herein a “probe corresponding to a differentially expressed sequence” is a probe capable of specifically reacting with the sequence such that reactivity of the probe with a sample indicates the presence of the sequence.

### Molecular Probes

When nucleic acids are used as molecular probes in the first assay, these can include oligonucleotides, cDNAs, RNA molecules, PNA molecules, DNA/RNA aptamers and modified forms thereof. When peptides, polypeptides or proteins are used as molecular probes in the first assay, these can include, but are not limited to, antibodies (single-chain, or double-chain), antigen-binding fragments of antibodies, or antigens themselves. Other small molecules which can be used in the first assay include, but are not limited to, oligosaccharides, phospholipids, mimetics, polymers, and drug congeners.

In one aspect, an individual molecular probe comprises a plurality of identical or substantially identical oligonucleotides. The nucleic acid probe can be DNA. However, the nucleic acid probe can also comprise a homogeneous cDNA population (one or more cDNAs which have been transcribed from RNA molecules having identical or substantially identical sequences). Preferably, a nucleic acid member of the array according to the invention is at least about 6, at least about 10, at least about 15, at least about 20, at least about 50, at least about 75, at least about 100 to at least about 6000 nucleotides in length.

In one aspect, one or more molecular probes are provided as controls for use in the assays described herein. For example, suitable control sequences include the sequences of housekeeping genes (e.g., actin, tubulin) and/or vector sequences. In one aspect, “other species nucleic acids” can be used as controls. For example, if the test probes being evaluated are from humans, plant sequences can be used as controls. Additional controls include mismatch controls such as are known in the art.

In a preferred aspect, cDNAs which are expressed in a specific cell type or tissue type are provided at distinct known locations on the substrate. In another aspect, cDNAs which are from a cell/tissue which is the target of a disease are provided at distinct known locations on the substrate. In still another aspect, cDNAs which are from different developmental stages of the same organism are provided at distinct known locations on the substrate. In a further aspect, cDNAs from cells/tissues exposed to a therapy (e.g., a drug, a protein therapy, gene therapy, antisense therapy, ribozyme therapy, aptamer therapy, and the like) are provided at distinct known locations on the substrate.

In another aspect, molecular probes on the substrate used in the first assay comprise cancer-specific biomolecules (e.g., nucleic acids, peptides, polypeptides or proteins) differentially expressed in cancer cells. In another aspect, the molecular probes comprise biomolecules from cancer cells at different stages/grades of disease and preferably, which are cancer-specific biomolecules.

In a further aspect, the molecular probes on the substrate used in the first assay comprise different modified forms of the same protein. Preferably, at least one probe comprises the unmodified form of the protein. In another aspect, the molecular probes are biomolecules which specifically recognize different modified forms of the same protein (e.g., the probes are antibodies or aptamers which specifically recognize one modified form of the protein but do not recognize unmodified forms or other types of modifications of the same protein). Preferably, at least one probe is provided which specifically reacts with the unmodified form of the protein and not with the modified form.

In one aspect, molecular probes in the first assay comprise nucleic acids and molecular probes in the second assay comprise one or more of peptides, polypeptide, or proteins or oligosaccharides. In a preferred aspect, when a nucleic acid probe is identified as reacting (e.g., specifically binding) to a biomolecule in the at least one target sample in the first assay, an antibody recognizing a peptide, polypeptide or protein encoded by a nucleic acid comprising the nucleic acid probe is used as a probe in the second assay.

In one aspect nucleic acid probes or peptide, polypeptide, or protein probes are arrayed which correspond to genes involved in one or more physiological responses, such as responses to disease, pathological conditions, drugs or agents, environmental conditions, and the like. As used herein, a molecular probe which “corresponds” to a gene is a nucleic acid sequence which is a subsequence of a gene or is a peptide, polypeptide, or protein encoded by the gene or peptide or polypeptide subsequence of the gene).

Physiological responses include, but are not limited to, cellular metabolism, energy metabolism, nucleic acid metabolism, signal transduction, progression through the cell cycle, cell transformation, DNA repair, secretion, subcellular localization and processing of cellular constituents (e.g., including RNA splicing, protein processing and/or modification and cleavage, protein transport through the Golgi and various compartments of the cell), cell-cell interactions, cell migration, cell adhesion, growth, differentiation, apoptosis, immune responses, neurotransmission, ion transport, sugar transport, lipid metabolism, and the like.

In one aspect, the genes are GPCR pathway genes. For example, molecular probes can be generated from nucleic acid sequences hybridizing to, or peptides, polypeptides, proteins encoded by the following sequences: serotonin receptor sequences (e.g., 5-hydroxytryptamine 1A, 1B, 1C, 1D, 1F, 2A, 2C, 5A and/or 5B receptors), adenosine receptor sequences (e.g., an adenosine A1 receptor, an adenosine A2A, A2B, A3, P2U, and/or P2Y), uridine nucleotide receptor sequences, an adrenergic receptor sequences (e.g., α-1A, 1B, 1C, 2A, 2B, 2C, and/or β-1, 2, and/or 3), angiotensin receptor sequences, bombesin receptor (e.g., bombesin Type 3, Type 4) sequences, neuromedin B receptor sequences, gastrin-releasing peptide receptor sequences, bradykin receptor sequences, C5A-anaphylatoxin receptor sequences, a cannabinoid receptor (e.g., Type 1, Type 2, Type A) sequences, gastrin receptor sequences, dopamine receptor sequences (e.g., dopamine 1A, 1B, D2, D3, D4), endothelin receptor sequences (e.g., endothelin A, endothelin B), formyl-methionyl peptide receptor sequences, gonadotrophin releasing hormone receptor sequences, glycoprotein hormone receptor sequences, histamine receptor (H1 and/or H2) sequences, interleukin-8 receptor sequences (e.g., interleukin 8A and 8B), adrenocorticotrophin receptor sequences, melanocortin receptor sequences, melanocyte stimulating hormone receptor sequences, muscarinic receptor (e.g., M1, M2, M3, M4, M5 receptors) neurokinin receptor sequences, olfactory receptor sequences, opiod receptor sequences (delta, kappa, mu, and/or X receptors), opsin receptor sequences (blue or red/green sensitive), such as a rhodopsin receptor sequences, parathyroid hormone receptor sequences, secretin receptor sequences, vasoactive intestinal peptide receptor sequences, extracellular calcium-sensing receptor sequences, metabotropic glutamate receptor sequences, prostanoid receptor sequences (EP1, EP2, EP3, EP4), platelet activating factor receptor sequences, thromboxane receptor sequences, somatostatin receptor sequences (Type 1, 2, 3, and/or 4), Burkitts' Lymphoma receptor sequences, EB1I orphan receptor sequences, EDG1 orphan receptor sequences, G10D orphan receptor sequences, GPR3 orphan receptor sequences, GPR6 orphan receptor sequences, GPR10 orphan receptor sequences, LCR1 orphan receptor sequences, mas oncogene sequences, RDC1 orphan receptor sequences, SENR orphan receptor sequences, calcitonin receptor sequences, parathyroid hormone receptor sequences, secretin receptor sequences, extracellular calcium sensing receptor sequences, a GABA receptor sequences, HF1AO41 sequences, HOFNH30 sequences, HCEGH45 sequences, HPRAJ70 sequences, HGBER32 sequences, HFIZO41 sequences, HIBCD07 sequences, a GPR receptor sequences, including, but not limited to, GPR1, GPR 27, GPR30, CPR31, GPR34, GPR 35, GPR37, GPR45, GPR52, GPR55, GPR61, GPR62, GPR63, GPR77, GPR88, epidermal growth factor (EGF)-TM7 protein sequences, Ca(2+)(o)-sensing receptor (CaR) sequences, a leucine-rich repeat-containing G protein-coupled receptor sequences, chemokine receptor sequences, pheromone receptor sequences, tachykinin receptor sequences, melanocortin receptor sequences, a viral GPCR receptor sequences, VPAC(1) sequences, VPAC(2) sequences, PARI sequences, CRF-R sequences, Emrl sequences, HIBCD07 sequences, HLWAR77 sequences, an SREB GPCR sequences, an Edg receptor sequences, a lysophospholipid receptor sequences, SALPR sequences, GH-secretagogue receptor (GHS-R) sequences, a PACAP receptor sequences, an EBI-2 GPCR sequences, a vasopressin receptor (e.g., V2 vasopressin renal receptor (V2R) sequences, a follicle stimulating hormone receptor sequences, lutropin-chroiogonadotrpic hormone receptor sequences, thyrotropin receptor sequences, Mas proto-oncogene receptor sequences, RDC1 sequences, a class E cAMP receptor sequences, ocular albinism protein receptor sequences (e.g., OA1), frizzled receptor sequences, smooth receptor sequences, Mlo receptor sequences, nematode chemoreceptor sequences, unclassified GPCRs, sequences, class Y GPCR sequences, homologous, mutated, or variant forms thereof, and sequences whose expression is turned on or off upon activation of these receptors, or whose expression negatively or positively regulates the expression of these receptors, and/or their homologous, mutant or variant forms.

In another aspect, the sequences which are used to generate molecular probes are selected from the group consisting of: one or more of SL1, C42, cdk1, cdk7, CycH, C42, C14, PCNA, R11, R10, CycD, p21, S9, CycA, RPA, S9, CycB, p68, primase, R2, Polα, CycE, Skp1, CBF3, C26, E2f, DMP1, cdc25a, CycD, cdk4/6, Gadd45, p26, p27, p53, p57, C17, C18, C23, C21, C13, C28, C30, C37, C38, C39, E20, pS76, Chk1, C-TAK1, APC, cdc25C, cdk1, cks1, Wee1, Myt1, Plk1, C15, C41, C37, C6, pTY4Y15, pT161, pS216, pY15, and other molecules in the cyclin-E2F cell cycle control system (see, e.g., as described at http://discover.nci.nih.gov/kohnk/interaction_maps.html), and homologs, mutants and/or variants thereof.

In another aspect, the sequences which are used to generate molecular probes are selected from the group consisting of: one or more of Rpase II, TBP, TAFH250, P36, RHA, MDM2, p53, p27, CSB, XPB/D, p36, cdk7, cycH, C43, P11, A5, C43, c-Abl, H7, p16, cycD, cdk4, primase, R2, p21, cycE, cycA, cdk2, PCNA, Polα, p70, N10, N7, S1, S2, S7, S8, S10, S11, S12, S13, S14, S16, S17, p34, rad52, SBF3, Skp1, Skp2, R1, DNAP α, p68, RF-C, FEN-1, ligase 1, Gadd45, XPC, cycD, PARP, karp, Ku80, Ku70, RPA2, HMG, histones, ATM, paxillin, Crk, pRb, RAD51, ss or ds DNA breaks, XPF, XPC, XPA, XPG, DNAPβ, ligaseII, ERCC1, U-glycosylase, BRCA1, pKCα/β, PARP, glycohydrolase, and other genes involved in the p53-MDM2 DNA repair pathway, and homologs, mutants and/or variants thereof.

In another aspect, the sequences which are used to generate molecular probes are selected from the group consisting of sequences associated with cholesterol metabolism: one or more of LDL-receptor, VLDL, HDL, cholesterol acyltransferase, apoprotein E, ApoA-I and A-II, HMGCoA reductase, and homologs, mutants and/or variants thereof.

In another aspect, the sequences which are used to generate molecular probes are selected from the group consisting of sequences involved in apoptosis, such as one or more of Bcl, Bak, ICE proteases, Ich-1, CrmA, CPP32, APO-1/Fas, DR3, FADD containing proteins, perforin, p55 tumor necrosis factor (TNF) receptor, NAIP. IAP, TRADD-TRAF2 and TRADD-FADD, TNF, D4-GDI, NF-kB, CPP32/apopain, CD40, IRF-1, p53, apoptin, and homologs, mutants and/or variants thereof.

In a further aspect, the sequences which are used to generate molecular probes are selected from the group consisting of sequences whose products are involved in blood clotting, such as thrombin, fibrinogen, factor V, Factor VIII-FVa, FVIIIa, Factor XI, Factor Xia, Factors IX and X, thrombin receptor, Thrombomodulin™, protein C (PC) to activated protein C (aPC). aPC, plasminogen activator inhibitor-1 (PAI-1), tPA (tissue plasminogen activator), and homologs, mutants and/or variants thereof.

In still a further aspect, the sequences which are used to generate molecular probes are selected from the group consisting of sequences whose products are involved in the flt-3 pathway, such as, flt-3, GRP-2, SHP-2, SHIP, Shc, and homologs, mutants and/or variants thereof.

In another aspect, the sequences which are used to generate molecular probes are selected from the group consisting of sequences whose products are involved in the JAK/STATS signaling pathway, such as Jak1, Jak2, IL-2, IL-4 and IL-7, Jak3, Ptk-2, Tyk2, EPO, GH, prolactin, IL-3, GM-CSF, G-CSF, IFN gamma, LIF, OSM, IL-12 and IL-6, IFNR-alpha, IFNR-gamma, IL-2R beta, IL-6R, CNTFR, Stat1 alpha, Stat1 beta, Stats2-6, and homologs, mutants and/or variants thereof.

In still a further aspect, the sequences which are used to generate molecular probes are selected from the group consisting of sequences whose products are involved in a MAP kinase signaling pathway, such as flt-3, ras, raf, Grb2, Erk-1, Erk-2, Src, sos, Shc, Erb2, gp130, MEK-1, MEK-2, hsp 90, JNK, p38, Sin1, Sty1/Spc1, MKK's, MAPKAP kinase-2, JNK/SAPK, and homologs, mutants and/or variants thereof.

In still a further aspect, the sequences which are used to generate molecular probes are selected from the group consisting of sequences whose products are involved in a PI 3 kinase pathway, such as SHIP, Akt, and homologs, mutants and/or variants thereof.

In still a further aspect, the sequences which are used to generate molecular probes are selected from the group consisting of sequences whose products are involved in a ras activation pathway, such as p120-Ras GAP, neurofibromin, Gap1, Ral-GDS, Rsbs 1, 2, and 4, Rin1, MEKK-1, and phosphatidylinositol-3-OH kinase (PI-3 kinase), ras, and homologs, mutants and/or variants thereof.

In another aspect, the sequences which are used to generate molecular probes are selected from the group consisting of sequences whose products are involved in an SIP signaling pathway, such as GRB2, SIP, ras, PI 3-kinase, and homologs, mutants and/or variants thereof.

In still a further aspect, the sequences which are used to generate molecular probes are selected from the group consisting of sequences whose products are involved in an SHC signaling pathway, such as trkA, trkb, NGF, BDNF, NT-4/5, trkC, f NT-3, Shc, PLC gamma 1, PI-3 kinase, SNT, ras, rafi, MEK, MAP kinase, and homologs, mutants and/or variants thereof.

In still another aspect, the sequences which are used to generate molecular probes are selected from the group consisting of sequences whose products are involved in the in a TGF- [symbol] signaling pathway, such as BMP, Smad 2, Smad4, activin, TGF- [symbol] , and homologs, mutants and/or variants thereof.

In still a further aspect, the sequences which are used to generate molecular probes are selected from the group consisting of sequences whose products are involved in a T cell receptor based signaling pathway, such as lck, fyn, CD4, CD8, T cell receptor proteins, and homologs, mutants and/or variants thereof.

In still a further aspect, the sequences which are used to generate molecular probes are selected from the group consisting of sequences whose products are involved in MHC mediated antigen presentation, such as TAP proteins, LMP 2, LMP 7, gp 96, HSP 90, HSP 70, class I molecules, class II molecules, and homologs, mutants and/or variants thereof.

The sequences which are used to generate molecular probes can also be selected from the group consisting of one or more tyrosine kinase pathway molecules. Such molecules include, but are not limited to, NTRK1; PTK2; SRK; CTK; TYRO3; BTK; LTK; SYK; STY; TEK; ERK; TIE; TKF; NTRK3; MLK3; PRKM4; PRKM1; PTK7; EEK; MNBH; BMX; ETK1; MST1R; 135 KD BTK-Associated Protein; LCK; FGFR2; TYK3; FER; TXK; TEC; TYK2; EPLG1; EMT; EPHT1; ZRK; PRKMK1; EPHT3; GAS6; KDR; AXL; FGFR1; ERBB2; FLT3; NEP; NTRKR3; EPLG5; NTRK2; RYK; BLK; EPHT2; EPLG2; EPLG7; JAK1; FLT1; PRKAR1A; WEE1; ETK2; MuSK; INSR; JAK3; FMS-related tyrosine kinase-3 ligand; PRKCB1; HER3; JAK2; LIMK1; DUSP1; DMD; HCK; YWHAH; RET; YWHAZ; YWHAB; HTK; MAP Kinase Kinase 6; PIK3CA; CDKN3; Diacylglycerol Kinase; PTPN13; ABL1; DAGK1; Focal Adhesion Kinase 2; EDDR1; ALK; PIK3CG; PIK3R1; EHK1; KIT; FGFR3; VEGFC; MST1; FHC; EGFR; S100A10; NF1; TRK; CML; GRB7; S100A4; RASA2; MET; STAT3; smg GDS-Associated Protein; Ubiquitin-Binding Protein P62; LCP2; EPS15; GRB10; GDNFRA; SHC1; CF; TPM3; CDC2; LGMD2C; Ash Protein; TSD; AGRN; S100A6; HPRT1; Cytovillin; GLG1; GRB14; FES; P32 Splicing Factor SF2 Associated Protein; Cartilage-Derived Morphogenetic Protein 1; PAX5; IRS1; SOS2; PIGA; RHO; TGFBR2; CSF1R; PDNP1; NPM1; ADD1; HMMR; ESR; SLA; PGF; ETV6; M6P2; FGR; FGF8; SNX1; TCF1; HGF; IL6R; YES1; ENG; HCLS1; GTF2H1; PDGFB; PDCD1; TGFBR1; EPS8; VEGF; CAR; ANGPT2; Glial Cell Line-Derived Neurotrophic Factor Receptor-BetA; and H4 gene, their targets, and homologs, mutants and/or variants thereof.

In another aspect of the invention, molecular probes are antibodies or antigen binding fragments thereof which specifically bind to any of the peptide, polypeptide, or proteins described above.

Antibodies specific for a large number of known antigens are commercially available. Alternatively, or in the case where the expression characteristics of an uncharacterized biomolecule, such as a polypeptide, are to be analyzed, one of skill in the art can generate their own antibodies, using standard techniques.

In order to produce antibodies, various host animals are immunized by injection with the growth-related polypeptide or an antigenic fragment thereof. Useful animals include, but are not limited to rabbits, mice, rats, goats, and sheep. Adjuvants can be used to increase the immunological response to the antigen. Examples include, but are not limited to, Freund's adjuvant (complete and incomplete), mineral gels such as aluminum hydroxide, surface active substances such as lysolecithin, pluronic polyols, polyanions, peptides, oil emulsions, keyhole limpet hemocyanin, dinitrophenol, and adjuvants useful in humans, such as BCG (bacille Calmette-Guerin) and Corynebacterium parvum. These approaches will generate polyclonal antibodies.

Monoclonal antibodies specific for a polypeptide can be prepared using any technique that provides for the production of antibody molecules by continuous cell lines in culture. These include, but are not limited to, the hybridoma technique originally described by Kohler and Milstein, 1975, Nature 256: 495-497, the human B-cell hybridoma technique (Kosbor et al., 1983, Immunology Today 4: 72; Cote et al., 1983, Proc. Natl. Acad. Sci. USA. 80: 2026-2030) and the EBV-hybridoma technique (Cole et al., 1985, In Monoclonal Antibodies and Cancer Therapy, Alan R. Liss, Inc., pp. 77-96). In addition, techniques developed for the production of “chimeric antibodies” (Morrison et al., 1984, Proc. Natl. Acad. Sci. USA 81:6851-6855; Neuberger et al., 1984, Nature 312: 604-608; Takeda et al., 1985, Nature 314: 452-454) by splicing the genes from a mouse antibody molecule of appropriate antigen specificity together with genes from a human antibody molecule of appropriate biological activity can be used. Alternatively, techniques described for the production of single chain antibodies (see, e.g., U.S. Pat. No. 4,946,778) can be adapted to produce growth-related polypeptide-specific single chain antibodies. The entireties of these references are incorporated by reference herein.

Antibody fragments which contain specific binding sites of a growth-related polypeptide can be generated by known techniques. For example, such fragments include, but are not limited to, F(ab′)2 fragments which can be produced by pepsin digestion of the antibody molecule and the Fab fragments which can be generated by reducing the disulfide bridges of the F(ab′)2 fragments. Alternatively, Fab expression libraries can be constructed (Huse et al., 1989, Science 246: 1275-1281) to allow rapid and easy identification of monoclonal Fab fragments with the desired specificity to a growth-related polypeptide. An advantage of cloned Fab fragment genes is that it is a straightforward process to generate fusion proteins with, for example, green fluorescent protein for labeling.

Antibodies, or fragments of antibodies can be used to quantitatively or qualitatively detect the presence of growth-related polypeptides or conserved variants or peptide fragments thereof. For example, immunofluorescence techniques employing a fluorescently labeled antibody coupled with light microscopic, or fluorimetric detection can be used.

In preferred embodiments, antibodies are used which are specific for specific allelic variants of a protein or which can distinguish the modified from the unmodified form of a protein (e.g., such as a phosphorylated vs. an unphosphorylated form, a glycosylated vs. an unglycosylated form of a polypeptide, an adenosylated vs. unadenosylated form of a polypeptide). For example, peptides or polypeptides, comprising protein allelic variations can be used as antigens to screen for antibodies specific for these variants. Similarly modified peptides, polypeptides, or proteins can be used to screen for antibodies which bind only to the modified form of the protein and not to the unmodified form. Methods of making allele-specific antibodies and modification-specific antibodies are known in the art and described in U.S. Pat. No. 6,054,273; U.S. Pat. No. 6,054,273; U.S. Pat. No. 6,037,135; U.S. Pat. No. 6,022,683; U.S. Pat. No. 5,702,890; U.S. Pat. No. 5,702,890; and in Sutton et al., J. Immunogenet. 14(1): 43-57 (1987), for example; the entireties of which are incorporated by reference herein.

In addition to nucleic acids, peptides, polypeptides, and proteins, molecular probes can also include other cellular polymers such as oligosaccharides and/or phospholipids. Synthetic molecular probes also can be provided on the substrate used in the first assay. For example, peptide mimetics, drug congeners, and other small molecules can be designed and arrayed on a substrate for use in first assays. In one aspect, synthetic molecular probes are obtained commercially such as from Maybridge Chemical Co. (Trevillet, Cornwall, UK), Comgenex (Princeton, N.J.), Brandon Associates (Merrimack, N.H.), and Microsource (New Milford, Conn.). Combinatorial libraries also can be prepared to generate a plurality of molecular probes.

Small molecules according to the invention have a molecular weight ranging from less than about 100 daltons, less than about less than about 200 daltons, less than about 400 daltons, less than about 500 daltons, less than about 750 daltons, to less than about 2,500 daltons. Small molecules include, but are not limited to heterocycles, saccharides, steroids, and the like.

### Sources of Target Samples

In a preferred aspect, target samples are generated from a single patient using a plurality of tissue samples from the patient. In one aspect, the target samples are genomic DNA, DNA amplified from genomic DNA, total RNA, mRNA, cDNA, cRNA transcribed from the cDNA, RNA transcribed from amplified DNA, peptides, polypeptides, proteins, oligosaccharides, from tissue samples or are pieces, chunks, slices, portions, or fragments of tissues themselves. Tissue samples can be obtained from cadavers or from patients who have recently died (e.g., from autopsies). Tissues also can be obtained from surgical specimens, pathology specimens (e.g., biopsies), from samples which represent “clinical waste” which would ordinarily be discarded from other procedures. Samples can be obtained from adults, children, and/or fetuses (e.g., from elective abortions or miscarriages).

Target samples also can be total RNA, mRNA, cDNA, collections of peptides, polypeptides, proteins, and/or oligosaccharides, and other cellular biomolecules, from cells or can be whole cells or portions, slices or sections of cells. Generally, as used herein a “cell sample” will refer to any of: whole cells, portions, slices or sections of cells. Cells can be obtained from suspensions of cells from tissues (e.g., from a suspension of minced tissue cells, such as from a dissected tissue), from bodily fluids (e.g., blood, plasma, sera, and the like), from mucosal scrapings (e.g., such as from buccal scrapings or pap smears), and/or from other procedures such as bronchial lavages, amniocentesis procedures and/or leukapheresis. In some aspects, cells are cultured first to expand a population of cells to be analyzed. Cells from continuously growing cell lines, from primary cell lines, and/or stem cells, also can be used.

In one aspect, target samples, such as those used in the second assay, comprise a plurality of samples from tissues/cells from a single individual, i.e., the substrate comprising the plurality of target samples represents substantially the “whole body” of an individual. Preferably, samples from at least about two, or at least about five, at least about ten, or at least about 15 different types of tissues from a single patient are disposed at distinct known locations on a substrate. Preferably, a plurality of different sample types are obtained from a single type of tissue/or cell population; e.g., for any given tissue type, preferably at least two of: a genomic DNA sample, a total RNA/mRNA/and/or cDNA sample, a peptide, polypeptide, protein, oligosaccharide, other cellular biomolecules, a cell sample, and/or tissue sample are obtained.

Tissues can be selected from the group consisting of: skin, neural tissue, cardiac tissue, liver tissue, stomach tissue, large intestine tissue, colon tissue, small intestine tissue, esophagus tissue, lung tissue, cardiac tissue, spleen tissue, pancreas tissue, kidney tissue, tissue from a reproductive organ(s) (male or female), adrenal tissue, and the like. Tissues from different anatomic or histological locations of a single organ can also be obtained to provide samples, e.g., such as from the cerebellum, cerebrum, and medulla, where the organ is the brain. In one aspect, the plurality of target samples in the second assay comprise one or more sets of samples representative of organ systems (i.e., a set comprising a plurality of samples, each sample from different organs within an organ system). In one aspect, the system is the respiratory system, urinary system, kidney system, cardiovascular system, digestive system, and reproductive system (male or female). In a preferred aspect, target samples further include at least one sample of cells or nucleic acids or polypeptides from a bodily fluid of the patient (e.g., such as from a blood sample).

Patients providing the samples on a particular substrate used in the second assay can comprise individuals sharing a trait. For example, the trait shared can be gender, age, pathology, predisposition to a pathology, exposure to an infectious disease (e.g., HIV), kinship, death from the same disease, treatment with the same drug, exposure to chemotherapy, exposure to radiotherapy, exposure to hormone therapy, exposure to surgery, exposure to the same environmental condition (e.g., such as carcinogens, pollutants, asbestos, TCE, perchlorate, benzene, chloroform, nicotine and the like), the same genetic alteration or group of alterations, expression of the same gene or sets of genes (e.g., samples can be from individuals sharing a common haplotype, such as a particular set of HLA alleles), and the like.

Samples also can be obtained from an individual with a disease or pathological condition, including, but not limited to: a blood disorder, blood lipid disease, autoimmune disease, bone or joint disorder, a cardiovascular disorder, respiratory disease, endocrine disorder, immune disorder, infectious disease, muscle wasting and whole body wasting disorder, neurological disorders including neurodegenerative and/or neuropsychiatric diseases, skin disorder, kidney disease, scleroderma, stroke, hereditary hemorrhage telangiectasia, diabetes, disorders associated with diabetes (e.g., PVD), hypertension, Gaucher's disease, cystic fibrosis, sickle cell anemia, liver disease, pancreatic disease, eye, ear, nose and/or throat disease, diseases affecting the reproductive organs, gastrointestinal diseases (including diseases of the colon, diseases of the spleen, appendix, gall bladder, and others) and the like. For further discussion of human diseases, see Mendelian Inheritance in Man: A Catalog of Human Genes and Genetic Disorders by Victor A. McKusick (12th Edition (3 volume set) June 1998, Johns Hopkins University Press, ISBN: 0801857422), the entirety of which is incorporated herein.

Preferably, samples of the same tissue(s) from a normal demographically matched individual and/or from non-diseased tissue from the patient having the disease, are arrayed on the same or a different microarray to provide controls.

In some aspects, target samples are from individuals have more than one disease condition (e.g., stroke and cardiovascular disease) and from individuals with only one of each of the diseases (e.g., samples from stroke patients without cardiovascular disease and samples from patients with cardiovascular disease but who have not experienced stroke). In some aspects, samples are from individuals with a chronic disease (e.g., such as Crohn's disease) and samples on the array include samples from patients in a remission period as well as samples from patients in an exacerbation period.

In a preferred aspect, the plurality of target samples represents different stages of a cell proliferative disorder, such as cancer. In one aspect, in addition to including samples which comprise the primary target of the disease (e.g., such as tumor samples), target samples are provided which represent metastases of a cancer to secondary tissues/cells. Preferably, samples of normal (non-diseased) tissues also are provided as controls, preferably from the same patient from whom the abnormally proliferating tissue was obtained, but normal tissues from other individuals also may be used as controls In some aspects, at least one target sample is from a cell line of cancerous cells (either primary or continuous cell lines). Target samples can be homogeneous, comprising a single cell type, or can be heterogeneous, comprising at least one additional type of cell or cellular material in addition to abnormally proliferating cells. For example, the sample can comprise abnormally proliferating cells and at least one of: fibrous tissue, inflammatory tissue, necrotic cells, apoptotic cells, normal cells, and the like.

Although in a preferred aspect of the invention, target samples are from humans, target samples from other organisms may be used. In one aspect, samples are from non-human animals which provide a model of a disease or other pathological condition (e.g. xenograft tissue grown in mice). It is shown in the art that a patient tissue derived xenograft grown in mice is comparable with the original clinical tissues, providing a clinical-matched model for determining the expression and regulation of biomarkers in diseases. (Merk J et al., European Journal of Cardio-thoracic Surgery, 2009, 36, 454-459; Sausville E and Burger A M, Cancer Res, 2006, 66, 3351-3354, each of which is incorporated herein by reference in its entirety.)

Preferably, a plurality of target samples are provided which represent different stages of the disease. Target samples also can be from cells/tissues from a non-human animal having the disease or condition which has been exposed to a therapy for treating the disease or condition (e.g., drugs, antibodies, protein therapies, gene therapies, antisense therapies, combinations thereof, and the like). In some aspects, the non-human animals can comprise at least one cell containing an exogenous nucleic acid (e.g., the animals can be transgenic animals, chimeric animals, knockout or knockin animals). Preferably, target samples from non-human animals comprise samples from multiple tissues/cell types from such a non-human animal. In one aspect, samples are from tissues/cells at different stages of development.

In still further aspects, samples from plants are obtained. Preferably, such samples include samples from plants at different stages of their life cycle and/or comprise different types of plant tissues (e.g., at least about two, or at least about five different plant tissues). In one aspect, samples are obtained from plants which comprise at least one cell containing an exogenous nucleic acid (e.g., the plant can be a transgenic plant).

Obtaining Nucleic Acid Target Samples from Tissues/cells

In one aspect, target samples comprise nucleic acids comprising RNA transcripts or molecules generated therefrom. Preferably, the samples are contacted with one or more inhibitors or destroyers of RNAse before use in the first or second assay. In some aspects, cells or tissues are homogenized in the presence of chaotropic agents to inhibit these nucleases. In other aspects, RNAases are inhibited or destroyed by heat treatment followed by proteinase treatment.

In one aspect, the target sample comprising RNA transcripts is a total RNA sample. Methods of isolating total mRNA are well known to those of skill in the art. For example, methods of isolation and purification of nucleic acids are described in detail in Chapter 3 of Laboratory Techniques in Biochemistry and Molecular Biology: Hybridization With Nucleic Acid Probes, Part I. Theory and Nucleic Acid Preparation, P. Tijssen, ed. Elsevier, N.Y. (1993) and Chapter 3 of Laboratory Techniques in Biochemistry and Molecular Biology: Hybridization With Nucleic Acid Probes, Part I. Theory and Nucleic Acid Preparation, P. Tijssen, ed. Elsevier, N.Y. (1993).

In one aspect, total RNA is isolated using an acid guanidinium-phenol chloroform extraction method as is known in the art. For example, after obtaining a tissue or cell sample of interest, the sample can be quick frozen in liquid nitrogen to prevent degradation of RNA. Preferably, where the sample is a tissue sample or a portion thereof, samples are ground, minced, and/or homogenized. Cell/tissue samples or portions thereof can be treated with guanidinium and then centrifuged to obtain a sample enriched for nucleic acids. The resulting supernatant can be incubated at 65° C. for at least about one minute in the presence of about Sarkosyl, layered over a 5.7M CsCl solution (0.1 g CsCl/ml), and separated by centrifugation overnight (e.g., at about 113,000×g) at 22° C. RNA will pellet and can be subsequently incubated overnight (or longer) at 4° C. in the presence of a suitable buffer (e.g., 5 mM EDTA, 0.5% (v/v) Sarkosyl, 5% (v/v) 2-ME) to allow complete resuspension of the RNA pellet. The resulting RNA solution can then be extracted sequentially with phenol/chloroform/isoamyl alcohol, preferably at a ratio of 25:24:1. Preferably, an additional extraction is performed in a 24:1 chloroform/isoamyl alcohol mixture, and the RNA is precipitated by the addition of a suitable salt, such as 3 M sodium acetate, in alcohol (e.g., 100% ethanol) and resuspended in DEPC water (see, e.g., as described in Chirgwin et al., 1979, Biochemistry 18: 5294).

Alternatively, RNA can be isolated using a single step protocol. For example, a tissue/cell(s) of interest can be prepared by contacting with denaturing solution (in the case of tissue, after homogenizing, mincing, etc) a suitable volume of denaturing agent, precipitating salt, phenol and a 49:1 solution of chloroform/isoamyl alcohol. The sample is separated by centrifugation (e.g., for 20 minutes at 10,000×g at 4° C.) precipitated by the addition of a suitable volume of 100% isopropanol, incubated at −20° C. (e.g., for about 20 minutes) and pelleted by centrifugation for 10 minutes at 10,000×g, 4° C. The RNA pellet is washed in 70% ethanol, dried, and resuspended in RNAse free buffer (e.g., DEPC-treated water or DEPC-treated 0.5% SDS) (Chomczynski and Sacchi, 1987, Anal. Biochem., 162:156).

Polyadenylated RNA (i.e., RNA representing mRNA) additionally can be isolated from total RNA using oligo(dT) column chromatography or by using (dT) on magnetic beads (see, e.g., Sambrook et al., 1989, Molecular Cloning. A Laboratory Manual (2nd ed.), Vols. 1-3, Cold Spring Harbor Laboratory, or Current Protocols in Molecular Biology, F. Ausubel et al., ed. Greene Publishing and Wiley-Interscience, New York, 1987.

In one aspect, after obtaining a population of mRNA molecules, these are converted to a form more suitable for their use as target samples. For example, in one aspect, mRNA samples are converted to cDNA samples by reverse transcriptase using degenerate primers to provide a form of nucleic acids representative of mRNA molecules in the target sample but which are resistant to degradation by RNAases. cDNAs can be further amplified by PCR (see, e.g., Innis, et al., 1990, PCR Protocols. A Guide to Methods and Application. Academic Press, Inc. San Diego), or any other amplification method. RNA molecules also can be amplified, for example, in transcription-based amplification methods (see, e.g., Van Gelder, et al., 1990, Proc. Natl. Acad. Sci. USA 87: 1663-1667; Eberwine et al. Proc. Natl. Acad. Sci. USA 89: 3010-3014).

Amplified polynucleotides can be purified by methods routine in the art (e.g., column purification and/or alcohol precipitation). A polynucleotide is considered pure when it has been isolated so as to be substantially free of primers and incomplete products produced during the amplification process. Preferably, a purified polynucleotide will also be substantially free of contaminants which may substantially hinder (i.e., decrease by greater than about four-fold) or otherwise mask the specific binding activity of the molecule.

In identifying sequences to amplify and stably associate with the substrate, preferably unique sequences are identified within any given sequence of interest (e.g., a gene sequence).

In another aspect, genomic nucleic acids are obtained to provide target samples, for example, for Comparative Genomic Hybridization (CGH) analyses. In this aspect, genomic DNA can be isolated according to methods routine in the art. For example, Laird (1991, Nucleic Acids Research 19: 4293) describes a DNA extraction method which comprises adding an appropriate volume of lysis buffer (e.g., 100 mM Tris Hcl pH 8.5, 0.5M EDTA, 10% SDS, 5M NaCl 20 mg/ml Proteinase K) incubating for an appropriate period of time (at about 37° C. for about 2-3 hours for cells or at 55° C. for tissue), preferably with agitation. About one volume of isopropanol is added to the solution to precipitate the genomic DNA and DNA recovered by lifting the aggregated precipitate, for example, using a pipette tip. DNA is then resuspended in an appropriate volume of buffer (500 ul to 10 mM Tris HCl, 0.1 mM EDTA, pH 7.5), and preferably with agitation at 37° C. or 55° C.). Many additional methods are known and are described in the art. (for example, Sambrook et al., 1989, Molecular Cloning: A Laboratory Manual, Cold Spring Harbor Laboratory, Cold Spring Harbor, N.Y.). Target nucleic acids can also be obtained from embedded cell or tissue specimens using methods known in the art.

In another aspect, cellular peptides, polypeptides, and/or proteins are provided as target samples. For this purpose, a cell lysate can be generated by contacting cells and/or tissue with lysis buffer (e.g., such as 10 mM Tris pH 7.4, 1.0% Triton X-100, 0.5% Nonidet P-40, 150 mM NaCl, 20 mM sodium fluoride, 0.2 mM sodium ortho-vanadate, 1.0 mM EDTA, 1.0 mM EGTA, 0.2 mM PMSF and proteases inhibitors). Genomic DNA and RNA can be removed by adding RNAase or DNAse and nucleic acids removed by washing the lysed cells or tissues in a suitable buffer, leaving the remaining peptides, polypeptides, and/or proteins behind as well as other molecules which might be of interest as target biomolecules (e.g., such as oligosaccharides or phospholipids).

### Embedding Cell or Tissue Samples

In one embodiment of the invention, cells and or tissues are obtained and either paraffin-embedded, plastic-embedded, or frozen. When paraffin-embedded tissues are used, a variety of tissue fixation techniques can be used. Examples of fixatives, include, but are not limited to, aldehyde fixatives such as formaldehyde, formalin or formol, glyoxal, glutaraldehyde, hydroxyadipaldehyde, crotonaldehyde, methacrolein, acetaldehyde, pyruvic aldehyde, malonaldehyde, malialdehyde, and succinaldehyde; chloral hydrate; diethylpyrocarbonate; alcohols such as methanol and ethanol; acetone; lead fixatives such as basic lead acetates and lead citrate; mercuric salts such as mercuric chloride; formaldehyde; dichromate fluids; chromates; picric acid, and heat.

Tissues are fixed until they are sufficiently hard to embed. The type of fixative employed will be determined by the type of molecular procedure being used, e.g., where the molecular characteristic(s) being examined include the expression of nucleic acids, isopentane, or PVA, or another alcohol-based fixative is preferred. Paraffin is preferred for performing immunohistochemistry, in situ hybridization, and in general, for tissues which are going to be stored for long periods of time. When cells are obtained from plasma, the cells may be snap-frozen. OCT embedding is optimal for morphological evaluations.

Embedding media encompassed within the scope of the invention, includes, but is not limited to paraffin or other waxes, plastic, gelatin, agar, polyethlene glycols, polyvinyl alcohol, celloidin, nitrocelluloses, methyl and butyl methacrylate resins or epoxy resins. Water-insoluble embedding media such as paraffin and nitrocellulose require that specimens be dehydrated in several changes of solvent, such as ethyl alcohol, acetone, xylene, toluene, benzene, petroleum, ether, chloroform, carbon tetrachloride, carbon bisulfide, and cedar oil, or isopropyl alcohol prior to immersion in a solvent in which the embedding medium is soluble. Water soluble embedding media such as polyvinyl alcohol, carbowax (polyethylene glycols), gelatin, and agar, can also be used.

In one aspect, tissue or cell specimens are freeze-dried by deep freezing in plastic tissue cassettes and storing them at −80-70° C., such as in liquid nitrogen. In another aspect, the tissues are then covered with a cryogenic media, such as OCT, and kept at −80-70° C., until sectioned. Examples of embedding media for frozen tissues or cells include, but are not limited to, OCT, Histoprep®, TBS, CRYO-Gel®, and gelatin. In another embodiment, a freezing aerosol may be used to facilitate embedding of a donor frozen tissue or cell block. An example of a freezing aerosol is tetrafluoroethane 2.2. Other methods known in the art may also be used to facilitate embedding of a tissue or cell sample and are encompassed within the scope of the invention.

### Substrates

The substrate facilitates handling of the molecular probes in the first assay or target samples in the second assay during a variety of molecular procedures. Preferably, the substrate is transparent and solvent resistant, and can be organic or inorganic. Suitable substrates include, but are not limited to: glass; quartz; fused silica or other nonporous substrates; plastic (e.g., polyolefin, polyamide, polyacarylamide, polyester, polyacrylic ester, polycarbonate, polytetrafluoroethylene, polyvinyl acetate, and the like), and the like. Substrates can additionally include one or more of: fillers (such as glass fillers); extenders; stabilizers; antioxidants; resins (e.g., celluloid, cellophane, urea, formaldehyde, cellulose acetate, ethylcellulose); and the like. The substrate, while preferably rigid, can also be semi-rigid or flexible (e.g., flexible plastic, nylon or nitrocellulose). Preferably, the substrate is optically opaque and substantially non-fluorescent (e.g., for use in applications where fluorescent labels are used to identify or confirm biological characteristics, such as the expression of one or more biomolecules in the target sample).

The surface of the substrate can also contain reactive groups, for example, to facilitate stable association of molecular probes and target samples to the substrate. In one aspect, such reactive groups include, but are not limited to, carboxyl, amino, hydroxyl, thiol, positively charged groups and the like.

The size and shape of the substrate can be varied. However, preferably, the substrate fits entirely on the stage of a microscope. The substrate can be in the form of particles, strands, precipitates, gels, sheets, tubing, spheres, containers, capillaries, pads, slices, films, plates, slides, microtiter plates, and the like. The substrate may have any convenient shape, such as a disc, square, sphere, circle, etc. In one aspect, the substrate is planar; however, in another aspect, the substrate comprises irregularities or cavities (e.g., in which synthesis reactions can take place).

In one aspect of the invention, the substrate comprises a location for placing an identifier (e.g., a wax pencil or crayon mark, an etched mark, a label, a bar code, a microchip for transmitting radio or electronic signals, and the like). For example, the identifier can be a microchip which communicates with a processor which comprises, or can access, stored information relating to the identity and address of different locations of target samples and/or molecular probes on the substrate and/or including patient information regarding the individual from whom the tissue was taken.

In one aspect, the substrate is associated with one or more electrical elements, for example, to electronically address different molecular probes on a substrate. Preferably, an electric charge at a particular location on the substrate can be changed between a net positive and a net negative charge so that molecules in contact with the substrate at one position can be directed toward or away from another position on the substrate. Methods of electronically addressing substrates are known in the art and are described in, for example, U.S. Pat. No. 6,238,868; WO 96/01836; Sonoski et al., 1997, Proc. Natl. Acad. Sci. USA 94: 119-123; and Edman et al., 1997, Nucl. Acid Res. 25: 4907-14, the entireties of which are incorporated by reference herein. In this aspect, the substrate also can be associated with one or more electrodes and/or permeation layers.

Preferably, the molecular probes and/or target samples are stably associated with the substrate, e.g., through covalent, ionic, or non-ionic associations, i.e., forming microarrays. The invention preferably provides sets of different types of microarrays comprising a plurality of different types of biomolecules arrayed on the same or different substrates wherein the biomolecules are obtained from the same patient, and preferably, from the same tissue/cell types of the same patient.

### Generating Microarrays Comprising Molecular Probes

Microarrays comprising molecular probes are known in the art as are methods for their fabrication. See, e.g., U.S. Pat. No. 6,239,273; U.S. Pat. No. 5,242,974; U.S. Pat. No. 5,384,261; U.S. Pat. No. 5,405,783; U.S. Pat. No. 5,412,087; U.S. Pat. No. 5,424,186; U.S. Pat. No. 5,429,807; U.S. Pat. No. 5,436,327; U.S. Pat. No. 5,445,934; U.S. Pat. No. 5,472,672; U.S. Pat. No. 5,527,681; U.S. Pat. No. 5,529,756; U.S. Pat. No. 5,545,531; U.S. Pat. No. 5,554,501; U.S. Pat. No. 5,556,752; U.S. Pat. No. 5,561,071; U.S. Pat. No. 5,599,895; U.S. Pat. No. 5,624,711; U.S. Pat. No. 5,639,603; U.S. Pat. No. 5,658,734; U.S. Pat. No. 5,700,637; U.S. Pat. No. 5,744,305; U.S. Pat. No. 5,770,456; WO 93/17126; WO 95/11995; WO 95/35505; EP 742 287; and EP 799 897, the entireties of which are incorporated herein by reference.

### Nucleic Acid Microarrays

As defined herein, a “nucleic acid array” refers a plurality of nucleic acid probes stably associated with a substrate at a plurality of distinct known locations such as by covalent, ionic, or nonionic bonding. Stable associations can be achieved by crosslinking (e.g., by ultraviolet irradiation, by heat, by mechanical or chemical bonding procedures, by using a vacuum system, or through a combination of techniques), using methods routine in the art. In one aspect, probes are linked to capture nucleic acid molecules which are themselves stably associated with distinct locations on the substrate by hydrogen bonding. In this aspect, the capture oligonucleotide is a sequence complementary to a subsequence (e.g., about 5-50 bases, preferably, about 8-25 bases of a particular nucleic acid probe).

In one aspect, a molecular probe comprises a plurality of identical or substantially identical oligonucleotides attached at a distinct known location on the substrate at a density of at least about 10 oligonucleotides/cm², preferably at least about 20 oligonucleotides/cm², at least about 50 oligonucleotides/cm², or at least about 100 oligonucleotides/cm². The substrate is addressed in that the identity/sequence of each molecular probe at a particular location is known. Preferably, this information is recorded in a database, indexed according to the coordinates of the molecular probes on the array.

In one aspect, the nucleic acid probe comprises identical or substantially identical oligonucleotide sequence(s). However, in another aspect, the nucleic acid probe comprises a homogeneous cDNA population (one or more cDNAs which have been transcribed from RNA molecules having identical or substantially identical sequences). Preferably, a nucleic acid probe is at least about 6, at least about 10, at least about 15, at least about 20, at least about 50, at least about 75, or at least about 100 to at least about 6000 nucleotides in length. Preferably, the substrate comprises at least about 100, at least about 500, at least about 1000, or at least about 10,000 different nucleic acid probes at different distinct known locations. Preferably, at least about 90% of molecular probes on a substrate used in the first assay are unique.

However, it is preferred that not all of the probes on the substrate are unique. For example, in one aspect, identical probes are duplicated at different known locations on the substrate to provide internal controls. For example, other sequences such as housekeeping genes and/or vector sequences can be used as controls (e.g., such as ubiquitin, phospholipase A2, hypoxanthine-guanine phosphoribosyl transferase, glyceraldehyde 3-phosphate dehydrogenase, tubulin, HLA class I histocompatibility antigen, C-4 alpha chain, actin, 23 kDa highly basic protein and ribosomal protein S9).

In one aspect, “other species nucleic acids” can be used as controls. For example, if the probes on the substrate are from humans, plant sequences can be used as controls (or fish or fly or rat or mouse). Additional controls include mismatch controls such as are known in the art. Controls are preferably placed in asymmetric locations and/or at corners on the substrate.

In one aspect, the nucleic acid probes are arrayed on a substrate at high density as described in WO 92/10588, the entirety of which is incorporated herein by reference for all purposes.

### Expressed Sequence Microarrays

In one aspect, the molecular probes arrayed on the substrate in the first assay are expressed sequences. Expressed sequences can be isolated from target nucleic acids (e.g., from mRNA samples and/or from biomolecules corresponding to these samples, such as cDNAs, and the like) or can be synthesized based on sequence information in databases in which information relating to expressed sequences are stored. For example, such databases include, but are not limited to the NCBI EST database, the LIFESEQ™, database (Incyte Pharmaceuticals, Palo Alto, Calif.), the random cDNA sequence database from Human Genome Sciences, the EMEST8 database (EMBL, Heidelberg, Germany), and the like. In one aspect, expressed sequences are selected for arraying which are expressed in a particular type of cell or tissue, while in another aspect, ESTs are selected which represent the expression products of one or more genes in a particular molecular pathway. In a preferred aspect, ESTs are selected which represent the expression products of a plurality of pathway genes, preferably, including at least one early, one middle, and one late pathway gene.

In one aspect, clustering programs are used to identify common sequence motifs in ESTs and substrates are provided comprising probes which share these motifs in common. In another aspect, the substrate comprises expressed sequence molecular probes which are diagnostic or prognostic of a particular trait such as a disease. In still a further aspect, arrays can be provided which comprise oncogene sequences, cell cycle gene sequences, apoptosis gene sequences, growth factor gene sequences, cytokine gene sequences, interleukin gene sequences, chemokine gene sequences, receptor gene sequences (including GPCR sequences, chemokine receptor sequences, interleukin and interferon receptor sequences, hormone receptor sequences, neurotransmitter receptor sequences), cell adhesion protein-encoding sequences, sequences encoding cytoskeleton and motility proteins, stress response protein gene sequences, sequences of DNA synthesis, repair, and/or recombination, and gene sequences associated with different stages of embryonic development. Typically, the length of the molecular probe will be less than the sequence of the mRNA transcript to which the gene corresponds.

Methods of identifying expressed sequences of interest include any method which identifies differentially expressed genes, such as electronic subtraction and differential display RT-PCR™ (DDRT) (see, e.g., U.S. Pat. No. 6,221,600). In DDRT, subpopulations of complementary DNA (cDNA) are generated by reverse transcription of mRNA by using a cDNA primer with a 3′ extension (preferably about two bases). Random 10 base primers are then used to generate PCR products of transcript-specific lengths. If the number of primer combinations used is large enough, it is statistically possible to detect almost all transcripts present in any given sample. PCR products obtained from two or more samples are then electrophoresed next to one another on a gel and differences in expression are directly compared. Differentially expressed bands can be cut out of the gel, reamplified and cloned sequencing and/or for immobilization on a substrate. Other methods such as serial analysis of gene expression (SAGE) (U.S. Pat. No. 5,866,330, the content of which is incorporated herein by reference in its entirety.) also can be used.

EST sequences, cDNA sequences, transcribed fragments of genomic sequences can be directly or indirectly linked to substrates according to the invention (e.g., by hybridization to capture molecules as described above).

Although in one aspect, expressed sequences which may or may not include coding sequences provide molecular probes, in other aspects, regulatory sequences can be used as probes. For example, promoters, enhancers, promoter/enhancer sequences, transcription termination sequences, polyadenylation sequences, translational regulatory sequences, IRES sequences, replication origins, and the like can be disposed on substrates for use in the first assay.

### Oligonucleotide Arrays

In one aspect, printing techniques are used to provide necessary reagents for the synthesis of oligonucleotides at different known locations on a substrate. For example, barrier material(s), deprotection agent(s), base group(s), nucleoside(s), nucleotide analog(s), coupling agent(s), and capping agent(s), and the like can be laid down on a substrate sequentially to facilitate monomer addition to a polymer. Methods of polymer addition to substrates are known in the art and are described, for example, in U.S. Pat. No. 6,239,273, the entirety of which is incorporated by reference herein. The oligonucleotides can be directly associated with the substrate or can be associated with the substrate through non-oligonucleotide linkers. In one aspect, a 5′ protected nucleoside is provided on a substrate which is blocked by covalent attachment of dimethyltrityl (DMT). The DMT group is removed in a deptrotection cycle by a deprotection agent such as a protic acid (e.g., TCA or dichloroacetic acid) and a washing step can be included (e.g., by contacting with acetonitrile to eliminated the removed protecting group. A coupling step follows in which a phosphoramidite nucleoside is reacted with the deprotected nucleoside. A capping step also can be performed to prevent unreacted nucleosides from participating in further addition cycles (e.g., reacting nascent polymers with acetic anhydride and N-methylimidazole to acetylate free 5′-hydroxyl groups). Oxidation steps can be performed to convert phosphite triester linkages to phosphodiester bonds, such as by using iodine in tetrahydrofuran/water/pyridine.

In one aspect, synthesis of oligonucleotides is directed to known distinct locations on the substrate forming spots or regions of different known molecular probes. The spots or regions can vary in shape and can be smaller than about 1 cm², smaller than about 1 mm², smaller than about 0.5 mm², smaller than about 100 μm², or smaller than about 10,000 nm². The amount of oligonucleotide present in each spot or region will be sufficient to provide for adequate hybridization and detection of target biomolecules during the assay in which the substrate is employed. Generally, the amount of each probe stably associated with the solid support of the array is at least about 0.1 ng, preferably at least about 0.5 ng and more preferably at least about 1 ng, where the amount may be as high as 1000 ng or higher, but will usually not exceed about 20 ng.

Printing techniques which can be used include ink jet printing techniques, xerography, and the like.

Other methods of stably associating nucleic acids on arrays are known in the art, and are encompassed within the scope of the invention. In one aspect, nucleic acid probes are spotted onto the substrate at distinct, known locations using manual methods, but preferably, probes are spotted using robotic or other automated methods. For example, in one aspect, a robotic GMS 417 arrayer (Affymetrix, Calif.) or Beckman Biomek 2000 (Beckman Instruments). See, for example, as described in U.S. Pat. No. 5,770,151 and WO 95/35505, the entireties of which are incorporated herein by reference.

Additional microfabrication technologies for stably associating nucleic acid probes with a substrate include photolithography, micropatterning, light-directed chemical synthesis, laser stereochemical etching and microcontact printing (reviewed in Cheng et al., 1996, Mol. Diagn. 1:183-200). Gene pen devices also can be used (see, e.g., as described in U.S. Pat. No. 6,235,473, which is incorporated herein by reference in its entirety.).

### Aptamer Microarrays

Aptamer probes are also encompassed within the scope of the invention, e.g., to label and/or identify target biomolecules which are not readily bound by nucleic acids using Watson-Crick binding or which are not readily detected by antibodies. Methods of generating aptamers are known in the art and described in U.S. Pat. No. 6,180,406, U.S. Pat. No. 6,051,388, Green et al., 2001, Biotechniques 30(5): 1094-6, 1098, 1100; and Srisawat, 2001, RNA 7(4): 632-41; for example, the entireties of which are incorporated by reference herein. Aptamers can be arrayed in the same way that other nucleic acids are arrayed.

Peptides, Polypeptides and/or Proteins Microarrays

Peptide arrays and polypeptide arrays can be generated in a similar manner to oligonucleotide arrays, i.e., by synthesizing desired peptides/polypeptides at know distinct locations on a substrate using routine methods of synthesis. For example, Pirrung et al., in U.S. Pat. No. 5,143,854, teach large scale photolithographic solid phase synthesis of polypeptides in an array fashion on silicon substrates. In this method, polypeptide arrays are synthesized on a substrate by attaching photoremovable groups to the surface of the substrate, exposing selected regions of the substrate to light to activate those regions, attaching an amino acid monomer (a D- or L-monomer) with a photoremovable group to the activated region, and repeating the steps of activation and attachment until peptides or polypeptides of the desired length and sequences are synthesized.

Purified polypeptides and proteins also can be stably associated with different known locations on a substrate using chemistry well known in the art. An example of a receptor polypeptide chip is described by Karlsson, 1991, J. Imununol. Methods 145: 229-240, 1991 and Cunningham and Wells, J. Mol. Biol. 234:554-563, 1993. A polypeptide/protein can be covalently attached to a substrate using amine or sulfhydryl chemistry or other standard protein coupling chemistry. Polypeptides/proteins also can be stably associated with a substrate using capture molecules such as binding partners, e.g., such as antibodies. In another aspect, antibodies or antigen-binding fragments thereof are molecular probes (see, e.g., as described in Huang et al., 2001, Anal. Biochem. 294(1): 55-62).

In one aspect, chimeric polypeptides are stably associated with the substrate and comprise a heterogeneous domain (a domain not shared by other polypeptides on the substrate) and a homogeneous domain (a domain shared by other polypeptides on the substrate). Preferably the homogeneous domain is used to stably associate the polypeptides to the substrate. For example, in one aspect, polypeptides are fused to an immunoglobulin Fc fragment which in turn is coupled via a second (anti-IgG) antibody that is bound to the substrate. However, homogeneous domains are not necessarily polypeptides but can be any type of linker molecule.

In one aspect, as described in Paweletz et al., 2001, Oncogene 20(16): 1981-9, reverse phase protein arrays are provided which immobilize an entire repertoire of proteins. In a preferred aspect, the repertoire represents individual cell and/or tissue populations responding to a physiological condition such as a disease.

Preferably, peptides, polypeptides, and proteins at each of the distinct known locations on the substrate are substantially pure, i.e., at least about 80%, 90%, 95%, 96%, 97%, 98%, or about 99% pure.

The number of different peptides/polypeptides/proteins on the substrate can vary. In one aspect, at least about 10, at least about 100, at least about 10³, 10⁴, 10⁵, 10⁶, 10⁷, or 10⁸ peptides/polypeptides/proteins are stably associated on substrates of the invention.

### Generating Target Sample Microarrays

In the second assay, target samples rather than probes are stably associated with different known locations on a substrate. For example, in one aspect, target samples are compartmentalized at the different known locations by varying surface features of the substrate. For example, the substrate can be configured to include wells or channels to hold genomic DNA, total RNA, mRNA or molecules corresponding thereto (i.e., amplified products representing these molecules), cellular peptides, polypeptides, proteins, and other cellular biomolecules. In other aspects, target samples can be spotted onto substrates (e.g., as in dot blotting or slot blotting).

Cell and/or Tissue Microarrays

In a preferred embodiment, target samples are cell or tissue samples which are stably associated with distinct known locations on a substrate. In one aspect, cell or tissue microarrays are generated by obtaining donor cells or tissues from any of the target samples described above, embedding these cells or tissues, and obtaining portions of the embedded tissue for placement in a block of embedding matrix into which holes have been cored. When a recipient block is filled with a desired number of donor samples, “a microarray block” is generated which can subsequently be sectioned, each section being placed on any of the substrates described above.

### Forming Donor Blocks

In one aspect, tissues or portions thereof are fixed and embedded as described above. Preferably, tissues are embedded in a mold to form block of embedded tissue. More preferably, after generating a block, a section is obtained and examined to identify cell(s) or regions of interest. For example, in one aspect, a section is stained to facilitate visualization of cellular morphology, and the coordinates of particular cells of interest (e.g., abnormally proliferating cells) are noted. In another aspect, cell(s) or a region of interest are identified by reacting the section with one or more molecular probes to identify those cell(s) or regions which express or do not express markers of interest. Identifying coordinates on the section can be facilitated by the use of gridded slides. Methods of identifying appropriate targets in a donor block are described further in U.S. Patent Application Ser. No. 60/234,493, filed Sep. 22, 2000, the entirety of which is incorporated by reference herein. Identical coordinates on the donor block are subsequently targeted for generating microarray blocks as described further below.

Donor blocks also can be generated which comprise cells rather than tissues. For example, the donor blocks can comprise embedded cells obtained from cell suspensions. Cells used to form the donor blocks can be obtained from cell culture (e.g., from primary cell lines or continuous cell lines), from dissections, from surgical procedures, biopsies, pathology waste samples (e.g., by mincing or otherwise disassociating tissues from these samples), as well as from bodily fluids (e.g., such as blood, plasma, sera, leukapheresis samples, and the like). Cells also can be obtained after one or more purification steps to isolate cells of a particular type (e.g., by dissection, flow sorting, magnetic sorting (i.e., antibody-based sorting), density gradient centrifugation, panning, and the like).

Cells are preferably washed one or more times in a suitable buffer which does not lyse the cells and are collected by centrifugation. After removing substantially all of the buffer, cells are resuspended gently in a volume of embedding material and transferred in the embedding material to a mold, such as a support web or plastic block, for hardening or freezing in the case of a cryogenic matrix. After the mold is removed, at least one section from the block should be evaluated to verify sample integrity (e.g., to validate the presence of suitable numbers of cells with acceptable morphology and/or to determine that cells express or fail to express one or more biomolecules). Cell donor blocks should comprise at least about one cell and preferably comprise at least about 50, at least about 10², at least about 10³, at least about 10⁴, at least about 10⁵, at least about 10⁶, at least about 10⁷, and at least about 10⁸ cells.

### Forming the Recipient Block

In one aspect, cell or tissue microarrays are constructed by coring holes in a recipient block comprising an embedding substance (e.g., paraffin, plastic, or a cryogenic media) and placing a cell or tissue sample from a donor block in a selected hole. Holes can be of any shape and size, but are preferably made in a regular pattern. In one aspect of the invention, the hole for receiving the tissue sample is elongated in shape. In another aspect, the hole is cylindrical in shape.

While the order of the donor cells or tissues in the recipient block is not critical, in some aspects, donor samples are spatially organized. For example, in one aspect, donor cells/tissues represent different stages of disease, such as cancer, and are ordered from least progressive to most progressive (e.g., associated with the lowest survival rates). In another aspect, cell and/or tissue samples within a microarray will be ordered into groups which represent the patients from which the cells/tissues are derived. For example, in one aspect, the groupings are based on multiple patient parameters that can be reproducibly defined from the development of molecular disease profiles. In another aspect, cells/tissues are coded by genotype and/or phenotype.

For example, samples may be arrayed in order of their progression through the cell cycle by obtaining a sample of a donor core and determining what stage of the cell cycle it is in by virtue of the expression of particular biomolecules and/or cytological criteria. The core is then placed in a known location in a recipient block and additional cores are obtained which represent different stages of the cell cycle. Duplicate cores can also be provided. A section of the recipient block is obtained to verify that donor cores within the block are at the stage of the cell cycle identified, and the block is then used to generate a plurality of microarrays representing different stages of the cell cycle.

In some aspects, cell/tissue samples are obtained which fail to express or which express altered levels or forms of a pathway molecule. For example, recipient blocks can be generated by obtaining samples from cells/tissues which fail to express early, middle and late pathway genes. As used herein, “early pathway genes” are genes whose expression effects the expression of multiple downstream genes (at least about 5), such that perturbing the expression of these genes will affect multiple genes in the pathway. “Middle pathway genes” are genes whose expression is required for the expression of at least about 2 but less than five downstream genes, while “late genes” are those which are downstream in the pathway and whose expression effects only one or a few (e.g., less than about 2 pathway molecules). Recipient blocks comprising cells/tissues having defects in the expression of early, middle and late pathway genes can be generated by obtaining tissue sections of an embedded tissue sample (e.g., a donor block), and subsequently coring the tissue sample if it produces the desired pattern of expression. Recipient blocks are validated by obtaining representative section(s) of the block and reacting the sections with a plurality of molecular probes which can react with early, mid, and late pathway genes and their products (which may include the expression products of other genes or various metabolites or cellular constituents. In one aspect, the pathway represented in the recipient block is a GPCR pathway and the recipient block is used to generate GPCR pathway microarrays.

Cell/tissue samples in the recipient block (and thus in the microarray) can be arranged according to expression of biomolecules, if this is known, or characteristics of the cell/tissue source, including exposure of the cell/tissue source to particular treatment approaches, treatment outcome, or prognosis, or according to any other scheme that facilitates the subsequent analysis of the samples and the data associated with them.

The recipient block can be prepared while samples are being obtained from the donor block. However, in one aspect, the recipient block is prepared prior to obtaining samples from the donor block, for example, by placing a fast-freezing, cryo-embedding matrix in a container and freezing the matrix so as to create a solid, frozen block. The embedding matrix can be frozen using a tissue freezing aerosol such as tetrafluorethane 2.2 or by any other methods known in the art. The holes for holding samples can be produced by punching holes of substantially the same dimensions into the recipient block as those of the donor samples and discarding the extra embedding matrix.

As used herein, a “microarray block” refers to a recipient block which comprises a desired number of donor samples. Information regarding the coordinates of the holes into which samples are placed and the identity of the sample at each hole is recorded, effectively addressing each location in the microarray block so that when the block is sectioned, each portion of sample in the section will have a known location on a substrate onto which the section is placed.

In one aspect of the invention, data relating to any, or all of, tissue type, stage of development or disease, individual of origin, patient history, family history, diagnosis, prognosis, medication, morphology, concurrent illnesses, expression of molecular characteristics (e.g., markers), and the like, is recorded and stored in a database, indexed according to the location of the tissue on the microarray. Data can be recorded at the same time that the microarray is formed, or prior to, or after, formation of the microarray.

The coring process can be automated using core needles coupled to a motor or some other source of electrical or mechanical power. Methods for automating tissue arraying are described in U.S. Pat. No. 6,103,518, in International Applications WO 99/44062 and WO 99/44062, in U.S. patent application Ser. No. 09/779,753 entitled “Frozen Tissue Microarrayer,” filed Feb. 8, 2001, (Attorney Docket No. 5568/1170), and in U.S. patent application Ser. No. 09/779,187 entitled “Stylet For Use With Tissue Microarrayer and Molds,” filed Feb. 8, 2001 (Attorney Docket No. 5568/1070), the entireties of which are incorporated by reference herein.

The size of the cores placed in the recipient block can vary. In one aspect of the invention, large format microarrays are generated from blocks which comprise at least one donor core whose diameter is greater than about 0.6 mm, about 1.2 mm and/or about 3.0 mm. In other aspects, microarrays are generated from microarray blocks which comprise at least one donor core of about 0.3 mm in diameter or less. 0.6 mm sample sizes can also be used.

In one aspect, donor samples which are placed in the recipient block are from samples embedded in different types of embedding medium. For example, at least two of a paraffin embedded sample, a frozen embedded sample, or a plastic embedded sample are placed in the same donor block. In one aspect, substantially identical portions of a sample are embedded in different types of embedding media to form donor cores for the array.

Once a microarray block is formed, the block can be sectioned to obtain a plurality of substantially identical microarrays. Methods of sectioning microarray blocks are described in U.S. patent application Ser. No. 09/888,362, filed Jun. 22, 2001, the entirety of which is incorporated by reference herein.

### Generating Hybrid Microarrays

In one aspect of the invention, microarrays comprising molecular probes and microarrays comprising target samples are generated on the same substrate. In a preferred embodiment, a microarray comprising a plurality of molecular probes is printed on a substrate at a first position and a microarray comprising a plurality of target samples (e.g., such as a section from a microarray block) is placed at a second position. In one aspect, a portion of the substrate is masked while a microarray is placed at a first or second position. For example, a cell or tissue microarray can be placed at a second position and masked with a coverslip or other barrier layer, while molecular probes are synthesized or spotted at known locations at the first position. Similarly, the molecular probe microarray can be masked (e.g., with a cover slip or a chemical barrier layer) while the cell or tissue microarray is placed at the second position.

### Use of Mixed Format Microarrays

As used herein, “mixed format microarrays” are sets of microarrays of different type, i.e., two or more of nucleic acid microarrays, peptide, polypeptide, and/or protein microarrays, oligosaccharide microarrays, lipoproteins microarrays, other small molecule arrays, cell microarrays, and tissue microarrays (among the latter including frozen, paraffin-embedded and/or plastic-embedded tissues). The use of sets of mixed format microarrays enables one to combine genomic and proteomic analysis with information obtainable from cell and tissue microarrays. Where molecular probes are identified as representing potentially useful markers of particular physiological responses on microarrays comprising probes, these can be validated by examining the reactivity of identified molecular probes with particular tissue and cell samples on a target sample microarray. In a particularly preferred embodiment, target samples reacted with molecular probes in a first assay and target samples stably associated with substrates in the second assay are from the same patient.

### Methods of Identifying Molecular Probes of Interest in Microarrays Comprising Molecule Probes

In one aspect, a microarray which comprises molecular probes stably associated with distinct known locations on a substrate is reacted with one or more target samples. In a preferred aspect, target samples are labeled (e.g., such as by nick translation, or by amplification of target biomolecules using labeled primers where the target biomolecules include nucleic acids, or by any other method which can incorporate a label into a polymer). Labels include, but are not limited to, any composition detectable by spectroscopic, photochemical, biochemical, immunochemical, or chemical means and include, but are not limited to, radioactive labels (e.g. ³²P, ¹²⁵I, ¹⁴C, ³H, and ³⁵S), fluorescent dyes (e.g. fluorescein, rhodamine, Texas Red, etc.), BODIPY dyes, electron-dense reagents (e.g. gold), enzymes (as commonly used in an ELISA), colorimetric labels (e.g. colloidal gold), magnetic labels (e.g. Dynabeads™), chemiluminescent labels, and the like. Examples of labels which are not directly detected but are detected through the use of directly detectable label include biotin and dioxigenin as well as haptens and proteins for which labeled antisera or monoclonal antibodies are available. Preferably, labels which can be spectrally distinguished from other labels are used so that multiple target samples, each labeled with different labels can be reacted with a single microarray at a time.

In a preferred embodiment, the target will include one or more control molecules which hybridize to control probes on the microarray to normalize signals generated by reacting the labeled target sample to the microarray. Preferably, labeled control targets are sequences that have a high affinity to control probes on the microarray (i.e., will substantially exclusively or exclusively bind to the control probes and not to non-control sequences). For example, in the case of a nucleic acid microarray, a control target is a nucleic acid molecule in the target sample perfectly complementary to the control probe on the microarray. Control targets may be naturally found in a target sample or can be spiked into the sample.

The signals obtained from the controls after hybridization provide a control for variations in hybridization conditions, label intensity, “reading” efficiency and other factors that may cause the signal of a perfect hybridization event to vary between arrays. In a preferred embodiment, signals (e.g., fluorescence intensity) read from all other probes in the array are divided by the signal (e.g., fluorescence intensity) from the control probes, thereby normalizing the measurements.

The reactivity of the microarray is monitored using standard optical systems. Preferably, data acquisition and at least some aspects of data analysis is automated. In one aspect, an optical system is provided which comprises a light source, a light directing elements (e.g., such as focusing elements or lens) for directing light from the light source to the substrate, and a detector for detecting emissions from the array (e.g., such as fluorescence). In another aspect, light is directed to a particular position, or positions, on the substrate through the use of a x-y-z translation table which can be controlled by a processor which also communicates with the detector.

The optical system can also comprise an auto-focusing mechanisms and temperature controllers. In a further embodiment of the invention, the optical system comprises a confocal microscope which can perform multiple scanning operations within a single plane (see, e.g., U.S. Pat. No. 5,874,219, the entirety of which is incorporated by reference herein).

In other aspects, an optical system is equipped with a phototransducer (e.g., a photomultiplier, a solid state array, charge-coupled devices (CCD) or charge-injection devices (CID), image-intensifier tubes, image orthicon tube, vidicon camera type, image dissector tube, or other imaging devices) attached to an automated data acquisition system to automatically record any signal produced. These types of automated systems are known in the art (see, e.g., U.S. Pat. No. 5,143,854, U.S. Pat. No. 4,605,485, U.S. Pat. No. 5,692,507, and U.S. Pat. No. 3,743,768, the entireties are incorporated herein by reference).

Still more preferably, data obtained from the microarray also is stored in a specimen-linked database, e.g., such as the one described in U.S. patent application Ser. No. 09/781,016, filed Feb. 9, 2001, the entirety of which is incorporated herein by reference, and discussed further below.

### Identifying Molecular Probes in Nucleic Acid Microarrays

When the molecular probes on the substrate are nucleic acids or modified forms thereof, reactivity of target sample biomolecules is detected by detecting the formation of hybridization complexes between target molecules and probe molecules at particular distinct locations on the substrate. Nucleic acids that do not form hybrid duplexes are then washed away leaving the hybridized target/probe complexes to be detected, typically through detection of an attached detectable label. Under low stringency conditions (e.g., low temperature and/or high salt) hybrid duplexes (e.g., DNA:DNA, RNA:RNA, or RNA:DNA) will form even where the annealed sequences are not perfectly complementary. Thus, specificity of hybridization is reduced at lower stringency. Conversely, at higher stringency (e.g., higher temperature or lower salt) successful hybridization requires fewer mismatches.

Methods of optimizing hybridization conditions are well known to those of skill in the art (see, e.g., Maniatis et al., supra, and WO 95/21944). In one aspect, low stringency conditions are at about 50° C. and 6×SSC (0.9 M sodium chloride/0.09 M sodium citrate) while hybridization under high stringency is at about 50° C. or higher and 0.1×SSC (15 mM sodium chloride/0.15 M sodium citrate). The stringency of hybridization conditions can be optimized by determining the kinetics of hybridization, i.e., by measuring the amount of binding at each of a number of different time points. This allows the user to determine the dependency of the hybridization rate for different cDNAs on temperature, sample agitation, washing conditions (e.g. pH, solvent characteristics, temperature), and the like. The speed with which CCD imaging systems operate makes these systems ideal for determining hybridization kinetics (see, e.g., as described in Fodor et al., U.S. Pat. No. 5,324,633, which is incorporated herein by reference in its entirety.).

Prior to detection, in order to reduce the potential for a mismatch hybridization event, the array of target/probe complexes can be treated with an endonuclease under conditions such that the endonuclease degrades single-stranded but not double-stranded DNA. Such nucleases include, but are not limited to (mung bean nuclease, S1 nuclease, and the like). In an assay using biotinylated target nucleic acids, the nuclease treatment will generally be performed prior to contact of the array with the appropriate detection label (e.g., such as a fluorescent-streptavidin conjugate). Endonuclease treatment ensures that only end-labeled target/probe complexes having substantially complete hybridization at the 3′ end of the probe are detected in the hybridization pattern.

Following hybridization, non-hybridized target is removed from the support surface, e.g., by washing, generating a pattern of labeled molecular probes which can be visualized in a manner suited to the type of the hybridized target polynucleotide on the substrate surface using methods routine in the art. The detection method used depends on the label used to label target biomolecules. Exemplary detection methods include, but are not limited to, scintillation counting, autoradiography, fluorescence measurement, calorimetric measurement, chemiluminescence detection, light emission measurement and the like.

Preferably, the detection method used provides a method of quantifying the amount of hybridization at a particular known location on the substrate. In one aspect, signal from a target/probe complex is measured and compared to a unit value corresponding to the signal emitted by a known number of labeled target nucleic acids to obtain a count or absolute value of the copy number of each labeled target that is hybridized to a particular location on the substrate.

Methods for analyzing the data collected from hybridization to arrays are well known in the art. For example, where detection of hybridization involves a fluorescent label, data analysis can include the steps of determining fluorescent intensity as a function of substrate position from the data collected, removing outliers, i.e., data deviating from a predetermined statistical distribution, and calculating the relative binding affinity of the test polynucleotides from the remaining data.

In a preferred embodiment a confocal microscope equipped with laser excitation sources and interference filters appropriate for the different labels labeling the target is used. Separate scans can be taken appropriate for each label and image segmentation performed to identify areas of hybridization, normalization of the intensities between the different images (each detecting the different labels), and calculation of the normalized mean label values (e.g., such as fluorescent values) at each known location are as described (Khan, et al., 1998, Cancer Res. 58: 5009-5013. Chen, et al., 1997, Biomed. Optics 2: 364-374). Normalization between images can be used to adjust for the different efficiencies in labeling and detection between two different types of labels. This can be achieved by equilibrating to a value of one the signal intensity ratio of a set of internal control nucleic acids associated with known locations on the substrate.

Following detection or visualization, the hybridization pattern is used to determine quantitative information about the molecular profile of the labeled target sample that was contacted with the array to generate the hybridization pattern, as well as the physiological source from which the labeled target polynucleotide sample was derived (see, e.g., as described in U.S. Pat. No. 6,004,755). Preferably, this data is stored in the specimen-linked database described above.

Hybridization can also be detected without the use of labels, for example by placing capacitors contiguous to molecular probes at the distinct known locations or by forming a transmission line between two electrodes at each location, to measure changes in conductance, upon hybridization of a target molecule to a probe molecule at that position (see, e.g., U.S. Pat. No. 5,843,767 and WO 93/22678, the entireties of which are incorporated by reference herein).

By determining whether any expressed target nucleic acid sequence (e.g., mRNA) within the sample hybridizes to the array, data relating to the expression of the target nucleic acid sequence is obtained. In one embodiment of the invention, the data comprises the amount of target nucleic acid sequence expressed in a sample.

### Methods of Identifying Molecular Probes in Peptides/Polypeptides/Proteins Microarrays

When the molecular probes on the substrate are one or more of peptides, polypeptides, proteins, or modified forms thereof, reactivity of target sample biomolecules is detected by detecting the formation of complexes between target molecules and probe molecules at particular distinct locations on the substrate. Preferably, target molecules are labeled using means known in the art. For example, in one aspect, target samples of cells and/or tissues are incubated with labeled methionine which is incorporated into peptides, polypeptides, and proteins being translated in the cells of the target sample. The labels used can be fluorescent or radioactive or generally any of the labels described above for nucleic acid target biomolecules. Where interactions between nucleic acids in the target sample and probes on the substrates are being evaluated, the target nucleic acids can be labeled using any of the methods described above.

However, target peptides/polypeptides/proteins do not necessarily have to be labeled. In one aspect of the invention, target samples are contacted with a peptide, polypeptide and/or protein array under binding conditions in which binding partners (e.g., receptors, ligands, antibodies, antigens) will specifically bind to each other and not to other molecules. After performing one or more washes to remove unbound proteins and interfering substances, the substrate comprising target biomolecules bound to peptides/polypeptides/proteins can be inserted into a ProteinChip Reader (SELDI-TOF-MS) (Cyphergen) allowing the molecular weights of the biomolecules which remain bound to the substrate surface to be determined, thereby providing a means to distinguish molecular probes which are bound to target from molecular probes which are not bound to target. See, e.g., as described in Anderson and Seilhamer, Electrophoresis 18: 533-537, 1997; Paweletz et al., March 1999, Proc. Amer. Assoc. Cancer Res. 40; Austen et al. Neuroreport 10 (8) 1699-1705, 1999.

### Using Molecular Probes to Identify Target Biomolecules in Target Samples

In a preferred aspect of the invention, molecular probes identified by binding target samples to any of the microarrays described above are reacted with target samples immobilized at distinct known locations on substrates to confirm the expression of target molecules identified by the molecular probes in the target samples.

In one aspect, a microarray is contacted with a molecular probe (e.g., an antibody, nucleic acid, and/or aptamer probe) reactive with a biomolecule and the reactivity of the molecular probe is measured to provide an indication of the presence, absence, or form of the biomolecule. Reactivity can be any of: binding, cleavage, processing, and/or labeling, and the like. Preferably, reactivity of the molecular probe with test samples in the microarray is compared with reactivity of the molecular probe with one or more control samples on the same or a different microarray comprising a known amount and/or form of the biomolecule. Molecular profiling can be performed using a variety of techniques, such as immunohistochemistry, in situ hybridization, and the like, in parallel or simultaneously.

### Immunohistochemistry (IHC)

In one aspect, the biomolecule of interest being profiled is an antigen. In situ detection of an antigen can be accomplished by contacting a microarray with a labeled antibody that specifically binds the antigen. For example, antibodies can be detectably labeled by linkage to an enzyme for use in an enzyme immunoassay (EIA) (Voller, 1978, Diagnostic Horizons 2:1-7, Microbiological Associates Quarterly Publication, Walkersville, Md.); Voller et al., 1978, J. Clin. Pathol. 31:507-520; Butler, 1981, Meth. Enzymol. 73: 482-523). The enzyme which is linked to the antibody will react with an appropriate substrate, preferably a chromogenic substrate, in such a manner as to produce a chemical moiety which is detectable, for example, by spectrophotometric, fluorimetric or visual means. Examples of enzymes useful in the methods of the invention include, but are not limited to peroxidase, alkaline phosphatase, and RTU AEC.

Detection of bound antibodies can alternatively be performed by radiolabeling antibodies and detecting the radiolabel. Following binding of the antibodies and washing, the samples can be processed for autoradiography to permit the detection of label on particular cells in the samples.

In one aspect, antibodies are labeled with a fluorescent compound. When the fluorescently labeled antibody is exposed to light of the proper wavelength, its presence can be detected due to fluorescence. Many fluorescent labels are known in the art and can be used in the methods of the invention. Preferred fluorescent labels include fluorescein, amino coumarin acetic acid, tetramethylrhodamine isothiocyanate (TRITC), Texas Red, Cy3.0 and Cy5.0. Green fluorescent protein (GFP) is also useful for fluorescent labeling, and can be used to label non-antibody protein probes as well as antibodies or antigen binding fragments thereof by expression as fusion proteins. GFP-encoding vectors designed for the creation of fusion proteins are commercially available.

The primary antibody (the one specific for the antigen of interest) can alternatively be unlabeled, with detection based upon subsequent reaction of bound primary antibody with a detectably labeled secondary antibody specific for the primary antibody. Another alternative to labeling of the primary or secondary antibody is to label the antibody with one member of a specific binding pair. Following binding of the antibody-binding pair member complex to the sample, the other member of the specific binding pair, having a fluorescent or other label, is added. The interaction of the two partners of the specific binding pair results in binding the detectable label to the site of primary antibody binding, thereby allowing detection. Specific binding pairs useful in the methods of the invention include, for example, biotin:avidin. A related labeling and detection scheme is to label the primary antibody with another antigen, such as digoxigenin. Following binding of the antigen-labeled antibody to the sample, detectably labeled secondary antibody specific for the labeling antigen, for example, anti-digoxigenin antibody, is added which binds to the antigen-labeled antibody, permitting detection.

The staining of tissues/cells for detection of antibody binding is well known in the art, and can be performed with molecular probes including, but not limited to, AP-Labeled Affinity Purified Antibodies, FITC-Labeled Secondary Antibodies, Biotin-HRP Conjugate, Avidin-HRP Conjugate, Avidin-Colloidal Gold, Super-Low-Noise Avidin, Colloidal Gold, ABC Immu Detect, Lab Immunodetect, DAB Stain, ACE Stain, NI-DAB Stain, polyclonal secondary antibodies, biotinylated purified antibodies, HRP-labeled affinity purified antibodies, and/or conjugated antibodies (e.g., enzyme-conjugated antibodies).

In one aspect, immunohistochemistry is performed using an automated system such as the Ventana ES System and Ventana Gen^{II}™ System (Ventana Medical Systems, Inc., Tucson, Ariz.). Methods of using this system are described in U.S. Pat. No. 5,225,325, U.S. Pat. No. 5,232,664, U.S. Pat. No. 5,322,771, U.S. Pat. No. 5,418,138, and U.S. Pat. No. 5,432,056, the entireties of which are incorporated by reference herein.

In some aspects, an immunohistochemical assay is combined with an evaluation of nucleic acids of samples on a microarray. For example, after immunohistochemistry, tissue cores corresponding to samples on the array can be obtained (e.g., from donor blocks) to provide nucleic acid samples for analysis. In one aspect, a sample of a tissue core is deposited in a plastic tube, and DNA and/or RNA extracted using means known in the art. For example, the amount of DNA from a single 0.6 mm diameter tissue core is usually enough for at least 50 PCR reactions. If more DNA is required, for example, for comparative genomic hybridization methods, additional samples can be collected and stored in the same tube. Thus, it can be useful to collect one sample for nucleic acid extraction, and place an adjacent sample into an array block. This sample can then be used for histology verification, ISH or FISH (described further below), additional immunohistochemistry, or it can be stored in an array block for future use. In some aspects, immunohistochemistry techniques are complemented by the use of histological stains and/or DNA ploidy stains (e.g., as described in U.S. Pat. No. 6,165,734, the entirety of which is incorporated by reference herein. RNA samples can also be obtained (e.g., for RT-PCR assays). See, as described in Taylor et al., 1998, J. Pathol. 184(3): 332-335.

Preferably, immunohistochemical analysis of cell and/or tissue microarrays is combined with analysis of one or more of a nucleic acid microarray, peptide, polypeptide, protein, and other small molecule microarray. In one aspect, an array of antibodies are used in the first assay and antibodies identified as binding to target biomolecules in a target sample are used in a second assay to probe cell or tissue microarrays by IHC. Preferably, the target sample in the first assay is from the same patient as at least one target sample on the microarray in the second assay. Preferably, the target samples are from the same tissue from the same patient.

### In Situ Hybridization (ISH) and Fluorescent In Situ Hybridization (FISH)

In another aspect, the biomolecule of interest being profiled is a nucleic acid and is detected using an in situ hybridization technique such as ISH or FISH. In these techniques, generally labels are attached to nucleic acid probes that allow hybridization of the probes to their complementary sequences in a tissue/cell to be visualized under a microscope. ISH probes have chromogenic markers and their binding can be observed by traditional light microscopy. FISH probes have a fluorescent markers bonded thereto (directly or indirectly) and their binding must be visualized through the use of a fluorescent microscope. Cell and/or tissue microarrays can be hybridized with nucleic acid probes using methods routine in the art, described in, for example, Ausubel et al., 1992, Short Protocols in Molecular Biology, (John Wiley and Sons, Inc.), pp. 14-15 to 14-16, the entirety of which is incorporated by reference herein. ISH or FISH can be performed with one or more amplification steps, i.e., such as by performing in situ PCR or in situ RT-PCR. A detailed description of these techniques is presented in Ausubel, et al., 1992, supra, pp. 14-37 to 14-49 and in Nuovo, 1996, Scanning Microsc. Suppl. 10: 49-55.

In addition to detecting specific nucleic acids (e.g., genes or transcripts), ISH or FISH probes or other nucleic acid molecular probes (e.g., DAPI, acridine orange, and the like) can also be used to evaluate the absolute amounts of nucleic acids in cells within a tissue/cell sample (e.g., to determine the copy number of nucleic acids on the tissue) since changes in copy number of nucleic acids are often associated with the development of pathology. In this aspect, preferably both control and test tissue samples are provided on a single substrate (e.g., as part of a single microarray or by using a profile array substrate) in order to enable a user to perform a side-by-side comparison of signal obtained under substantially identical conditions. Preferably, an optical system in communication with the microarray is used to quantitate and compare the amount of signal obtained (e.g., determining a ratio of signal of from a test sample and control sample). In one aspect, the optical system comprises a light source in communication with the microarray for transmitting light to one or more samples on the array (e.g., such as in a CCD device), and a light receiving element for receiving light transmitted by one or more samples on the array. Preferably, the light receiving element transmits this light to a detector which converts light into an electrical signal which is proportional to the amount of light received. The detector, in turn, is in communication with a processor for storing and or displaying the electrical signal. In one aspect, an image is displayed of one or more samples on the array.

Molecular profiling can be complemented by techniques which evaluate the characteristics of nucleic acids in tissue/cell samples on the microarray. For example, microarrays can be assayed for the presence of cell death in one or more sample in the microarrays by detecting the presence of DNA fragmentation (e.g., such as generated by apoptosis) in samples on the microarrays, such as by performing TUNEL assays (see, e.g., as described in U.S. Pat. No. 6,160,106 and U.S. Pat. No. 6,140,484, the entireties of which are incorporated by reference herein). In TUNEL, the free 3′-OH termini generated by DNA fragmentation can be labeled using modified nucleotides (e.g., biotin-dUTP, DIG-dUTP, fluorescein-dUTP and the like) in the presence of terminal deoxynucleotidyl transferase (TdT). The incorporation of modified nucleotides can be detected using an antibody which specifically recognizes the modification and which itself is coupled to a detectable molecule such as a reporter enzyme (e.g., alkaline phosphatase).

Microarrays can also be evaluated to detect the presence or absence of methylation in one or more cells in samples on the array. In situ methods of identifying methylated sequences are described in U.S. Pat. No. 6,017,704, for example, the entirety of which is incorporated by reference herein. The method comprises contacting a nucleic acid-containing specimen with an agent that modifies unmethylated cytosine, amplifying the CpG-containing nucleic acid in the specimen by means of CpG-specific oligonucleotide primers which distinguish the distinguish between modified methylated and non-methylated nucleic acids, and detecting the methylated nucleic acids by detecting amplification products. The method relies on using the PCR reaction itself to distinguish between modified (e.g., chemically modified) methylated and unmethylated DNA.

In a preferred aspect of the invention, data relating to the reactivity of different locations in the microarray with one or more molecular probes are entered into a database, and information relating to biomolecule(s) being evaluated by the probe(s) is made accessible, along with other data relating to the samples at each location on the array, to the user. Molecular profiling data can be used to further characterize a biomolecule whose function is at least partly known; however, molecular profiling data can also be used to identify the biological role of an uncharacterized gene, e.g., by identifying aberrant physiological processes in which the expression of the gene is altered (i.e., overexpressed or underexpressed or expressed in a different form or eliminated).

In one aspect of the invention, information relating to the individual from whom the test tissue was obtained is entered into the database. Such information can include, age, sex, weight, race, patient medical history (e.g., drug treatment history and outcomes, concurrent and underlying illnesses), family medical history, and the like. Preferably, the database comprises information relating to a population of individuals for whom like information also has been obtained. Still more preferably, the specimen-linked database is part of a information system which further comprises an information management system. The information management system comprises search functions and relationship determining functions for organizing and retrieving information in the database in response to user queries. Such systems are described and discussed further below.

In one aspect, the tissue information system is used to identify a relationship between the expression of a biological characteristic (e.g., the expression of an antigen, transcript, or genotype, gene expression profile or protein expression profile) and the occurrence, progression, aggressiveness or likelihood of recurrence of a disease. In another aspect, the tissue information system identifies treatment options suited to a pattern of expression of biomolecules associated with a disease (for example, the detection of expression of estrogen receptors on samples of cancerous breast tissue would trigger the tissue information system to indicate that hormone treatment would be a suitable treatment option). In another aspect, the information system provides a prediction of the outcome of a drug treatment (for example, the prediction of the outcome of irinotecan treatment for colorectal cancer).

### Simultaneous Assays

Microarrays comprising frozen samples are preferred over microarrays comprising paraffin-embedded samples for simultaneously evaluating proteins and nucleic acids. Thus, in one aspect, in situ hybridization and immunohistochemical evaluation are performed at the same time preferably using frozen microarrays. Such multi-labeling techniques are described in, for example, Zaidi et al., 2000, J. Histochem. Cytochem. 48(10): 1369-1375, and Kingsbury et al., 1996, J. Neurosci. Methods 69(2): 213-27, the entireties of which are incorporated by reference herein. In another aspect, evaluation of proteins and nucleic acids is performed sequentially on a single microarray. For example, cell samples can be obtained from the microarray itself after performing histological evaluations and used for PCR and/or RT-PCR assays (see, e.g., as described in Fernandez et al., 1997, Mol. Carcinog. 20(3): 317-326.

### Cancer Diagnosis and Prognosis

In one aspect, microarrays according to the invention are used to assay the expression and/or form of a cancer-specific marker or tumor-specific antigen. As used herein, a “cancer-specific marker” or a “tumor-specific antigen” is a biomolecule which is expressed preferentially on cancer cells and tumor cells, respectively, and is not expressed or is expressed to small degree in non-cancer/tumor cells of an adult individual. A cancer-specific marker is any biomolecule that is involved in or correlates with the pathogenesis of a cancer, and can act in a positive or negative manner, as long some aspect of its expression or form influences or correlates with the presence or progression of cancer. While in one aspect, expressed levels of a biomolecule provide an indication of cancer progression or recurrence, in another aspect of the invention, the expressed form of a biomolecule provides the indication (e.g., a cleaved or uncleaved state, a phosphorylated or unphosphorylated state).

In one aspect, the expression characteristics of cancer-specific markers are determined in test tissue samples and compared to the expression characteristics of the marker in cell/tissue microarrays comprising both cancerous and normal tissues (either on the same or different substrates. Test tissue samples can be provided on different substrates or on the same substrate as the microarray (e.g., using a profile array substrate). The cancer-specific marker can be the product of a characterized gene, e.g., such as a cell growth-related polypeptide which promotes cell proliferation, or can be uncharacterized or only partially characterized (e.g., identified through the use of molecular profiling methods described above).

Non-limiting examples of cancer-specific markers include growth factors, growth factor receptors, signal transduction pathway participants, and transcription factors involved in activating genes necessary for cell proliferation. Alternatively, or in addition, cell proliferative genes can function to suppress cell proliferation. Non-limiting examples include tumor suppressor genes (e.g., p57kip2, p53, Rb) and growth factors that act in a negative manner (e.g., TGF-). A loss or alteration in the function of a negatively acting growth regulator often has a positive effect on cell proliferation.

The so-called tumor antigens are also included among the growth-related polypeptides. Tumor antigens are a class of protein markers that tend to be expressed to a greater extent by transformed tumor cells than by non-transformed cells. As such, tumor antigens can be expressed by non-tumor cells, although usually at lower concentrations or during an earlier developmental stage of a tissue or organism. Tumor antigens include, but are not limited to, prostate specific antigen (PSA; Osterling, 1991, J. Urol. 145: 907-923), epithelial membrane antigen (multiple epithelial carcinomas; Pinkus et al., 1986, Am. J. Clin. Pathol. 85: 269-277), CYFRA 21-1 (lung cancer; Lai et al., 1999, Jpn. J. Clin. Oncol. 29: 421-421) and Ep-CAM (pan-carcinoma; Chaubal et al., 1999, Anticancer Res. 19: 2237-2242). Additional examples of tumor antigens include CA125 (ovarian cancer), intact monoclonal immunoglobulin or light chain fragments (myeloma), and the beta subunit of human chorionic gonadotropin (HCG, germ cell tumors).

A sub-category of tumor antigens includes the oncofetal tumor antigens. The oncofetal tumor antigens alphafetoprotein and carcinoembryonic antigen (CEA) are usually only highly expressed in developing embryos, but are frequently highly expressed by tumors of the liver and colon, respectively, in adults. Other oncofetal tumor antigens include, but are not limited to, placental alkaline phosphatase (Deonarain et al., 1997, Protein Eng. 10: 89-98; Travers & Bodmer, 1984, Int. J. Cancer 33: 633-641), sialyl-Lewis X (adenocarcinoma, Wittig et al., 1996, Int. J. Cancer 67: 80-85), CA-125 and CA-19 (gastrointestinal, hepatic, and gynecological tumors; Pitkanen et al., 1994, Pediatr. Res. 35: 205-208), TAG-72 (colorectal tumors; Gaudagni et al., 1996, Anticancer Res. 16: 2141-2148), epithelial glycoprotein 2 (pan-carcinoma expression; Roovers et al., 1998, Br. J. Cancer. 78: 1407-1416), pancreatic oncofetal antigen (Kithier et al., 1992, Tumor Biol. 13: 343-351), 5T4 (gastric carcinoma; Starzynska et al., 1998, Eur. J. Gastroenterol. Hepatol. 10: 479-484; alphafetoprotein receptor (multiple tumor types, particularly mammary tumors; Moro et al., 1993, Tumour Biol. 14: 11-130), and M2A (germ cell neoplasia; Marks et al., 1999, Brit. J. Cancer 80: 569-578).

The expression characteristics of cell growth-related polypeptides are critical not only to their function, but also to their usefulness as prognostic or diagnostic indicators of disease. For example, when a given polypeptide (e.g., a tumor-suppressor gene product) or the RNA encoding it is used as a diagnostic or prognostic indicator, there are several characteristics of its expression that can be relevant. First, the total level of expression in the tumor, relative to the expression in normal cells of the corresponding cell type is important. In one aspect of the invention, the total level of expression is determined by quantitating relative signals observable using molecular probes reacted with test and control samples on a microarray. For a tumor suppressor gene, for example, a lower level of the tumor suppressor gene product in tumor samples would suggest that the lack of the tumor suppressor protein can be involved in the progression of the tumor. Such correlations can be verified because the microarrays according to the invention provide the opportunity to evaluate hundreds and even thousands of samples.

Even when no definitive mechanism of action in tumor etiology is known, the correlation of any expression characteristic (e.g., higher or lower expression) of a given polypeptide or RNA encoding the polypeptide with a particular clinical diagnosis or outcome in other patients makes the expression characteristics of that polypeptide or its RNA useful in the diagnosis or prognosis of disease. The level of expression of the given polypeptide or its RNA in a particular patient is used, along with the known correlation with its expression in that disease, to diagnose or predict a clinical outcome for that patient.

Other diagnostic/prognostic indications which can be identified and validated using microarrays according to the invention include the percentage of cells expressing a biomolecule in a given tissue sample, or the localization of the biomolecule within cells in a sample. For example, if a polypeptide that is normally predominantly cytoplasmic becomes predominantly nuclear in a disease, that change can be useful as a diagnostic or prognostic indicator. Still another expression characteristic that can be evaluated is a change in the conformation of a polypeptide. Conformational changes generally result from mutations to the gene encoding the polypeptide, but can also occur due to changes in the expression of a co-factor that influences the conformation of the polypeptide. Additionally, changes in post-translational modifications (e.g., phosphorylation, glycosylation, myristoylation, etc.) of a polypeptide can also be useful expression characteristics in diagnosis and/or prognosis of disease. Antibodies that distinguish between two conformations or between different modified forms of a polypeptide are known in the art (e.g., there are antibodies known in the art that distinguish the conformation of mutant from wild-type p53) and methods of making these are described further above.

In further aspects of the invention, cancer progression can be detected and/or monitored by examining the expression of the activity of a cancer-specific marker. For example, in one aspect, the activity of telomerase is monitored in situ in samples on a microarray. Methods of in situ detection of telomerase activity are known in the art and are described, for example, in U.S. Pat. No. 6,194,206, the entirety of which is incorporated by reference herein.

In some aspects, sets or panels of cancer-specific markers are used to determine the progression of cancer in a test sample. Perhaps one of the better examples of this application is the diagnosis of small round blue cell tumors in childhood. These tumors show no distinguishing morphological features but require positive identification because of their requirements for specific therapies and clinical outcomes. Immunohistochemistry (IHC) has proven to be one of the most powerful diagnostic tools to help categorize these tumors. In the majority of cases, a carefully selected panel of antibodies (e.g., directed against antigens such as neuron-specific enolase (NSE), Mic-2 gene product, leukocyte-common antigen (LCA), vimentin, chromogranin, cytokeratin (CK), epithelial membrane antigen (EMA)) can assist in identifying most of the small blue round tumors such as leukemia/lymphoma, Ewing's Sarcoma, rhabdomyosarcoma, and mesenchymal chrondrosarcoma (see, e.g., Brahmi et al., 2001, Diagn Cytopathol. 24(4): 233-239, the entirety of which is incorporated by reference herein).

Although no one specific antibody is diagnostic, each tumor will have a specific pattern of staining using such a panel of antibodies. Therefore, in one aspect of the invention, a plurality of substantially identical microarrays are evaluated, preferably in parallel, using panels of antibodies directed against, for example, NSE, Mic-2 gene product, LCA, vimentin, chromogranin, CK, EMA, and the like, to provide a diagnosis to a patient suspected of having such a tumor.

### Validating Diagnostic Biomolecules Identified in Other Arrays

In a preferred aspect of the invention, tissue or cell microarrays are used to validate results obtained through the analysis of other types of microarrays. For example, in one aspect, a nucleic acid array comprising expressed sequences is hybridized to a sample of labeled nucleic acids from a test tissue sample (e.g., a sample from a patient with an aberrant physiological process such as a disease) to identify one or more oligonucleotide probes on the array that hybridize to nucleic acids in the sample and/or to identify nucleic acids which fail to hybridize. Aberrantly expressed nucleic acids (e.g., nucleic acids expressed in the test sample but not in a control sample from a normal patient or from a non-diseased tissue or cell, or nucleic acids not expressed in the test sample which are expressed in the control sample) are identified and their sequence determined based on the address of the nucleic acid which hybridized or failed to hybridize in the array. Nucleic acids probes (“test diagnostic probes”) comprising the same or substantially the same sequence (e.g., having sufficient sequence identity to identify the same targets in a hybridization assay) are subsequently reacted with microarrays according to the invention to identify the expression pattern of the test diagnostic probes in one or more donor samples from demographically matched test patients sharing the same aberrant physiological process and in demographically matched control patients (the test and control patients sharing demographic characteristics with each other except for the presence of the aberrant physiological process in the test patients). Preferably, the expression of test diagnostic probes is evaluated in whole body arrays from a plurality of patients. Still more preferably, the microarray comprises cells from a bodily fluid to determine if the test diagnostic probe could be monitored in a readily obtainable sample. Similarly, peptide arrays or polypeptide arrays or protein arrays (e.g., comprising a plurality of different antibodies) can be used to identify aberrantly expressed peptides/polypeptides and this expression can be verified in tissue microarrays using suitable reactive antibodies specifically recognizing these peptides/polypeptides.

In one aspect, cell microarrays comprising a plurality of cancer cells (e.g., from different cancer cell lines) are used to identify target diagnostic probes diagnostic of cancer. Such probes can be validated using tissue microarrays according to the invention comprising samples obtained from a plurality of patients having different types of cancer. In one aspect, the microarrays are used to identify universal cancer markers expressed in substantially all (at least about 75%, and preferably, at least about 95%) of cancer cells. In other aspects, the microarrays are used to identify type specific cancer cell markers (e.g., expressed predominantly in specific types and/or grades of cancers and not in other types and/or grades of cancers).

### Selecting Promising Drug Targets

Microarrays according to the invention also can be used to identify drug targets whose interactions with one or a plurality of biomolecules is associated with disease. For example, drug targets can include binding pairs such as receptor:ligand pairs whose binding triggers an aberrant physiological response when either or both of the receptor or ligand is mutated or improperly modified. Alternatively, a drug target can be a molecule which is overexpressed or under-expressed during a pathological process. By identifying drug targets, drugs can be screened for which can restore a cell's/tissue's normal physiological functioning. For example, where a drug target is a receptor:ligand pair, a suitable drug might be an antagonist of ligand binding. Alternatively, where a drug target is a molecule which is overexpressed or under-expressed, a suitable drug could be a molecule (e.g., a therapeutic antibody, polypeptide, or nucleic acid) which restores substantially normal levels of the drug target.

Test probes are used to identify a biomolecule or set of biomolecules whose expression is diagnostic of a trait (e.g., such as by using the molecular profiling techniques described above). In one aspect, identifying diagnostic biomolecules is performed by determining which molecules on a microarray are substantially always present in a disease sample and substantially always absent in a healthy sample, or substantially always absent in a disease sample and substantially always present in a healthy sample, or substantially always present in a certain form or amount in a disease sample and substantially always present in a certain other form or amount in a healthy sample. By “substantially always” it is meant that there is a statistically significant correlation to within 95% confidence levels between the expression/form of the biomolecule or set of biomolecules and the presence of an aberrant physiological process, such as a disease.

Test probes identifying diagnostic biomolecules are then contacted with a microarray substrate to identify the presence, amount, and/or form of diagnostic biomolecules in a microarray comprising different types of healthy and/or diseased tissues. In this way, a correlation between the expression of the diagnostic biomolecule(s) and a disease state can be validated.

Preferably, expression of a diagnostic biomolecule or set of biomolecules is examined in a microarray comprising tissues/cells from a drug-treated patient and tissues from an untreated diseased patient and/or from a healthy patient. In this aspect, the efficacy of the drug is monitored by determining whether the expression profile of the diagnostic molecule(s) returns to a profile which is substantially similar (e.g., not significantly different as determined by routine statistical testing) to the expression profile of the same biomolecule(s) in a healthy patient or a patient who has achieved a desired therapeutic outcome. A drug is identified as useful for further testing when the expression pattern in the test tissue is substantially the same as the expression pattern within the healthy tissue (to within 95% confidence levels) or is within about 10% of the levels of the biomolecule observed in a normal patient or a patient who has achieved a desired therapeutic outcome.

### Information Management System for Evaluating Molecular Profiles to Physiological Responses

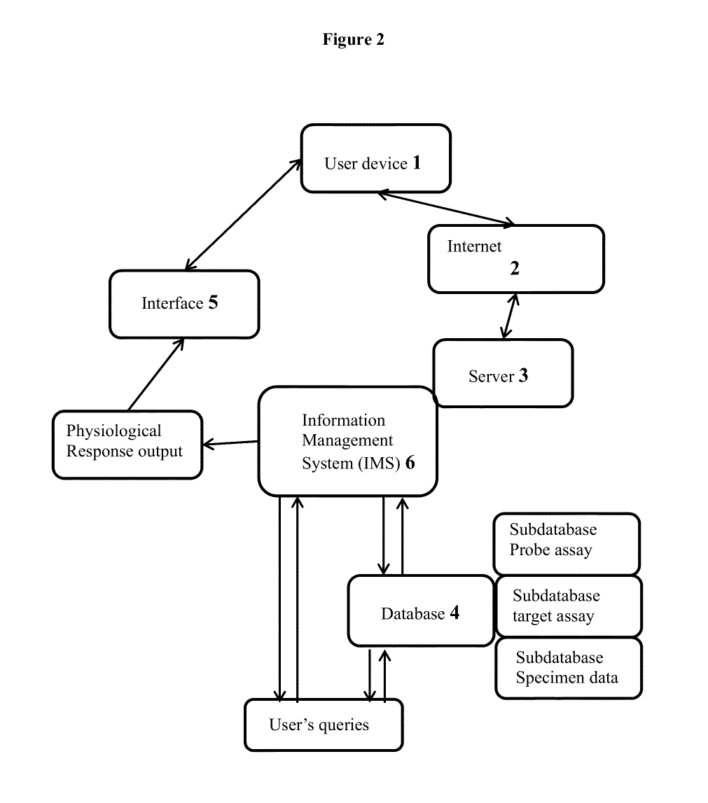

The invention provides an information management system (schematically shown in FIG. 2) for evaluating molecular profiles relating to physiological responses. The system enables a user to access, organize, display and analyze information relating to any of the microarrays described above. In particular, the system provides a specimen-linked database (4) enabling a user to evaluate the physiological responses of organisms whose tissues are included in the arrays. The information system comprises at least one user device 1 connected to a network 2. In one aspect, the network is wide area network (WAN) to which the at least one user device 1 is directly connected. However, in another aspect, user device 1 is connected to a WAN indirectly through a local area network (e.g., via a proxy server). In one aspect, one or more user device 1 at different physical locations can access, organize, analyze and display information relating physiological responses through the connection to the network 2. Thus, in one aspect of the invention, one or more microarrays as described herein are each screened at physically distant locations, for example, in different laboratories, hospitals, or companies, and the information obtained from the microarrays screened at each location is correlated with tissue information included within the specimen-linked database 4. Multiple users can both access and add to information within the database 4.

Accessing the information management system 6 through the user device 1 results in an interface 5 being displayed on a display of the user device 1. The interface 5 comprises at least one link to a specimen-linked database 4 which comprises microarray data and specimen information. In one aspect, the database 4 is also coupled to an information management system (IMS) 6 which comprises both information search functions and relationship determination functions for presenting information to the user in a useable form.

The device 1 comprises a processor and further includes processor readable storage media or electronic memory that can be accessed by the processor. Processor media includes volatile and nonvolatile media, such as RAM, ROM, EPROM, flash memory, CD-ROM, digital versatile disks (DVD), optical storage media, cassettes, tape, discs, and the like. The device 1 can further include multimedia rendering functions by including audio and video components (not shown). In one aspect, the device 1 also comprises an operating system (e.g., such as Microsoft Windows, UNIX X-Windows, or Apple MacIntosh System) and one or more application programs, including an Internet or Web browser, such as Microsoft's Internet Explorer™, Netscape®, Safari and FireFox (see, as described in Internet Starter Kit by Adam Engst, Corwin Low and Michael Simon, Second Edition, Hayden Books, 1995, the entirety of which is incorporated by reference herein).

Web browsers enable a user of the user device 1 to click on portions of an interface 5 displayed on the display of a user device 1, triggering a response by the system. In one aspect, the response by the system is to download and display tissue information on the interface 5 or to provide links to sources of tissue information. In addition to browsers, other networking systems can be included in the information system, such as routers, peer devices, common network nodes, modems, and the like.

Suitable devices 1 connectable to the network 2 which are encompassed within the scope of the invention, include, but are not limited to, computers, laptops, microprocessors, workstations, personal digital assistants (e.g., palm pilots), mainframes, wireless devices, and combinations thereof. In one aspect, the device 1 comprises a text input element, such as a key board or touch pad, enabling the user to input information or queries into the system. In another aspect, navigating devices, including, but not limited to, a mouse, light pen, track ball, joystick(s) or other pointing device, are coupled to the device 1 to allow the user to navigate an interface 5.

In one aspect, the system comprises at least one server 3. The server 3 provides access to one or more data storage media such as hard disks or hard disk arrays. In one aspect, the server 3 maintains the database 4 on one of these hard disks. In one aspect, the server 3 comprises one or more applications, including the IMS 6, which permits a user to access information within the database 4, as well as to implement programs for determining relationships between data in the database 4 and cells or tissues on cell/tissue microarrays. In another aspect, another application program is provided which implements the search function of the IMS 6. In a further aspect, application programs which retrieve records also perform user-defined operations on the records (e.g., such as creating folders in which to store records of particular interest to a user). Applications programs ordinarily are written in a general purpose host programming language, such as C<++>; however, also include user-defined statements written in a relational query language such as SQL. In some aspects, a web application is provided which includes executable code necessary for the generation of SGL statements. The application can include configuration files which include pointers and addresses to the various software applications included within the server as well as to external and internal databases that must be accessed to service user requests.

In further aspects of the invention, the system comprises information output modules (e.g., printers) for outputting and reporting information from the database 4. The system can also comprise information input modules (e.g., scanners), for receiving information from a user, such as scanned data.

### Mixed Format Microarray Database (Specimen-Linked Database)

Information within the specimen-linked database 4 is dynamic, being added to and refined as additional users access the database 4 through the system. In one aspect, inputted information at least comprises information relating to the analyses of the microarrays described above and the database 4 organizes this information according to a data model. Data models are known in the art and include flat file models, indexed file models, network data models, hierarchical data models, and relational data models. Flat file models store data in records composed of fields and are dependent upon the particular applications comprising the IMS 6, e.g., if the flat file design is changed, the applications comprising the IMS 6 must also be modified. Indexed file systems comprise fixed-length records composed of data fields and indexes which group data fields according to categories. A spreadsheet system can also be used.

A network data model also comprises fixed-length records composed of data fields which are indexed according to categories. However, network data models provide record identifiers and link fields to connect records together for faster access. Network data models further comprise pointer structures which provide a shorthand means of identifying linked records. Hierarchical data models comprise fixed-length records composed of data fields, indexes, record identifiers, link fields, and pointer structures, but further represent the relationship of different records in a database in a tree structure. Hierarchical data models are described further in U.S. Pat. No. 5,980,096, the entirety of which is incorporated by reference herein.

In contrast, relational data models comprise tables comprising columns and rows of data elements or attributes. Attributes provide information about the different facts stored within the database 4. Columns within the table comprise attributes of the same data type (e.g., in one aspect, all information relating to patient X's drug exposure), while each row of the table represents a different relationship (e.g., row one, representing dosage, row two representing efficacy, row three representing safety). As with network data models, and hierarchical data models, relational database models link related information within the database.

Any of the data models described above can be used to organize information within the database 4 into information categories to facilitate access by a user of the information system. In a preferred aspect, a system operator, i.e., the user who provides access to the information system to other users, determines the parameters which define a particular information category recognized by a particular data model.

For example, in one aspect, the system operator determines the fields that are used to define the information category “drug exposure.” In this aspect, the system operator may determine that these fields should include: “types of drugs to which the patient was exposed”; “frequency of exposure”; “dose at each exposure”; “physiological response to exposure”; “tests used to measure physiological responses”; “molecular response to exposure”; “tests used to measure molecular responses”; and the like. Similarly, the system operator may determine that fields which define the information category “medical history of a patient” should encompass all information obtained by health care workers at any time during the patient's life, as well as information relating to tests performed by health care workers, or should encompass only selected portions of such records. It should be obvious to those of skill in the art that information categories determined by the system operator can overlap in the types of information contained within them. For example, information relating to medical history could include information relating to a patient's drug exposure. In one aspect, therefore, the database 4 further comprises links between different information categories which comprise areas of overlap.

The parameters defined by the system user are included within a database dictionary portion of the database 4 and, in one aspect, a user other than the system operator can access the database dictionary on a read-only basis to determine what parameters were used to define a particular information category. In another aspect of the invention, a user of the system can request that additional parameters be included in the definition of an information category, and, subject to the approval of the system operator, the definition of the information category can be modified as the database expands. In a further aspect, the database 4, for example, as part of the dictionary can include a table comprising word equivalents to facilitate searching by the IMS-6. In some aspects, the table comprises codes representing community accepted definitions of diagnoses, anatomic locations and the like (e.g., such as SNOWMED codes, DSM-IV-TR codes) or accepted genetic nomenclature (e.g., UNIGENE codes).

In one aspect, new information inputted into the system is stored within a temporary database and is subject to validation by the system operator prior to its inclusion in the portion of the database 4 to which all users of the system have access to.

In another aspect, data within the temporary database, is fully able to be accessed and compared to information within the specimen-linked database 4; however, users of the system are alerted to the fact that data within the temporary database has not necessarily been validated (e.g., repeated or evaluated as to quality). In this aspect, the information categories included within the temporary database can include information relating to the time and date on which the new information was inputted into the system.

In one aspect of the invention, information within information categories is derived from an analysis of any of the tissue microarrays described above. For example, in one aspect, the database 4 comprises information reflective of “whole body microarrays” which have been evaluated by user(s). In this aspect, information included within the database encompasses information relating to the types of tissue on the microarray and relating to biological characteristics of the tissue source (e.g., such as patient information). In another aspect, the database 4 comprises information including, but not limited to, the sex and age of the tissue source, underlying diseases affecting the tissue source, the types of drugs or other therapeutic agents being taken by the tissue source, the localization of the drugs and agents in the different tissues of the microarray, and the effects of the drugs and agents on the different tissues of the microarray, environmental conditions to which the tissue source has been, and is being exposed to, as well as the lifestyle of the tissue source (e.g., moderate or no exercise, alcohol, tobacco consumption, and the like), cause of death, and age of death (if appropriate).

In further aspects of the invention, information from a plurality of microarray is used to create the database 4, providing information relating to populations of individuals (e.g., such as demographic and/or epidemiological information). In one aspect, information relating to microarray(s) comprising at least one disease tissue sample (e.g., a tissue sample expressing biological characteristics associated with disease) is included within the database 5. In one aspect, this information relates to biological characteristics which define different stages of the disease (e.g., biological characteristics which are associated with different stages of cancer). In another aspect, information relating to the biological characteristics of normal tissues from the same or different patients is also included within the database 4. In a further aspect, patient information relating to the tissue sources of tissues at different locations on microarray(s) is included within the database, providing information such as gender, age, underlying diseases, family information, cause and time of death if appropriate, information relating to treatment with drugs or other therapeutic agents (e.g., such as protein or nucleic acid-based therapeutic agents), and/or exposure to chemotherapy, radiotherapy, surgery, environmental conditions, and the like.

While in one aspect, the database 4 comprises information relating to human tissues, in another aspect, the database 4 also includes information from non-human tissues (e.g., animals, plants, and/or genetically engineered animals or plants). For example, in one aspect, the database 4 includes information relating to the biological characteristics of non-human tissues which have been exposed to any of drugs, antibodies, protein therapies, gene therapies, antisense therapies, and the like. In some aspects, the biological characteristics of tissues from non-human individuals which have been genetically engineered to over express or under express desired genes are included within the database 4. In a further aspect, information within the database 4 also includes information from cell lines (normal and/or cancer cell lines) which have been genetically engineered to express desired genes (e.g., cell proliferation genes or tumor suppressor genes or modified forms of such genes).

In one aspect, the database comprises information relating to tissues from different recombinant inbred strains of individuals (e.g., mice). Such information includes, but is not limited to, the allele carried at one or more loci, haplotype information, and information relating to the expression of one or more proteins encoded by these loci. In a further aspect, information relating to diseases associated with particular alleles or haplotypes are further included within the database.

In one aspect, the database 4 comprises molecular profiling data (i.e., information relating to the expression of one or more biomolecules). In one aspect, molecular profiling data is obtained from any of normal tissue, diseased tissue (including tissues at different stages of disease), different developmental stages from one or more different types of organisms, and from tissues which have been genetically engineered to include different doses or altered forms of gene(s). Molecular profiling data from whole body microarrays as well as microarrays reflecting populations of individuals can also be included within the database 4. In one aspect, molecular profiling data includes the expression pattern of a plurality of genes expressed during cancer, a patient having one or more of an autoimmune disease, a neurodegenerative disease (either chronic or acute), a neuropsychiatric disorder, a respiratory disorder, a skin disorder, an endocrine disorder, and the like. In another aspect, molecular profiling data includes data relating to genes expressed during selected physiological processes. In still another aspect, molecular profiling data includes data relating to the expression of genes which are part of a common pathway during a normal or disease state.

While in one aspect, information within the database 4 is obtained from tissues provided on the microarrays described above, information can also be obtained from a variety of other sources, such as test samples assayed alongside cell and/or tissue microarrays (e.g., using profile array substrates), or test samples which have been assayed independently of cell and/or tissue microarrays, or samples from cells, or tissue panels from living patients or from archived tissues, and the like. Information relating to nucleic acid microarrays, protein, polypeptide, peptide, and other biomolecule arrays preferably is included within the database, irrespective of whether information from a corresponding cell and or tissue microarray has also been obtained. As used herein, although the database is described as being “specimen-linked” the database can also include data unrelated to specific test specimens. However, in a preferred embodiment, the database comprises data from multiple related sources, such as cell and tissue microarrays which have been evaluated alongside (either simultaneously or sequentially) with the other types of microarrays described above. Preferably, target samples reacted with molecular probes on these other types of microarrays are arrayed on the cell/tissue microarrays.

In one aspect, the specimen linked database 4 can be organized to facilitate information retrieval by the IMS 6 by providing a plurality of “subdatabases”, each of which comprises information relating to a particular category of tissue information. For example, in one aspect, the subdatabases comprise information relating to any of: oncology, cardiovascular diseases, respiratory diseases, renal diseases, gastrointestinal diseases, liver diseases, metabolic diseases, endocrine diseases, infectious diseases, inflammatory diseases, musculoskeletal diseases, neurological diseases (including neurodegenerative and neuropsychiatric diseases), dermatological diseases, gynecological diseases, and urological diseases.

In another aspect, subdatabases are restricted to particular types of information and include, but are not limited to, sequence subdatabases, protein structure subdatabases, chemical formula/structure subdatabases, expression pattern subdatabases (e.g., providing information relating to the expression of genes in different tissues, such as data from the target microarrays), information relating to drug targets and drug leads (e.g., including, but not limited to information relating to compound toxicity, side effects, efficacy, metabolism, drug interactions), as well as literature subdatabases, medical history subdatabases, demographic information subdatabases, and the like.

In one aspect of the invention, data within the database 4 is defined using SNOMED® Clinical Terms™. For example, different clinical concepts (e.g., cardiovascular disease, neurodegenerative disease, autoimmune disease, cancer, reproductive disease, neuropsychiatric diseases) are assigned unique concept identifiers which are represented within a “Concept Table” within the database 4. Concepts can be defined by codes, such that a string of codes can be used to cross reference data from a plurality of databases and subdatabases.

In a further aspect, the database 4 stores uncompressed raw data files, such as for example, microscopy and histological data obtained from the tissues. In this aspect, the database 4 is of a magnitude which enables storage of memory intensive files, and the network 2 connection enables high speed (T-1, T-3 or higher) transmission of the data to the user. In still another aspect of the invention, data relating to an image of the test tissue is stored within the database 4, and the image can be displayed by the user upon accessing the database 4.

Thus, as described above, the specimen-linked database 4 according to the invention makes information available concurrently from a number of different sources to enable a user to practice “genomic medicine,” i.e., to develop diagnostic and treatment modalities based not only on the physiological responses of a patient, but also on the biomolecular responses of a patient. As illustrated in the table below, in one aspect, a genomic medicine database is provided which comprises a plurality of subdatabases, including, but not limited to, a patient information subdatabase, a medical information subdatabase, a pathology information subdatabase, and a genomic information subdatabase. As can be seen from the table, information in one database may overlap (i.e., be repeated) in another database. For example, a pathology subdatabase can included molecular information relating to a particular disease, just as can a genomics database, but may also include additional information, such as information identifying the correlation between a particular marker and a morphological characteristic.

TABLE 1
Genomic Medicine Database

| Patient | Medical | Pathology | Genomic |
|---|---|---|---|
| Information | Information | Information | Information |
| Subdatabase | Subdatabase | Subdatabase | Subdatabase |
| Demographics | Diagnosis | Diagnosis | DNA |
| Life style | Other conditions | Histology | Protein |
| Epidemiology | Concurrent Illness | Clinical Data | mRNA |
| Family History | Medications | Molecular Markers | |
| | Outcome Survival | | |

### Physiological Response Database

In a preferred aspect of the invention, the database 4 comprises information relating to the physiological responses of patients to particular conditions, such as diseases, pathological conditions, drugs or agents, environmental conditions, and the like. Physiological responses include, but are not limited to, cellular metabolism, energy metabolism, nucleic acid metabolism, signal transduction, progression through the cell cycle, DNA repair, secretion, subcellular localization and processing of cellular constituents (e.g., including RNA splicing, protein modification and cleavage), cell-cell interactions, growth, differentiation, apoptosis, immune responses, neurotransmission, ion transport, sugar transport, lipid metabolism, and the like. The database 5 also can include information relating to kinetic parameters which govern physiological responses. For example, the database can include information relating to dissociation constants, Michaelis Menton constants, inhibition constants, catalytic constants, circulating half-life, excretion rates, and the like.

In one aspect, physiological responses are evaluated by monitoring the expression of a plurality of biomolecules representing at least one molecular pathway in a tissue sample (“pathway biomolecules”) and using the database 4 to identify correlations between an expression pattern observed and the likelihood that the source of the tissue sample has been exposed to one or more conditions. Preferably, physiological responses are evaluated by monitoring the expression of pathway biomolecules in a plurality of tissues, and more preferably, in whole body microarrays representing different populations of patients which share one or more traits.

In one aspect, the specimen-linked database 4 includes a plurality of records comprising information relating to pathway biomolecules and the effects of particular conditions on the expression of these biomolecules. In one aspect, the database 4 comprises records relating to biomolecules which are expressed or inhibited upon activation of a particular G-protein coupled receptor or “GPCR pathway biomolecules” For example, the database can include information relating to any one or more of a serotonin receptor (e.g., 5-hydroxytryptamine 1A, 1B, 1C, 1D, 1F, 2A, 2C, 5A and/or 5B receptors), an adenosine receptor (e.g., an adenosine A1 receptor, an adenosine A2A, A2B, A3, P2U, and/or P2Y), uridine nucleotide receptor, an adrenergic receptor (e.g., α-1A, 1B, 1C, 2A, 2B, 2C, and/or (3-1, 2, and/or 3), angiotensin receptor, bombesin receptor (e.g., bombesin Type 3, Type 4), neuromedin B receptor, gastrin-releasing peptide receptor, bradykin receptor, C5A-anaphylatoxin receptor, a cannabinoid receptor (e.g., Type 1, Type 2, Type A), gastrin receptor, dopamine receptor (e.g., dopamine 1A, 1B, D2, D3, D4), endothelin receptor (e.g., endothelin A, endothelin B) formyl-methionyl peptide receptor, gonadotrophin releasing hormone receptor, glycoprotein hormone receptor, histamine receptor (H1 and/or H2), interleukin-8 receptor (e.g., interleukin 8A and 8B), adrenocorticotrophin receptor, melanocortin receptor, melanocyte stimulating hormone receptor, muscarinic receptor (e.g., M1, M2, M3, M4, M5 receptors) neurokinin receptors, olfactory receptors, opiod receptors (delta, kappa, mu, and/or X receptors), opsin (blue or red/green sensitive), parathyroid receptor, secretin receptor, vasoactive intestinal peptide receptor, extracellular calcium-sensing receptor, metabotropic glutamate receptor, prostanoid receptor (EP1, EP2, EP3, EP4), thromboxane receptor, somatostatin receptor (Type 1, 2, 3, and/or 4), Burkitts' Lymphoma receptor, EB1I orphan receptor, EDG1 orphan receptor, G10D orphan receptor, GPR3 orphan receptor, GPR6 orphan receptor, GPR10 orphan receptor, LCR1 orphan receptor, mas oncogene, RDC1 orphan receptor SENR orphan receptor, calcitonin receptor, parathyroid hormone receptor, secretin receptor, vasoactive intestinal peptide receptor, extracellular calcium sensing receptor, a glutamate receptor, or mutated or variant forms thereof, and any biomolecules whose expression is turned on or off upon activation of these receptors, and/or their mutant or variant forms. Preferably, the database 5 includes information relating to the expression all of these biomolecules in a plurality of different tissues (e.g., such as the whole body microarrays described above).

In a preferred aspect, the database 4 comprises information relating to the expression of one or more tyrosine kinase pathway molecules. Such molecules include, but are not limited to, NTRK1; PTK2; SRK; CTK; TYRO3; BTK; LTK; SYK; STY; TEK; ERK; TIE; TKF; NTRK3; MLK3; PRKM4; PRKM1; PTK7; EEK; MNBH; BMX; ETK1; MST1R; 135 KD BTK-ASSOCIATED PROTEIN; LCK; FGFR2; TYK3; FER; TXK; TEC; TYK2; EPLG1; EMT; EPHT1; ZRK; PRKMK1; EPHT3; GAS6; KDR; AXL; FGFR1; ERBB2; FLT3; NEP; NTRKR3; EPLG5; NTRK2; RYK; BLK; EPHT2; EPLG2; EPLG7; JAK1; FLT1; PRKAR1A; WEE1; ETK2; MuSK; INSR; JAK3; FMS-related tyrosine kinase-3 LIGAND; PRKCB1; HER3; JAK2; LIMK1; DUSP1; DMD; HCK; YWHAH; RET; YWHAZ; YWHAB; HTK; MAP Kinase Kinase 6; PIK3CA; CDKN3; Diacylglycerol Kinase; PTPN13; ABL1; DAGK11; Focal Adhesion Kinase 2; EDDR1; ALK; PIK3CG; PIK3R1; EHK1; KIT; FGFR3; VEGFC; MST1; FHC; EGFR; S100A10; NF1; TRK; CML; GRB7; S100A4; RASA2; MET; STAT3; smg GDS-Associated Protein; Ubiquitin-Binding Protein P62; LCP2; EPS15; GRB10; GDNFRA; SHC1; CF; TPM3; CDC2; LGMD2C; Ash Protein; TSD; AGRN; S100A6; HPRT1; Cytovillin; GLG1; GRB14; FES; P32 Splicing Factor SF2 Associated Protein; Cartilage-Derived Morphogenetic Protein 1; PAX5; IRS1; SOS2; PIGA; RHO; TGFBR2; CSF1R; PDNP1; NPM1; ADD1; HMMR; ESR; SLA; PGF; ETV6; M6P2; FGR; FGF8; SNX1; TCF1; HGF; IL6R; YES1; ENG; HCLS1; GTF2H1; PDGFB; PDCD1; TGFBR1; EPS8; VEGF; CAR; ANGPT2; Hypogammaglobulinemia And Isolated Growth Hormone Deficiency, X-LINKED; Glial Cell Line-Derived Neurotrophic Factor Receptor-BetA; and H4 gene and mutants and/or variants thereof.

In other aspects, the physiological response database 4 comprises information relating the expression of one or more cell cycle genes. For example, the database can comprise information relating to the expression of one or more of SL1, C42, cdk1, cdk7, CycH, C42, C14, PCNA, R11, R10, CycD, p21, S9, CycA, RPA, S9, CycB, p68, primase, R2, Polα, CycE, Skp1, CBF3, C26, E2f, DMP1, cdc25a, CycD, cdk4/6, Gadd45, p26, p27, p53, p57, C17, C18, C23, C21, C13, C28, C30, C37, C38, C39, E20, pS76, Chk1, C-TAK1, APC, cdc25C, cdk1, cks1, Wee1, Myt1, Plk1, C15, C41, C37, C6, pTY4Y15, pT161, pS216, pY15, and other molecules in the cyclin-E2F cell cycle control system (see, e.g., as described at http://discover.nci.nih.gov/kohnk/interaction_maps.html), and mutants and/or variants thereof.

In another aspect, the physiological response database 4 comprises information relating the expression of one or more DNA repair genes. For example, the database can comprise information relating to the expression of one or more of Rpase II, TBP, TAFH250, P36, RHA, MDM2, p53, p2′7, CSB, XPB/D, p36, cdk7, cycH, C43, P11, A5, C43, c-Abl, H7, p16, cycD, cdk4, primase, R2, p21, cycE, cycA, cdk2, PCNA, Polα, p70, N10, N7, S1, S2, S7, S8, S10, S11, S12, S13, S14, S16, S17, p34, rad52, SBF3, Skp1, Skp2, R1, DNAP a, p68, RF-C, FEN-1, ligase 1, Gadd45, XPC, cycD, PARP, karp, Ku80, Ku70, RPA2, HMG, histones, ATM, paxillin, Crk, pRb, RAD51, ss or ds DNA breaks, XPF, XPC, XPA, XPG, DNAP [symbol] , ligaseII, ERCC1, U-glycosylase, BRCA1, pKCα/β, PARP, glycohydrolase, and other genes involved in the p53-MDM2 DNA repair pathway, and mutants and/or variants thereof.

The physiological response database 4 can also comprise information relating the expression of one or more biomolecules involved in cholesterol metabolism, such as LDL, LDL-receptor, VLDL, HDL, cholesterol acyltransferase, apoprotein E, Cholesteryl esters, ApoA-I and A-II, HMGCoA reductase, cholesterol, and mutants and/or variants thereof.

In another aspect, the physiological response database 4 comprises information relating the expression of one or more biomolecules involved in apoptosis, such as Bcl, Bak, ICE proteases, Ich-1, CrmA, CPP32, APO-1/Fas, DR3, FADD containing proteins, perforin, p55 tumor necrosis factor (TNF) receptor, NAIP. IAP, TRADD-TRAF2 and TRADD-FADD, TNF, D4-GDI, NF-kB, CPP32/apopain, CD40, IRF-1, p53, apoptin, and mutants and/or variants thereof.

The physiological response database 4 can also comprise information relating the expression of one or more biomolecules involved in blood clotting, such as thrombin, fibrinogen, factor V, Factor VIII-FVa, FVIIIa, Factor XI, Factor Xia, Factors IX and X, thrombin receptor, Thrombomodulin™, protein C (PC) to activated protein C (aPC). aPC, plasminogen activator inhibitor-1 (PAI-1), tPA (tissue plasminogen activator), and mutants and/or variants thereof.

In another aspect, the physiological response database 4 comprises information relating the expression of one or more biomolecules involved in the flt-3 pathway, such as, flt-3, GRP-2, SHP-2, SHIP, Shc, and mutants and/or variants thereof.

In another aspect, the physiological response database comprises information relating the expression of one or more biomolecules involved in the JAK/STATS signaling pathway, such as Jak1, Jak2, IL-2, IL-4 and IL-7, Jak3, Ptk-2, Tyk2, EPO, GH, prolactin, IL-3, GM-CSF, G-CSF, IFN gamma, LIF, OSM, IL-12 and IL-6, IFNR-alpha, IFNR-gamma, IL-2R beta, IL-6R, CNTFR, Stat1 alpha, Stat1 beta, Stats2-6, and mutants and/or variants thereof.

In another aspect, the physiological response database 4 comprises information relating the expression of one or more biomolecules involved in a MAP kinase signaling pathway, such as flt-3, ras, raf, Grb2, Erk-1, Erk-2, and Src, Erb2, gp130, MEK-1, MEK-2, hsp 90, JNK, p38, Sin1, Sty1/Spc1, MKK's, MAPKAP kinase-2, JNK/SAPK, and mutants and/or variants thereof.

The physiological response database 4 can also comprise information relating the expression of one or more biomolecules involved in a PI 3 kinase pathway, such as SHIP, Akt, and mutants and/or variants thereof.

The physiological response database 4 can also comprise information relating the expression of one or more biomolecules involved in a ras activation pathway, such as p120-Ras GAP, neurofibromin, Gap1, Ral-GDS, Rsbs 1, 2, and 4, Rin1, MEKK-1, and phosphatidylinositol-3-OH kinase (PI-3 kinase), ras, and mutants and/or variants thereof.

In another aspect, the physiological response database 4 comprises information relating the expression of one or more biomolecules involved in an SIP signaling pathway, such as GRB2, SIP, ras, PI 3-kinase, and mutants and/or variants thereof.

In another aspect, the physiological response database 4 comprises information relating the expression of one or more biomolecules involved in an SHC signaling pathway, such as trkA, trkb, NGF, BDNF, NT-4/5, trkC, f NT-3, Shc, PLC gamma 1, PI-3 kinase, SNT, ras, rafi, MEK, MAP kinase, and mutants and/or variants thereof.

In another aspect, the physiological response database 4 comprises information relating the expression of one or more biomolecules involved in a TGF- [symbol] signaling pathway, such as BMP, Smad 2, Smad4, activin, TGF- [symbol] , and mutants and/or variants thereof.

In another aspect, the physiological response database 4 comprises information relating the expression of one or more biomolecules involved in a T cell receptor based signaling pathway, such as lck, fyn, CD4, CD8, T cell receptor proteins, and the like.

The physiological response database 4 can also comprise information relating the expression of one or more biomolecules involved in a MHC-1 mediated antigen presentation, such as TAP proteins, LMP 2, LMP 7, gp 96, HSP 90, HSP 70, and the like.

In a preferred aspect, the physiological response database 4 comprises information relating to the expression of a plurality of pathway molecules expressed within whole body tissue microarrays obtained from populations of patients and the database is subdivided to include subdatabases including information relating to specific pathways, such as the ones described above. Additional subdatabases encompassed within the scope of the invention include, but are not limited to, the EGF receptor pathway, insulin receptor pathway, p53 mediated pathways, glutamate receptor pathways, metabolic pathways, HOX gene and other pattern forming gene pathways, and the like.

Preferably, the physiological response database comprises information relating not only to the expression of biomolecules in particular pathways, but also includes information relating to the biological impact of this expression. For example, the database 4 preferably includes information relating the expression of a plurality of pathway biomolecules to physiological responses to disease, pathological conditions, drugs, agents, therapies, environmental conditions, and the like. The database can also include information relating the expression of pathway biomolecules to physiological parameters such as blood pressure, heart rate, pH, body temperature, level of metabolites, and the like. In some aspects, information relating to biological impact includes the association of the expression of pathway biomolecules with parameters considered as being important to quality of life, e.g., levels of pain, ability to move, sleep, eat, and the like.

A control subdatabase also is preferably provided, comprising information relating to the average physiological responses of healthy patients in specific demographic groups. This database can further include information relating to the expression of housekeeping genes in different tissues and different stages of development.

Still more preferably, the database also links information relating to the expression of different pathway molecules to information about patient characteristics. For example, in one aspect, the database includes information relating to the sources of tissues on a plurality of microarrays which have been evaluated to determine the expression of a plurality of pathway biomolecules. This information can include, but is not limited to, information regarding the age, sex, weight, height, ethnic background, occupation, environment, family medical background and medical history of the sources of the tissue samples on the microarray. Medical history information can include information pertaining to prior and current diseases or conditions, diagnostic and prognostic test results, drug exposure, or exposure to other therapeutic agents, responses to drug exposure or exposure to other therapeutic agents, history of alcoholism, drug or tobacco use, cause of death, if appropriate, and the like.

In one aspect, the physiological response database 4 includes information relating to the effect of drugs on a plurality of pathway molecules and/or information relating to the localization of one or more drugs in tissues on a whole body microarray from one or more patients. Subdatabases including this information can be organized according to particular classes of drugs and particular concurrent and underlying illnesses to which a patient has been exposed or according to other common patient characteristics. In some aspects, the drugs correlated to physiological responses include anti-cancer agents such as those described in Weinstein et. al. Science 258: 447 (1992) and van Osdol et. al, J Natl Cancer Inst 86: 1853 (1994) and/or compounds included in an external database such as the Anti-Cancer Agent Mechanism Database, which includes a set of 122 compounds with anti-cancer activity and reasonably well known mechanism action. Still other subdatabases can be provided in which the expression of pathway biomolecules is correlated with exposure of a patient to one or more toxic agents.

In a further aspect, the physiological response database comprises a database of information relating to treatment options, including, but not limited to drugs available to patients who exhibit particular physiological responses. Treatment databases can further include expert rules for correlating particular treatment options to particular physiological responses. Treatment databases are known in the art and are described, for example, in U.S. Pat. No. 6,188,988e, the content of which is incorporated by reference herein in its entirety.

### Information Management System (IMS) for Identifying Pathway Biomolecules and for Modeling Molecular Pathways

The database 4 according to the invention is coupled to an Information Management System (IMS) 6. In one aspect, the IMS 6 includes functions for searching and determining relationships between data structures in the database 4. In another aspect, the IMS 6 displays information obtained in this process on an interface 5 of the user device 1. In one aspect, the IMS 6 is stored within one or more servers 3, and is accessible remotely by the user of the device 1 through the network 2. In another aspect of the invention, the IMS 6 is accessible through a readable medium, which the user accesses through their particular device 1, such as a CD-ROM.

IMS 6's encompassed within the scope of the present invention include the Spotfire™ program, which is described in U.S. Pat. No. 6,014,661, the entirety of which is incorporated by reference herein. This database management software provides links to genomics data sources and those of key content and instrumentation providers, as well as providing computer program products for gene expression analysis. The software also provides the ability to communicate results and records electronically. Other programs can also be used, and are encompassed within the scope of the invention, and include, but are not limited to Microsoft Access, ORACLE and ILLUSTRA. In a preferred aspect, a JAVA-based system is used to facilitate handling of large quantities of data.

In one aspect, the IMS 6 comprises a stored procedure or programming logic stored and maintained by the IMS 6. Stored procedures can be user-defined, for example, to implement particular search queries or organizing parameters. Examples of stored procedures and methods of implementing these are described in U.S. Pat. No. 6,112,199, the entirety of which is incorporated herein by reference.

In one aspect of the invention, the IMS 6 includes a search function which provides a Natural Language Query (NLQ) function. In this aspect, the NLQ accepts a search sentence or phrase in common every day from a user (e.g., natural language inputted into an interface of a device 1) and parses the input sentence or phrase in an attempt to extract meaning from it. For example, a natural language search phrase used with the specimen-linked database 4, could be “provide medical history of patient at location 1,1 of microarray 4591.” This sentence would processed by the search function of the IMS 6 to determine the information required by the user which is then retrieved from the specimen-linked database 4. In another aspect of the invention, the search function of the IMS 6 recognizes Boolean operators and truncation symbols approximating values that the user is searching for.

In one aspect, the search function of the IMS 6 generates search data from terms inputted into a field displayed on an interface 5 of a device 1 in the system in a form recognized by at least one search engine (e.g., identifying search terms which are stored in fields in the database 4 or in the summary subdatabase), and transfers the search data to at least one search engine to initiate a search. However, in another aspect, the search query is communicated through the selection of options displayed on the interface 5. For example, in one aspect, search results are displayed on the interface 5, which may be in the form of a list of information sources retrieved by the at least one search engine. In another aspect, the list comprises links which link the user to information provided by the information source. In a further aspect, the search function of the IMS 6 removes redundancies from the list and/or ranks the information sources according to the degree of match between the information source and the search terms extracted, and the interface 5 displays the information sources in order of their rankings Search systems which can be used are described in U.S. Pat. No. 6,078,914, the content of which is incorporated herein by reference in its entirety.

In another aspect, the search function of the IMS 6 searches a summary subdatabase of the database 4 to identify particular subdatabase(s) most relevant to the search terms which have been inputted by the user. In this aspect, the search function of the IMS 6 restricts its search to subdatabases so-identified. In a further aspect, the subdatabases searched by the IMS 6 can be defined by the user.

In one aspect, relationships are defined by codes, such as SNOMED® codes, which can be inputted into the system by a user (e.g., on an interface of a user device). SNOMED® and SNOMED codes are described further in Altman, et al., Proceedings of American Medical Informatics Association Eighteenth Annual Symposium on Computer Applications in Medical Care. November 5-9, Washington D.C. pg. 179-183; Bale, Pathology; 23(3): 263-267, 1991; Ball, et al., Computing pp. 40-46, 1999; Barrows, et al., Proceedings of American Medical Informatics Association Eighteenth Annual Symposium on Computer Applications in Medical Care, November 5-9, Washington D.C. pg. 211; Beckett, Pathologist, Vol. XXXI, No. 7, July 1977; Bell, Journal of the American Medical Informatics Association, 1(3): 207-217, 1994; Benoit, et al., Proceedings of the Annual Symposium of Computers Applications in Medical Care. 1992; pp. 787-788; Berman, et al., A SNOMED Analysis of Three Years' Accessioned Cases (40,124) of Surgical Pathology Department: Implications for Pathology-based Demographic Studies. Proceedings of American Medical Informatics Association Eighteenth Annual Symposium on Computer Applications in Medical Care. Nov. 5-9, 1994, Washington D.C. pg. 188-192; Berman, et al., Modern Pathology. 9(9): 944-950, 1996; Bidgood., Meth. Inf. Med. 37: 404-414, 1998; Brigl, et al., International Journal of Bio-Medical Computing. 38: 101-108, 1995; Brigl, et al., Int J Biomed Comput. 37(3): 237-247, 1994; Campbell, et al., Methods Inf. Med. 37 (4-5): 426-39, 1998; and Campbell, et al., Proceedings of American Medical Informatics Association Eighteenth Annual Symposium on Computer Applications in Medical Care. Nov. 5-9 1994, Washington, D.C. pg. 201-205, for example, the entireties of which are incorporated by reference herein.

In a further aspect of the invention, the IMS-6 includes a mapping function for mapping terms to particular tables within the database 4. Alternatively, or in addition to SNOMED®, other classification and mapping codes can be used (e.g., CPT, OPCS-4, ICD-9, and ICD-10). In one aspect, the IMS-6 comprises a program enabling it to read inputted codes and to access and display appropriate information from a relationship table. For example, in one aspect, unique SNOMED® codes are assigned to tissues from specific anatomic sites, while in another aspect, codes are assigned to tissues having specific pathologies (e.g., specific types of cancer) and/or having selected pathologies (e.g., diagnostic codes are assigned to tissue samples/specimens which are the targets of specific types of cancer). In a further aspect (not shown), tissue samples/specimens are cross-referenced using SNOMED® codes for both anatomic sites and diagnosis. Exposure of individual tissue samples to particular drugs can also be indicated by codes such as by using American Hospital Formulary Service List (AHFS) Numbers or “V-Codes” to classify other types of circumstances or events to which the source of a tissue sample has been exposed such as vaccinations, potential health hazards related to personal and family history, and exposure to toxic chemicals, and the like (see, e.g., as described in U.S. Pat. No. 6,113,540, which is incorporated by reference herein in its entirety.).

In a further aspect, specimens/tissues are obtained from individuals having a neuropsychiatric disorder, and specimens/tissues on a microarray are cross-referenced in the database (i.e., linked to the database) according to the individuals' classification using DSM-IV-TR criteria. In another aspect, specimens/tissues are linked to the database using ICD-9-CM criteria. In still another aspect, the specimens/tissues are cross-referenced using a number of criteria, such as tissue type, date of birth of the source individual, medical history of the source individual, ICD-9 criteria, DSM-IV TR criteria, Medications, and method of preparation. In a further aspect, the ICD-9 and/or DSM-IV-TR criteria are indicated using codes. ICD-9-CM codes are alpha-numeric codes that classify diseases and a variety of signs, symptoms, abnormal findings, complaints, social circumstances and external causes of injury or diseases. Nearly every health condition can be assigned to a unique category and given a code, up to six characters long including a set of similar diseases. DSM-IV TR codes are numeric classifications of diagnostic statistics, particularly for mental health disorders (Diagnostic and statistical manual of mental disorders, 2002, APA).

In addition to comprising a search function, the IMS 6 comprises a relationship determining function. In one aspect, in response to a query and/or the user inputting information regarding a tissue into the information system, the IMS 6 searches the database 4 and classifies tissue information within the database 4 by type or attribute (e.g., patient sex, age, disease, exposure to drug, tissue type, cancer grade, cause of death, and the like, and/or by codes, such as by SNOMED® codes, ICD-9 codes, and/or DSM-IV-TR codes). In one aspect, when all attributes have been defined and classified as characteristic of defined relationship(s), the IMS 6 assigns a relationship identification number to each attribute, or set of attributes, and signals representing these attribute(s) are stored in the database 4 (e.g., as part of the data dictionary subdatabase) where they are indexed by the relationship ID# and provided with a descriptor. For example, in one aspect, the expression of a plurality of biological characteristics which have been classified as correlating to a disease state X (e.g., cancer) is assigned an ID# and a descriptor such as “diagnostic traits of disease X.”

In one aspect, the relationship determining function of the IMS 6 employs a statistical program to identify groups of attributes as representing a particular relationship. In one aspect, the statistical program is a non-hierarchical clustering program. In another aspect, the clustering program employs k-means clustering.

Clustering programs can also be used to identify structural relationships between newly identified pathway molecules to identify conserved domains and similar structures. The identification of conservation can be used to establish initial predictions regarding interactions between candidate pathway molecules and other pathway molecules based on the existence of such interactions in other organism. In one aspect, the IMS-6 is used in conjunction with one or more genomic and/or proteonomic database and search platforms, including, but not limited to GeneData Phylosopher™, GeneSpring™ (available from Silicon Genetics), MetaMine™, and the like. Such platforms are intended to complement the IMS-6 system's ability to access and perform operations on disparate data.

Pipelining can be used to streamline various operations performed by the IMS-6 allowing disparate data sources to be analyzed sequentially and allowing data to be screened using characteristics not necessarily stored in the database.

The IMS 6 analyzes the relationships between data in the database 4 and/or new data being inputted, using any method standardly used in the art, including, but not limited to, regression, decision trees, neural networks, and fuzzy logic, and combinations thereof. In response to the results of this analysis, upon a query by a user, the system displays at least one relationship or identifies that no discernible relationship can be found on the interface 5 of the user device 1. In one aspect, the system displays descriptors relating to plurality of relationships identified by the IMS 6 on the interface 5 as well as information relating to the statistical probability that a given relationship exists.

In one aspect, the user selects among a plurality of relationships identified by the IMS 6 by interfacing with the interface 5 to determine those of interest (e.g., a relationship which is a disease might be of interest, while a relationship regarding hair color might not be). In another aspect of the invention, rather than scanning an entire database 4, the IMS 6 samples the database 4 randomly until at least one statistically satisfactory relationship is identified, with the user setting parameters for what is “statistically satisfactory.” In a further aspect of the invention, the user identifies particular subdatabases for the IMS 6 to search. In still another aspect, the IMS 6 itself identifies particular subdatabases based on query terms the user of the system has provided.

In one aspect of the invention, the relationship of interest is used to provide a diagnosis of a disease (e.g., the relationship identified is a high correlation with a disease state). In another aspect of the invention, the relationship of interest is used to identify the biological role of an uncharacterized gene, or to identify particular demographic factors (e.g., such as socioeconomic factors) associated with a disease state or other physiological response to a condition.

In one aspect of the invention, the IMS-6 system is used to identify populations of patients who share selected clinical characteristics by identifying sources of tissue samples who have these clinical characteristics. Clinical characteristics may be embodied in data which has already been entered into the database 4 or may be embodied in new data, which is being inputted into the system for validation. In one aspect, populations of patients are identified who share a particular clinical history or outcome, a specific type of physiological response to a drug, either adverse or beneficial.

In another aspect, the IMS-6 identifies relationships between sets of genes expressed or not expressed in tissues on one or more microarrays and clinical information relating to the patients from whom the tissues were obtained. For example, in one aspect, the IMS-6 identifies relationships between a pathological condition (e.g., such as stroke) and genes expressed or not expressed during in tissues from patients who have experienced or are experiencing the condition. For example, in one aspect, the relationship determining function of the IMS-6 (for example, an application program which performs k-means clustering) is used to designate potential pathway genes, i.e., genes which are expressed during a disease and whose expression is related to the expression of other genes in the pathway.

Thus, in a very simple aspect, where a stroke victim A expresses genes 1, 2, 3, 4, a stroke victim B expresses genes 1, 2, 4, 7, 8, a stroke victim C expresses genes 1, 2, 4, 8, 9, 10, and normal patients D, E, and F express genes 2, 3, 8, the IMS 6 would identify genes 1, 4, 7, 9, and 10 as potentially involved in a pathway of genes affected during stroke, and in certain aspects, would rank genes 1 and 4 as being highly likely to be pathway genes. In a further aspect, the IMS 6, in response to a user query would identify other patient parameters associated with the expression of genes 7, 9, and 10 and would perform clustering analyses to determine whether any relationships identified were statistically unlikely to arise by chance. For example, the IMS 6 might identify that populations expressing genes 7, 9, and 10, in addition to stroke, suffer from cardiovascular disease.

In one aspect of the invention, the IMS 6 includes an expert system. For example, the IMS 6 can comprise an object-oriented deployment system (e.g., such as the G2 Version 3.0 Real Time Expert System, available from Gensym, Corp.). Static Expert systems can also be used. Expert systems can be used to establish rules and procedures to identify and validate molecular pathways and to correlate changes in the expression of pathway biomolecules with any of the physiological responses described above. In one aspect, the expert system includes an inference function that operates on information within the specimen-linked database 4 and its associated subdatabases to identify biomolecules which are likely to belong to a pathway. The inference function allows the system 1 to rank pathways identified according to their probability of occurrence given the information which has been inputted into the database 4. In other aspects, the system 1 can be directed by a user to simulate pathways and to compare these pathways with molecular profiling data within the database 4. Preferably, the IMS 6 ranks simulated pathways according to their likelihood of occurrence based on data obtained from a plurality of tissue microarrays. The expert system of the IMS 6 can further include a transaction manager whose function is to direct input and output requests between one or more servers 3 of the system and the interfaces of one or more user devices 1 of the system, in order to respond to user requests.

Expert systems are known in the art and include such systems as MYCIN, EMYCIN, NEOMYCIN, and HERACLES (see, e.g., Clancy, “From Guidon to Neomycin and Heracles in Twenty Short Lessons: ORN Final Report 1979-1985,” The AI Magazine 8/86, pp. 40-60; Thompson et al., “A Qualitative Modeling Shell for Process Diagnosis,” 1986 IEEE Software, pp. 6-15; Bylander, “CRSL: A Language for Classificatory Problem Solving and Uncertainty Handling,” The AI Magazine 8/86, pp. 66-77; Hofmann et al., “Building Expert Systems for Repair Domains,” Expert Systems, 1/86, vol. 3, No. 1, pp. 4-11; and Yung-Choa Pan et al., “Pies: A Engineer's Do-It-Yourself Knowledge System for Interpretation of Parametric Test Data,” AI Magazine, Fall, 1986, pp. 62-69). Other expert systems are described in, for example, U.S. Pat. No. 6,154,750, U.S. Pat. No. 6,188,988, U.S. Pat. No. 6,149,585, U.S. Pat. No. 6,055,507, U.S. Pat. No. 5,991,730, and U.S. Pat. No. 5,777,888, and U.S. Pat. No. 4,866,635. The entireties of these references are incorporated by reference herein.

Relationships identified by the IMS 6 can be displayed to the user in a variety of formats such as graphs, histograms, dendograms, charts, tables and the like. In a preferred aspect, in response to a request by a user, the system 1 displays on the interface of a user device 1 a representation of a molecular pathway which includes a plurality of pathway biomolecules graphically arranged according to their effect on the expression of other pathway biomolecules (e.g., connected by arrows and the like). When a user selects a particular pathway biomolecule on the “pathway interface” (e.g., by moving a cursor to a representation of the biomolecule, such as the biomolecule's name), the user is linked to an interface which provides information relating to the biomolecule. The interface can alternatively, or additionally, provide information category links which provide the user with access to portions of the database 4 which comprise information related to a particular information category.

Information about a biomolecule can include a three-dimensional molecular structure information, sequence information and/or links to external genomic and/or protein databases, where appropriate (e.g., such as GenBank or SWISS-Prot), information relating to one or more of: mutations, allelic variants, ligands, substrates, products, cofactors, agonists, and antagonists, reference links to external databases including references about the biomolecule (e.g., PubMed), and information about available clones (e.g., cDNA molecules expressing a pathway protein), if applicable, and the like.

In a preferred aspect, the user can access an “expression profile interface” on which is displayed a representation of the levels and/or forms of expression of the selected pathway biomolecule in a plurality of tissues. Preferably, this interface is also associated with one or more information category links identifying physiological response categories such as responses to diseases, pathological conditions, drugs or other agents, environmental conditions and the like. Selecting one of these information categories will link the user to an interface on which is displayed an expression profile of the biomolecule during a particular physiological response. In certain aspects, the expression profiles of pathway molecules in a plurality of tissues during a plurality of different physiological responses is displayed on a single interface for comparison. In one aspect, in response to a user query, the system performs an electronic subtraction analysis and displays differences in expression profiles on a single interface. Electronic subtraction methods are known in the art (see, for example, U.S. Pat. No. 6,114,114, the entirety of which is incorporated by reference herein). A “pathway home” button can be provided on any or all of these interfaces to direct a user back to the interface displaying the pathway.

In one aspect, selecting a pathway biomolecule on a pathway interface provided by the system 1 displays a pull down menu which provides the user with the simulation options, such as “delete,” “underexpress” and/or “overexpress.” Selecting one of these options directs the IMS 6 to simulate the effects of deleting, underexpressing and/or overexpressing the biomolecule identified on the expression of other biomolecules in the pathway. In some aspects, selecting “underexpress” or “overexpress” causes a pull down menu of values to be displayed (e.g., 2× or −2×; selecting 2× would show the effects of doubling the biomolecule, while selecting −2× would show the effects of halving the biomolecule). In some aspects, the system 1 is used to model the effect of one or more feedback loops on the pathway.

In some aspects, selecting a representation of a receptor in a pathway interface (e.g., such as a GPCR) links the user to an interface which displays information categories links relating to “antagonists” and “agonists” of the receptor molecule. These links provide a user with access to portions of the specimen-linked database which include information relating to molecules which have been demonstrated to alter the interaction of the receptor with its ligand. These molecules can include drugs with known dissociation constants and characterized circulating half lives. However, in other aspects, the user can direct the IMS 6 to simulate the molecular structure of antagonist or agonist molecule and model the effect of binding such a molecule to the receptor on the expression of other pathway molecules in the pathway to which the receptor belongs. In silico modeling of receptor ligand interactions is known in the art and is described in, for example, Lengauer et al., Curr. Opin. Struct. Biol. 5: 402-406 (1996); Strynadka et al., Nature Struct. Bio. 3: 233-239 (1996); Chen et al., Biochemistry 36: 11402-11407 (1997); and Kuntz, et al.,. J. Mol. Biol. 161: 269-288 (1982); the entireties of which are incorporated by reference herein.

In some aspects, the IMS 6 is used to identify the effects of agents (e.g., antagonists or agonists or potentially toxic agents) on a plurality of pathway molecules by comparing the physiological responses of cells in culture exposed to one or more agents with the biological characteristics of samples of these cells arrayed on tissue microarrays. Thus, in some aspects, the IC₅₀ value, or the concentration of an agent that causes 50% growth inhibition, the GI₅₀ value (which measures the growth inhibitory effect of an agent) the TGI (which provides a measure of an agent's cytostatic effect), and/or the LC₅₀ (which provides a measure of the agent's cytotoxic effect) is measured in vitro and correlated with the expression of one or more pathway biomolecules in samples on microarrays. In the case of agonists or antagonists, the effects of these agents on dissociation constants and other kinetic parameters of biological receptors can also be measured.

In some aspects, in response to a user query, the system displays a “mean graph” interface or an interface which provides a display of the pattern created by plotting positive and negative values generated from a set of GI₅₀, TGI, or LC₅₀ values. For example, positive and negative values can be shown plotted along a vertical line that represents the mean response of all cells exposed to an agent. Positive values provide a measure of which cellular sensitivities are significant, while negative values indicate results that are not significant. Mean graphs are described in, for example, Paull et al., J. Natl. Cancer Inst. 81: 1088-1092 (1989); Paull et al., Proc. Am. Assoc. Cancer Res. 29: 488 (1988), the entireties of which are incorporated by reference herein.

In some aspects, the IMS 6 implements a COMPARE algorithm to provide an ordered list of agents ranked according to their effects on the physiological responses of cells and/or tissues and on the expression of biomolecules in these cells and/or tissues. COMPARE algorithms are described in Paul et al., supra, and in Hodes et al., J. Biopharm. Stat. 2: 31-48 (1992), the entireties of which are incorporated by reference herein. Data obtained from this analysis can be added to the specimen-linked database 5 and made available to other users of the system 1. The IMS 6 also can include statistical programs to facilitate comparisons such as PROC CORR. Other algorithms, such as the DISCOVER algorithm also can be used.

In a preferred aspect, in response to a user query, the system will display an interface which includes a representation of the expression profiles of pathway biomolecules in tissues exposed to an agent characterized as described above. In still more preferred aspects, the system will perform an electronic subtraction to show only changes in expression profiles in treated tissues compared to untreated tissues. In still other aspects, changes in expression values are expressed as ratios of differences (e.g., level of biomolecule A in treated tissue 1/level of biomolecule A in untreated tissue 1) or as percent changes of expression.

The above assays can be performed in parallel with assays using animals who have also been exposed to the same agents to compare the physiological responses of these animals with the expression of pathway biomolecules in whole body tissue microarrays obtained from these animals. Physiological responses measured can include the overall health of the animal, organ function, levels of metabolites and other molecules in the blood, behavioral changes, and the like. In some aspects, the localization of the agents in tissues on the microarrays is determined, for example, by using labeled aptamer probes or other molecular probes which recognize these agents.

Similarly, the physiological responses of patients to agents can also be correlated with the expression of a plurality of pathway biomolecules by using tissue microarrays. In some aspects, patient samples are derived from autopsies and the expression of pathway biomolecules in whole body tissue microarrays is correlated with detailed information relating to the patient's medical history (e.g., including drug exposure), family medical history, and other characteristics which have been inputted into the specimen-linked database 4.

In one aspect, the user is able to view, print, permanently store, read, and/or further manipulate data displayed on the display 5 of his or her device 1. In this aspect, the user is able to use the system 6 to investigate and define the relationships most relevant to tissues or diseases of interest (e.g., the relationship between medications being used and menstrual status, and/or further the relationship between menstrual status and other concurrent conditions, such as cardiac conditions experienced, hypertension, diabetes, pneumonia, etc.). In one aspect, the user is also able to link to any database publicly accessible through the network 2, and to integrate information from such a database with the system's database 4 through the IMS 6. Thus, in one aspect, information can be shared with other users and information from other users can be continuously added to the database 4.

One aspect of the invention recognizes potential difficulties in enabling unrestricted access to the database 4, and encompasses providing restricted access to the database 4, and/or restricted ability to change the contents of the database 4 or records in the database 4 using the IMS 6 and/or a security application. Methods of providing restricted access to electronic data are known in the art, and are described, for example, in U.S. Pat. No. 5,910,987, the entirety of which is incorporated by reference herein.

### Kits

The invention further provides kits. A kit according to the invention, minimally contains two different types of microarray comprising at least two of a: nucleic acid microarray, a peptide, polypeptide, protein microarray, a cell and/or tissue microarray, an oligosaccharide, lipoprotein, small molecule microarray. Preferably, the kit provides access to an information database (e.g., in the form of a URL and an identifier which identifies the particular microarray being used, and/or a password). In one aspect, the kit comprises instructions for accessing the database 5, or one or more molecular probes, for obtaining molecular profiling data using the microarrays, and/or other reagents necessary for performing molecular profiling (e.g., labels, suitable buffers, and the like). In a preferred aspect, kits are provided which include a panel of molecular probes reactive with a plurality of pathway biomolecules. Because of the completion of the sequencing of the human genome, unique sequence probes (both antibodies and nucleic acids) can be generated for any of the pathway molecules described above and included in the kits described herein.

It will be appreciated by those of skill in the art that the techniques and embodiments disclosed herein are preferred embodiments only that in general numerous equivalent methods and techniques may be employed to achieve the same result.

All of the references identified hereinabove, are hereby expressly incorporated herein by reference to the extent that they describe, set forth, provide a basis for or enable compositions and/or methods which may be important to the practice of one or more embodiments of the present inventions.

What is claimed is:

1. A method of using a plurality of different types of microarrays to identify and validate biomarkers in a subject, comprising
a. performing one or more assays comprising, in each assay, contacting a target sample comprising a plurality of target biomolecules to a plurality of molecular probes “arrayed” at the distinct known locations on a substrate;
b. detecting the reactivity of one or more molecule probes with one or more biomolecules in the target sample in (a);
c. performing one or more assays comprising, in each assay, contacting one or more molecular probes to a plurality of target samples, each of which comprising a plurality of target biomolecules, arrayed at the distinct known locations on a substrate;
d. detecting the reactivity of the molecular probes with one or more biomolecules in the target samples in (c);
e. storing information relating to reactivity between molecular probes and biomolecules in a specimen-linked database of an information management system along with clinical information about target samples; and
f. identifying or validating one or more biomarkers using the stored information of the information management system.

2. The method of claim 1, wherein target samples are one or more samples selected from the group consisting of genomic DNA, DNA amplified from genomic DNA, total RNA, mRNA, cRNA transcribed from the cDNA, RNA transcribed from amplified DNA, cellular peptides, polypeptides or proteins generated from tissue samples or cell samples, pieces, slices or portions of tissue samples, and cell samples.

3. The method of claim 1, wherein at least two target samples are from the same subject.

4. The method of claim 2, wherein cell samples are substantially homogeneous populations of cells.

5. The method of claim 1, wherein the plurality of molecular probes is nucleic acids selected from the group consisting of oligonucleotides, EST, cDNA and aptamer.

6. The method of claim 1, wherein the plurality of molecular probes are peptides, polypeptides or proteins or their modifiers thereof.

7. The method of claim 6, wherein peptides, polypeptides or proteins are antibodies or antigen binding fragments of antibodies or antigens themselves.

8. The method of claim 7, wherein antibodies are specific to allelic variants of the same proteins and/or the unmodified and modified variants of the same protein.

9. The method of claim 1, wherein the plurality of molecular probes further comprise small molecules selecting from the group comprising oligosaccharides, phospholipids, mimetics, polymers and drug congeners.

10. The method of claim 1, wherein the target samples are from different parts of the body of the same subject.

11. The method of claim 1, wherein the target samples are from patients who share similar biological characteristics.

12. The method of claim 2, wherein tissue samples are at least two different types of tissues from the same subject.

13. The method of claim 12, wherein tissue samples further comprise frozen, paraffin embedded or plastic embedded tissue samples.

14. The method of claim 10, wherein the subject is a human being.

15. The method of claim 14, wherein the human being is a patient with a clinical condition.

16. The method of claim 15, wherein the clinical condition is a cancer.

17. The method of claim 1, wherein the target sample in (a) is further labeled, while the molecular probe in (c) is further labeled.

18. The method of claim 5, wherein one or more molecular probes in (c) further comprise an antibody or antigen recognizing fragment of an antibody, which recognizes the peptides, polypeptides or proteins encoded by a nucleic acid comprising the nucleic acid probe reacting with a biomolecule in the target sample in (a).

19. The method of claim 17, wherein the labeled target sample further includes a labeled control biomolecule.

20. The method of claim 19, wherein the labeled control biomolecule is a nuclei acid molecule perfectly complementary to the sequence of a control probe on the molecular probe microarray.

21. The method of claim 20, wherein the control probe consisting of the nucleic acid sequence of a house keeping gene.

22. The method of claim 21, wherein the housekeeping gene is a tubulin.

23. A method of using hybrid microarrays to identify and validate biomarkers in a target sample, comprising
a. depositing a plurality of molecular probes at the different known location at the first portion on a substrate;
b. depositing a plurality of target samples at the different known locations at the second proton on said substrate;
c. performing a first array comprising contacting a target sample to the plurality of molecules probes at the first portion of the substrate, while the second portion of said substrate is covered;
d. performing a second array comprising contacting a molecular probe to the plurality of target samples at the second portion of the said microarray, while the first portion of said substrate is covered;
e. storing the information relating to reactivity between molecular probes and biomolecules in a specimen-linked database of an information management system along with clinical information about target samples; and
f. identifying or validating one or more biomarkers using the stored information of the information management system.

24. A method for diagnosing, prognosing, or predicting a physiological condition in a subject, comprising,
a. performing one or more molecule probe microarray assays using diagnostic and/or prognostic biomarkers as molecular probes;
b. validating the molecular probe/target biomolecule complex;
c. further performing one or more target sample microarray assays using a plurality of target samples from said subject;
d. detecting the reactivity of the diagnostic and/or prognostic biomarkers with the target samples and storing information in a specimen linked database of an information management system comprising clinical information of the target samples;
e. determining the correlation of the expression of the diagnostic and/or prognostic biomarkers with the clinical information of the target samples from said subject using the stored information of the information management system; and
f. utilizing the information determined in step (e) for diagnosing, prognosing or predicting the physiological condition in said subject.

25. The method of claim 24, wherein the diagnostic and/or prognostic biomarkers are cancer markers.

26. An information management system for evaluating physiological responses of patients comprising
a specimen linked database comprising information of the reactivity of the molecular probes with the biomolecules in the target sample from at least one molecular probe microarray assay identified by a unique identifier, information of the reactivity of the molecular probes with the target biomolecules in a plurality of target samples from at least one cell or tissue microarray assay identified by a second unique identifier and clinical information of any target sample used in any microarray assay, along with other information of patient(s) from whom the target samples are obtained;
a database searching function allowing a user to design queries to obtain information from the specimen-linked database;
a relationship determination function allowing a user to design search queries to evaluate the physiological responses of patients; and
at least one user device connectable to a network comprising a display for displaying an interface onto which a user can input said identifier, said queries, said inputting enabling said user to access database.
